(19) United States
(12) Patent Application Publication
(10) Pub. No.: US 2014/0030416 A1
(43) Pub. Date: Jan. 30, 2014

(54) Frozen Confections Comprising Protein Hydrolysate Compositions and Method for Producing the Frozen Confections

(71) Applicants: DAVID SABBAGH, Fenton, MO (US); William C. Smith, Cahokia, IL (US); John A. Brown, Festus, MO (US)

(72) Inventors: DAVID SABBAGH, Fenton, MO (US); William C. Smith, Cahokia, IL (US); John A. Brown, Festus, MO (US)

(73) Assignee: Solae, LLC, St. Louis, MO (US)

(21) Appl. No.: 14/041,808

(22) Filed: Sep. 30, 2013

Related U.S. Application Data
(63) Continuation of application No. 13/119,422, filed on Mar. 16, 2011, now abandoned.
(60) Provisional application No. 61/098,933, filed on Sep. 22, 2008.

(51) Int. Cl. A23G 9/38

(52) U.S. Cl. CPC A23G 9/38
USPC 426/586; 426/656; 426/580; 426/588

(57) ABSTRACT

The present invention provides frozen confection compositions and dairy-analog frozen confection compositions and the method for producing the frozen confection compositions. In particular, the frozen confections comprise protein hydrolysate compositions, which are generally comprised of polypeptide fragments having primarily either an arginine residue or a lysine residue at each carboxyl terminus.

### FIELD OF THE INVENTION

The present invention generally provides frozen confections comprising an edible material and a protein hydrolysate composition, and optionally may include dairy proteins and the method for producing the frozen confections.

### BACKGROUND OF THE INVENTION

Frozen confections, such as ice cream, water ice, sherbet, and the like, have been enjoyed by people of all ages for years. Dairy-based frozen confections are typically made with whole milk, butterfat, and/or heavy cream, and sugar, while the non-dairy based frozen confections can contain high levels of sugar and calories at the expense of being nutritionally sound, for example, not containing any fiber or protein. While many may enjoy frozen confections, these treats tend to be avoided for a variety of reasons. First, frozen confections are not nutritious products due to the high levels of fat and calories they typically contain. Second, a large portion of the population is not able to consume dairy-based frozen confections since they cannot metabolize lactose, a sugar found in dairy products. Third, some people choose not to eat dairy-based frozen confections due to religious or personal beliefs surrounding the consumption of dairy products. In light of all these factors, there is a need for a low-dairy or non-dairy frozen confection product that is also nutritious.

Dairy-based frozen confections are loved because of the milky flavor and creamy texture. One product that is routinely used to replace dairy in a variety of products is soy protein. It is well known that there are frozen confections containing soy currently available on the market. These products have reduced or eliminated the dairy content and may be nutritionally sound. Current soy proteins used on the market as an ingredient in frozen confections tend to cause the frozen confections to have a “grassy” or “beany” flavor that individuals find objectionable or unpalatable. Despite the emergence of these “healthy” frozen confection options, it seems clear that consumers are not willing to sacrifice taste and texture of their favorite indulgence in an effort to be healthy or avoid dairy. Therefore, a need exists for non-dairy or low-dairy frozen confections which strive to address health or belief restrictions by containing a soy protein product, but which still retain the tastes and textures people have come to know and love.

### SUMMARY OF THE INVENTION

One aspect of the present invention provides frozen confection compositions comprising a protein hydrolysate having a mixture of polypeptide fragments having primarily either an arginine residue or a lysine residue at each carboxyl terminus. These products optionally include dairy proteins. Additionally, the protein hydrolysate composition has a degree of hydrolysis of at least about 0.2% and a soluble solids index (SSI) of at least about 80% at a pH of greater than about 6.0.

Other aspects and features of the invention are described in more detail below.

### REFERENCE TO COLOR FIGURES

The application contains at least one photograph executed in color. Copies of this patent application publication with color photographs will be provided by the Office upon request and payment of the necessary fee.

### DESCRIPTION OF THE FIGURES

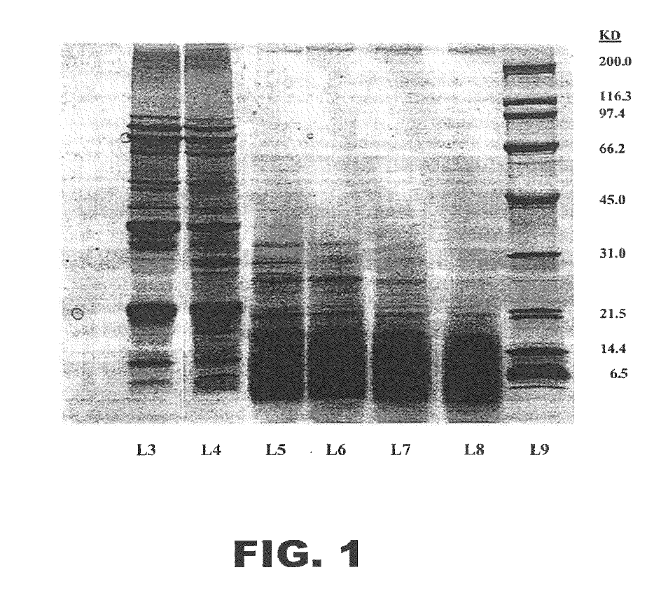

FIG. 1 illustrates hydrolysis of isolated soy protein by Fusarium trypsin-like endopeptidase (TL1). Shown is an image of a Coomassie-stained SDS-polyacrylamide gel. Lane 3 (L3) contains non-hydrolyzed isolated soy protein (SUPRO® 500E). Lane 4 (L4), lane 5 (L5), lane 6 (L6), lane 7 (L7), and lane 8 (L8) contain TL1 hydrolysates with 0.3%, 2.2%, 3.1%, 4.0%, and 5.0% degrees of hydrolysis (DH), respectively. Lane 9 (L9) contains a protein MW standard, with the sizes in kiloDaltons (KD) indicated at the right of the gel.

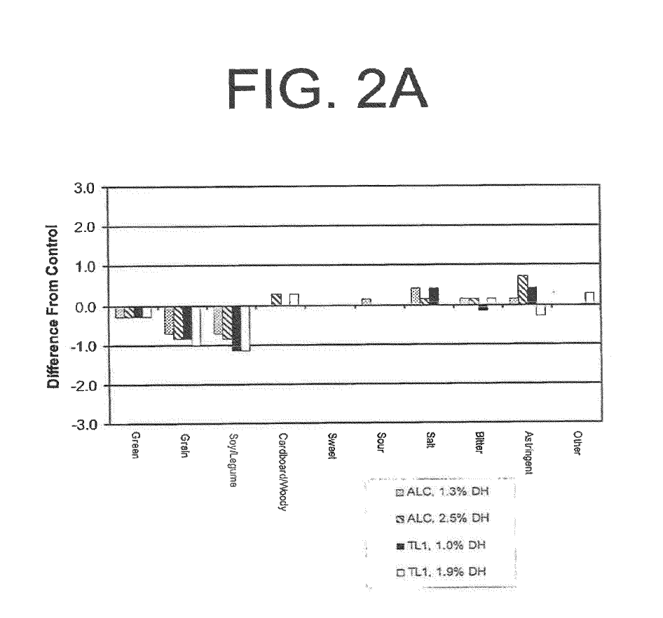

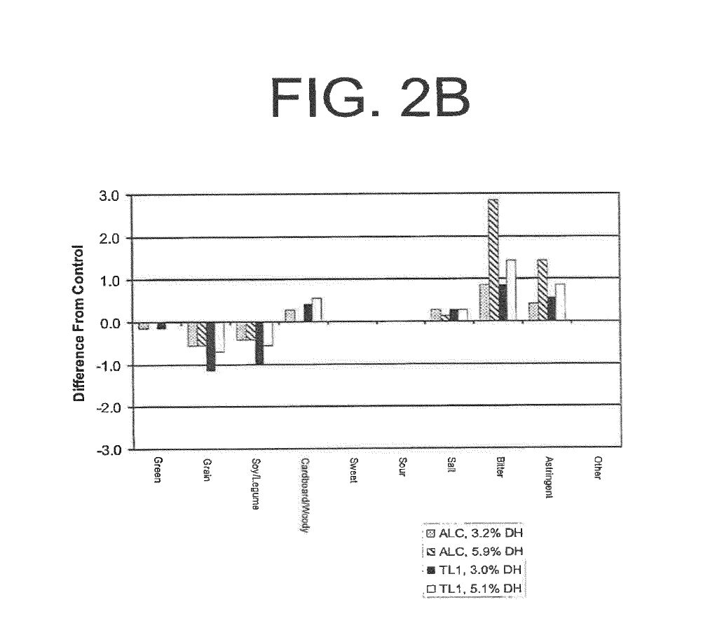

FIG. 2 presents the diagnostic scores of TL1 hydrolysates and ALCALASE® hydrolysates at 5.0% solids as evaluated by trained assessors. The identity and degree of hydrolysis (% DH) of each hydrolysate are presented below each plot. Positive scores indicate the hydrolysate had more of the sensory attribute than the control sample, and negative scores indicate the hydrolysate has less of the sensory attribute than the control sample. The control sample was non-hydrolyzed isolated soy protein. (A) Presents the scores for TL1 and ALCALASE® (ALC) hydrolysates with degrees of hydrolysis less than about 2.5% DH. (B) Presents the scores for TL1 and ALCALASE® (ALC) hydrolysates with degrees of hydrolysis greater than 3% DH.

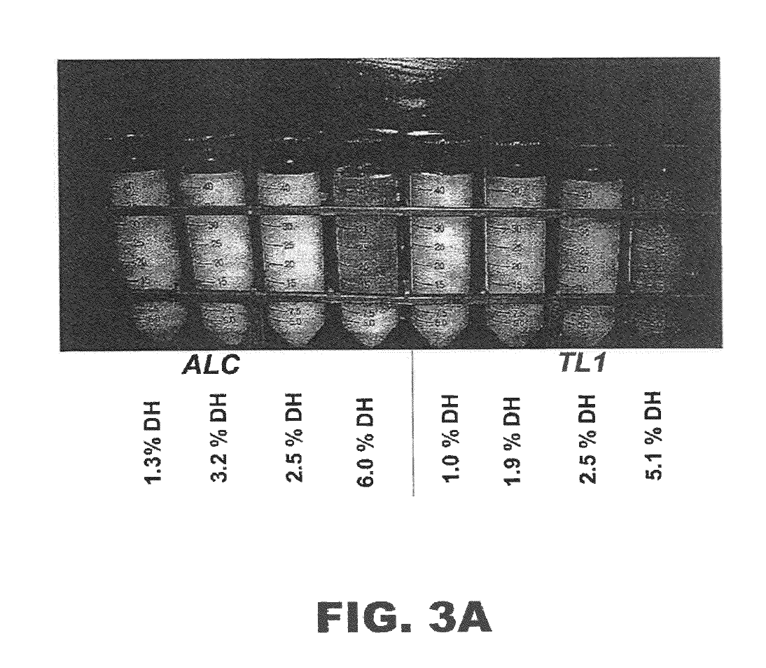

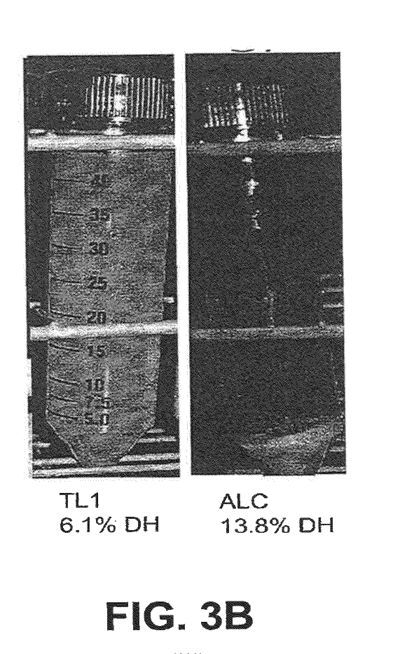

FIG. 3 compares the solubility of ALCALASE® and TL1 hydrolysates. The enzyme and degree of hydrolysis (% DH) of each is presented below each tube. (A) Presents tubes of ALCALASE® (ALC) and TL1 hydrolysates (at 2.5% solids) stored at pH 7.0 for two weeks at 4° C. (B) Presents TL1 and ALCALASE® (ALC) hydrolysates (at 2.5% solids) stored at pH 8.2 for three weeks at 4° C.

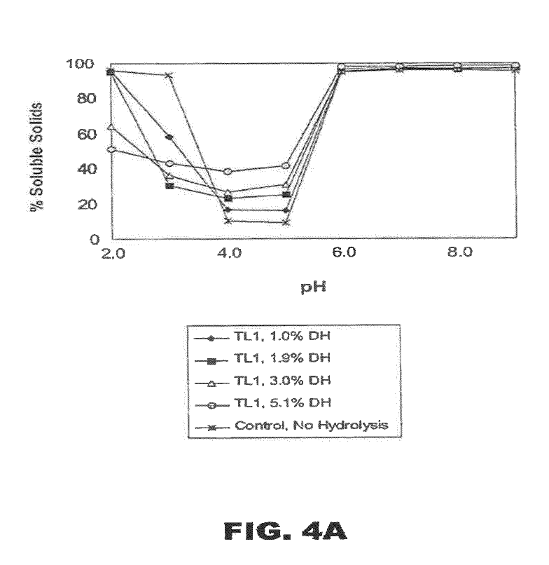

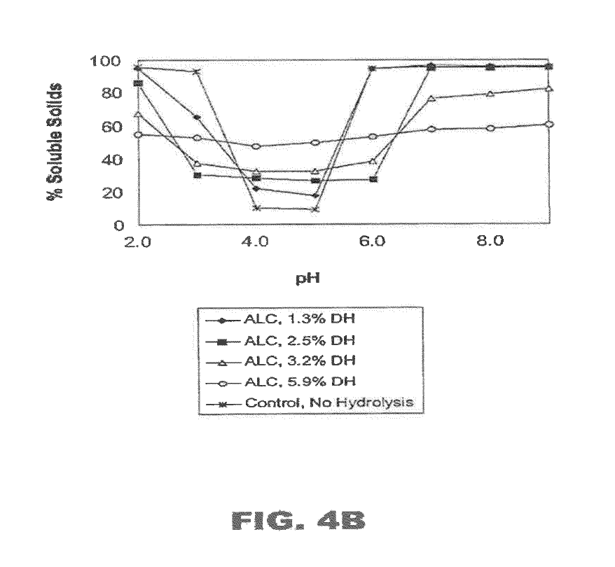

FIG. 4 presents solubility plots of TL1 and ALCALASE® hydrolysates. The percent of soluble solids (i.e., soluble solids index) of each hydrolysate (at 2.5% solids) is plotted as a function of pH. The identity and degree of hydrolysis (% DH) of each hydrolysate is presented below each plot. (A) Presents solubility curves for TL1 hydrolysates. (B) Presents solubility curves for ALCALASE® (ALC) hydrolysates. (C) Presents a direct comparison of the solubility of selected TL1 and ALCALASE® (ALC) hydrolysates.

FIG. 5 illustrates the hydrolysis of soy protein material with TL1 at a pilot plant scale. Shown is an image of a Coomassie-stained SDS-polyacrylamide gel in which the TL1 hydrolysates and control samples were resolved. Lane 1 (L1) and lane 3 (L3) contain non-hydrolyzed soy protein; lane 2 (L2) contains a 2.7% DH TL1 hydrolysate; lane 4 (L4) contains a hydrolyzed control sample (SUPRO® XT 219 hydrolyzed to 2.8% with a mixture of enzymes); lanes 5-11 (L5-L11) contain TL1 hydrolysates with 1.3, 2.0, 3.8, 0.3, 0.9, 1.6, and 5.2% DH, respectively. Lane 12 (L12) contains a molecular weight standard, with the sizes in kiloDaltons (KD) indicated to the right of the gel.

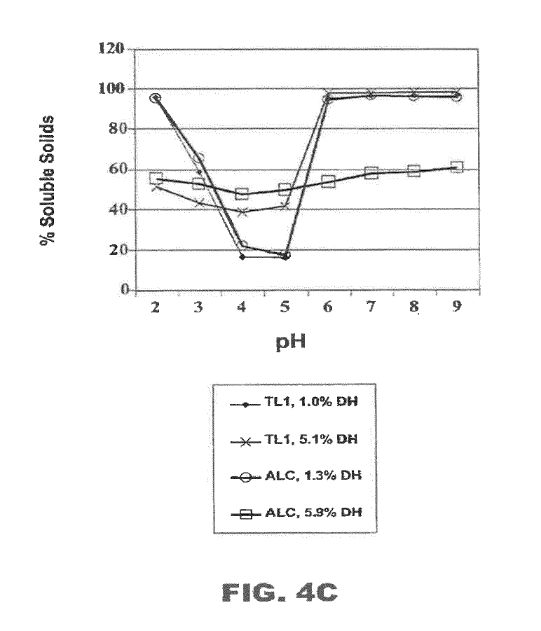

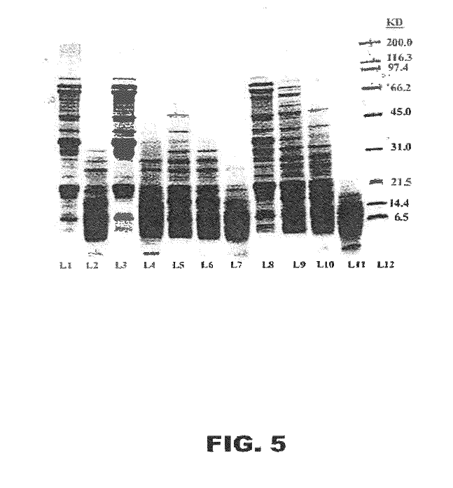

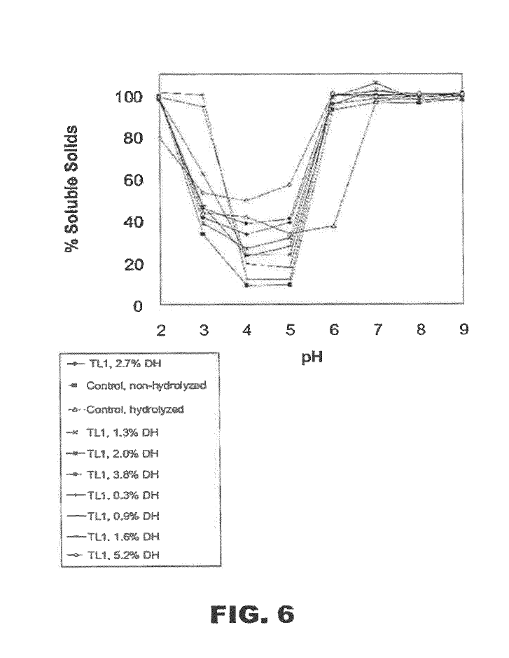

FIG. 6 presents solubility plots of the pilot plant TL1 hydrolysates and control samples. The degree of hydrolysis (% DH) for each hydrolysate is presented below the plot.

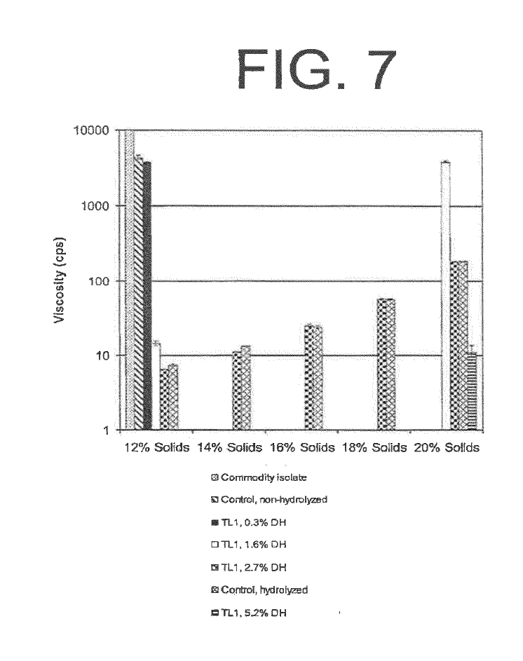

FIG. 7 presents a plot of the viscosity of the pilot plant TL1 hydrolysates and control samples. The degree of hydrolysis (% DH) of each hydrolysate is presented below the plot.

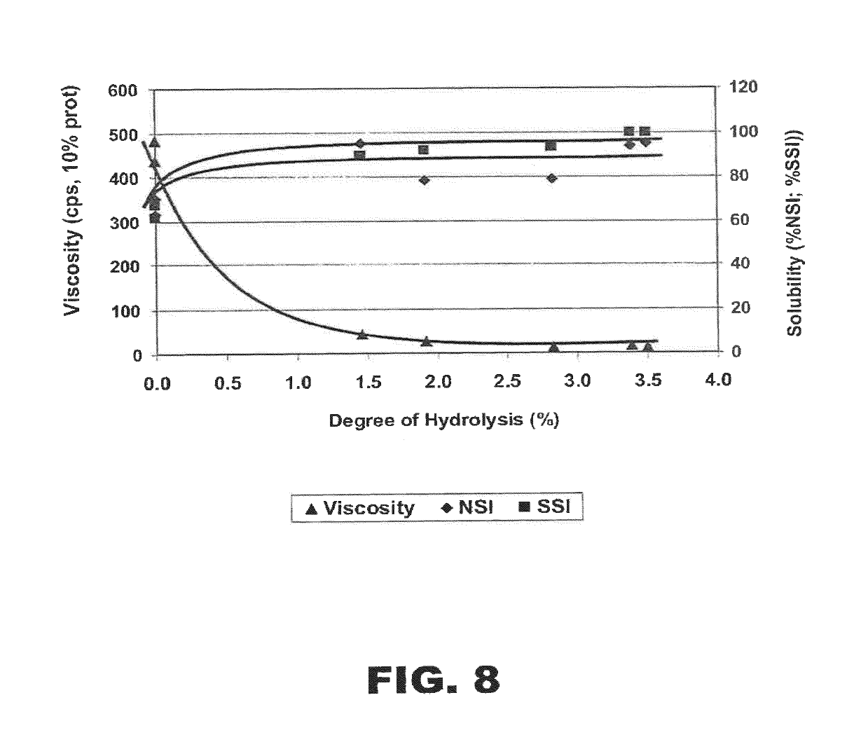

FIG. 8 presents a plot of the viscosity and solubility [i.e., soluble solids index (SSI) and nitrogen soluble index (NSI)] as a function of degree of hydrolysis of the pilot plant TL1 hydrolysates.

FIG. 9 illustrates that the levels of flavour volatiles are lower in the TL1 hydrolysate as compared to the control samples. (A) Presents the levels of the total active volatiles and hexanal in the control sample and TL1 hydrolysates with different degrees of hydrolysis (% DH). (B) Presents the levels of the indicated flavour volatiles in the control sample and TL1 hydrolysates with different degrees of hydrolysis (% DH).

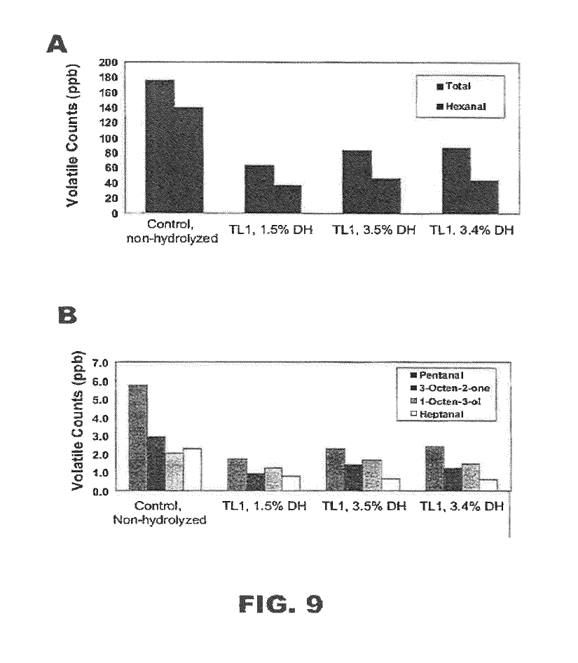

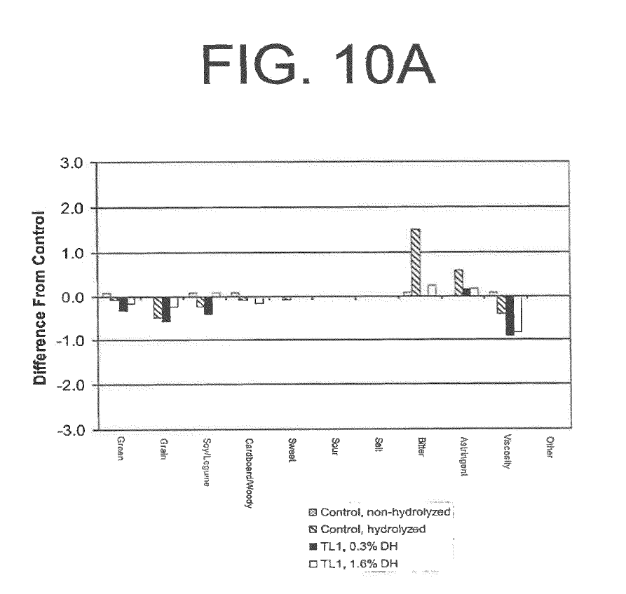

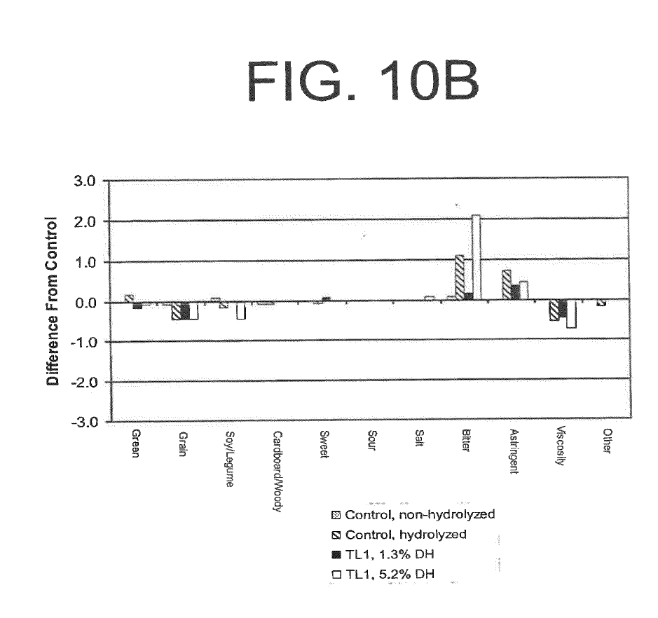

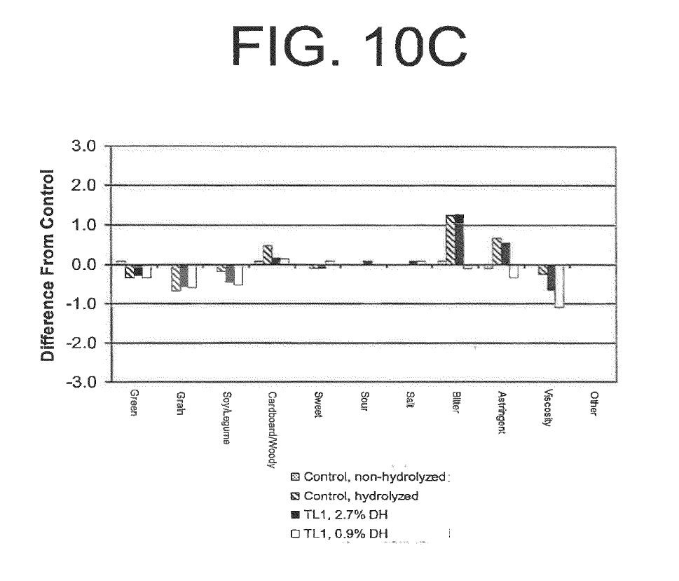

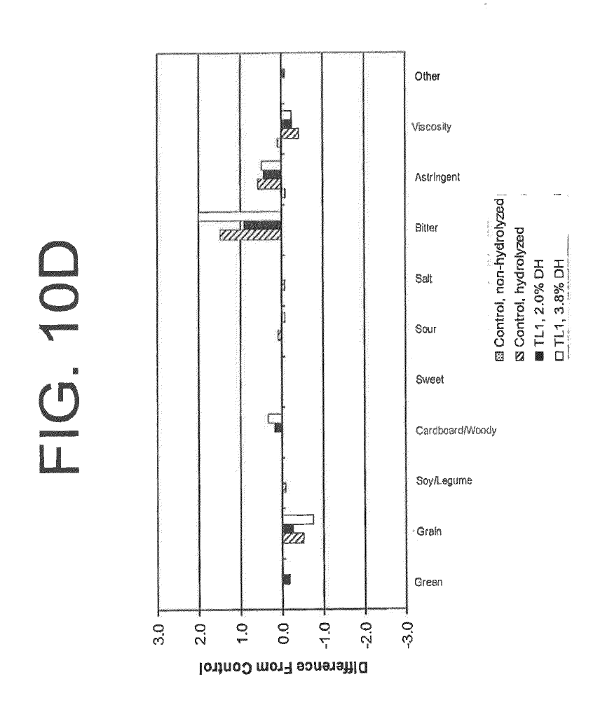

FIG. 10 presents plots of the diagnostic scores of the pilot plant TL1 hydrolysates and control samples. The control sample was non-hydrolyzed isolated soy protein. Positive scores indicate the hydrolysate had more of the sensory attribute than the control sample, and negative scores indicate the hydrolysate has less of the sensory attribute than the control sample. (A) Presents the scores for the control, 0.3% DH, and 1.6% DH samples. (B) Presents the scores for the control, 1.3% DH, and 5.2% DH samples. (C) Presents the scores for the control, 2.7% DH, and 0.9% DH samples. (D) Presents the scores for the control, 2.0% DH, and 3.8% DH samples.

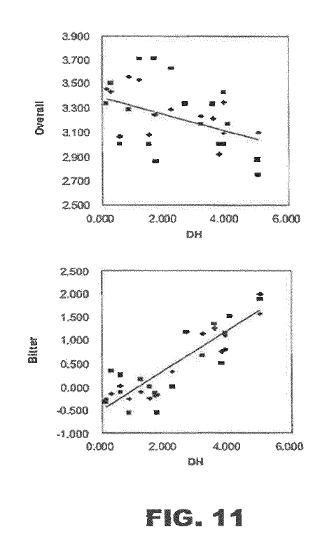

FIG. 11 presents summary plots of the sensory scores of TL1 hydrolysates as a function of degree of hydrolysis (DH). Overall liking scores are presented above and bitter scores are presented below. Diamonds represent predicted scores and squares represent real scores.

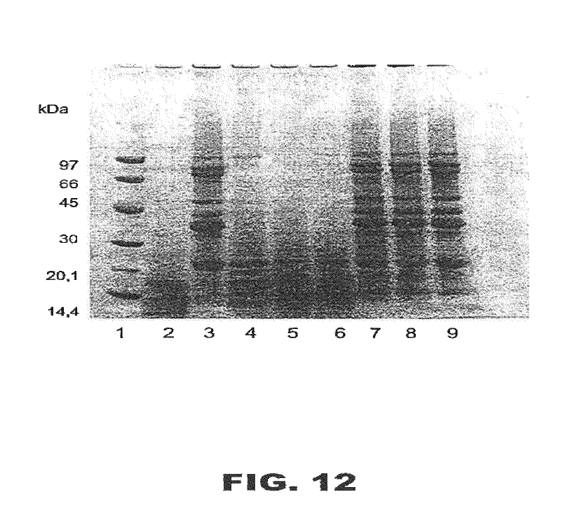

FIG. 12 illustrates the hydrolysis of isolated soy protein with several different trypsin-like proteases. Presented is an image of a Coomassie-stained SDS polyacrylamide gel in which non-hydrolyzed soy protein and enzyme-treated soy protein samples were resolved. Lane 1 contains molecular weight markers with the sizes indicated to the left of the gel. Lanes 3 and 9 contain untreated isolated soy protein. Lane 2 and lanes 4-8 contain soy treated with TL1. SP3, TL5, TL6, porcine trypsin, and bovine trypsin, respectively.

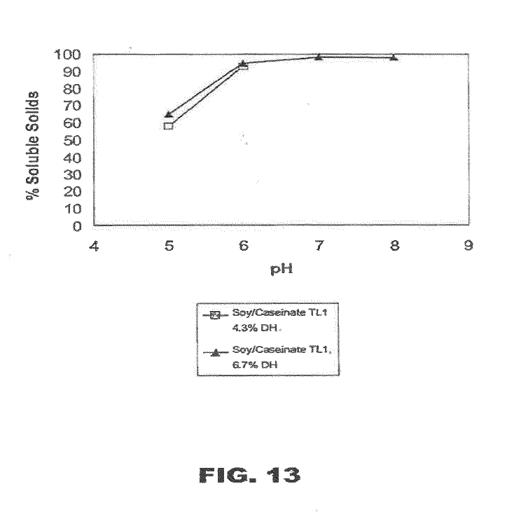

FIG. 13 illustrates the solubility of TL1 hydrolysates of a combination of soy and dairy proteins as a function of pH.

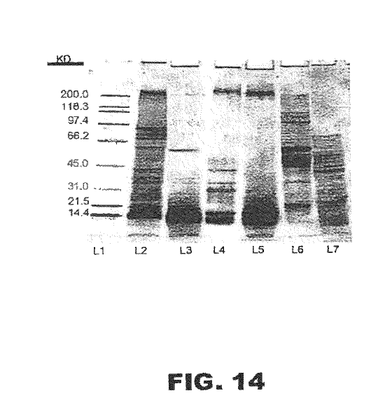

FIG. 14 illustrates the hydrolysis of other plant protein materials by TL1. Presented is an image of a Coomassie-stained SDS-polyacrylamide gel in which untreated and treated protein samples were resolved. Lane 1 (L1) contains molecular weight markers (as indicated in KD to the left of the gel). Lane 2 (L2), lane 4 (L4), and lane 6 (L6) contain samples of unhydrolyzed corn germ, canola and wheat germ, respectively. Lane 3 (L3), lane 5 (L5), and lane 7 (L7) contain TL1 hydrolysates of corn germ, canola and wheat germ, respectively.

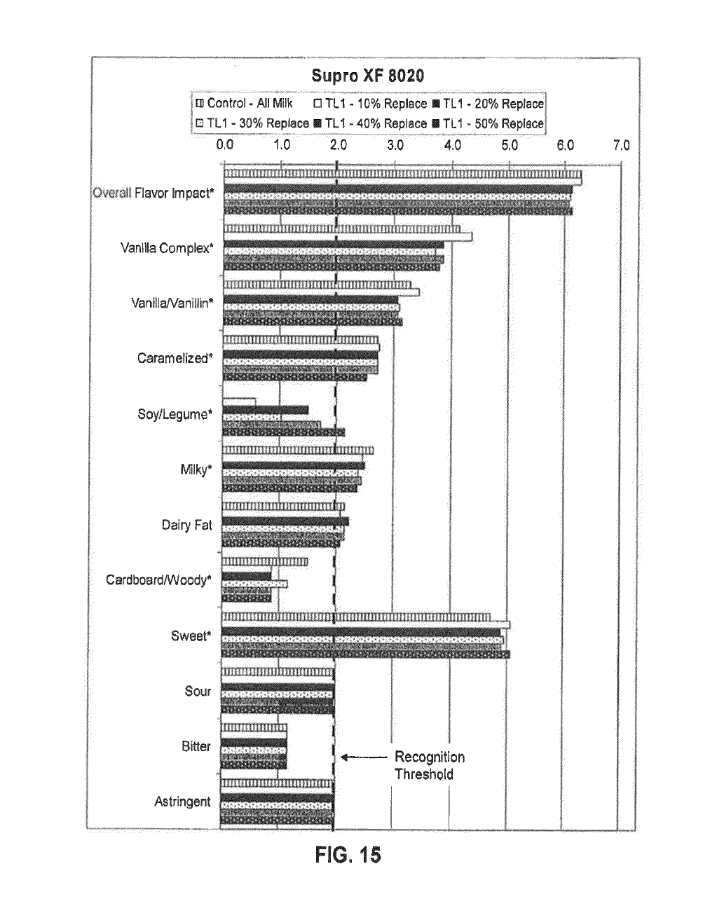

FIG. 15 is a bar graph representing the flavor profile for vanilla ice cream comprising 10% dairy replacement with Supro® XF8020, 20% dairy replacement, 30% dairy replacement, 40% dairy replacement, and 50% dairy replacement, as compared to the all-dairy control ice cream.

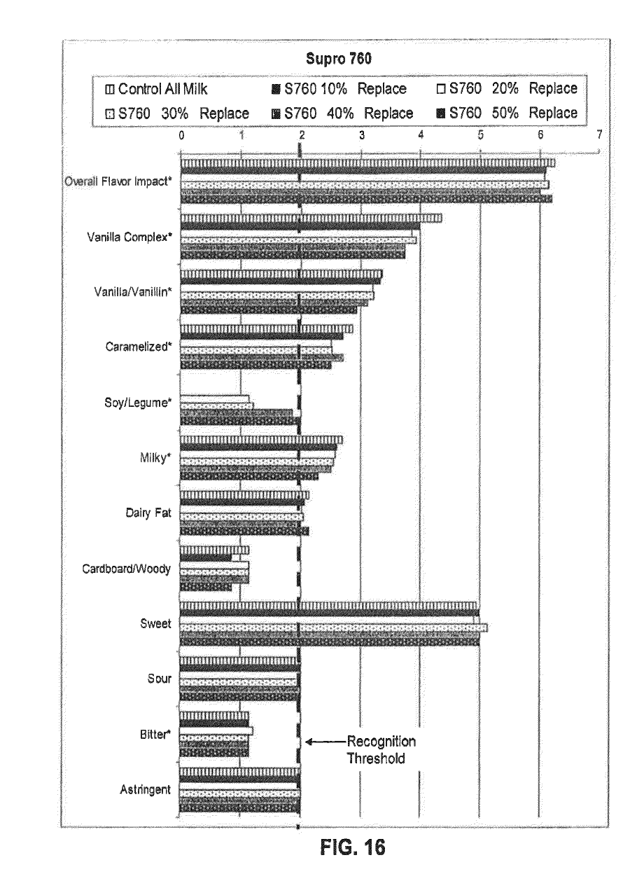

FIG. 16 is a bar graph representing the flavor profile for vanilla ice cream comprising 10% dairy replacement with Supro® 120, 20% dairy replacement, 30% dairy replacement, 40% dairy replacement, and 50% dairy replacement, as compared to the all-dairy control ice cream.

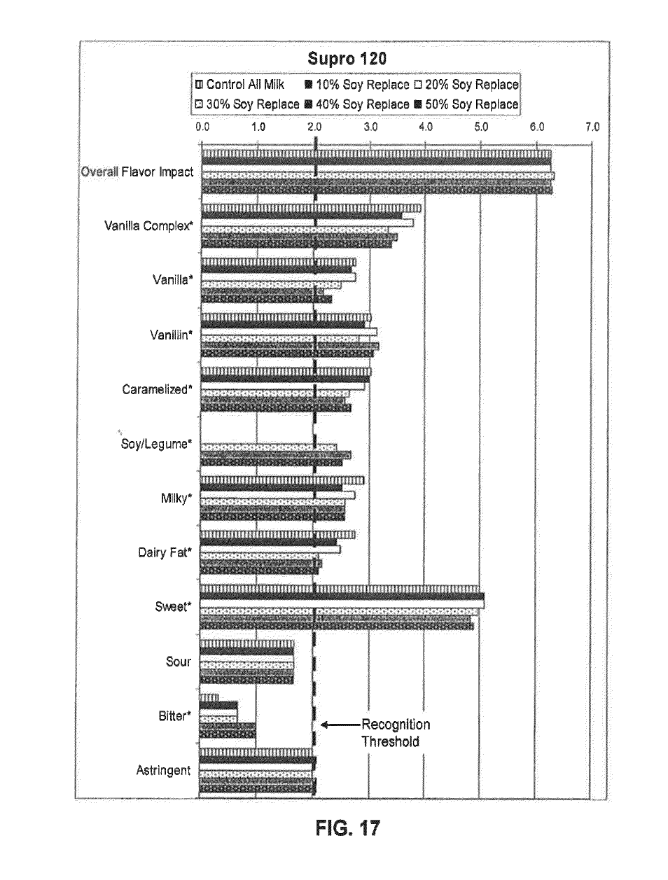

FIG. 17 is a bar graph representing the flavor profile for vanilla ice cream comprising 10% dairy replacement with Supro® 760, 20% dairy replacement, 30% dairy replacement, 40% dairy replacement, and 50% dairy replacement, as compared to the all-dairy control ice cream.

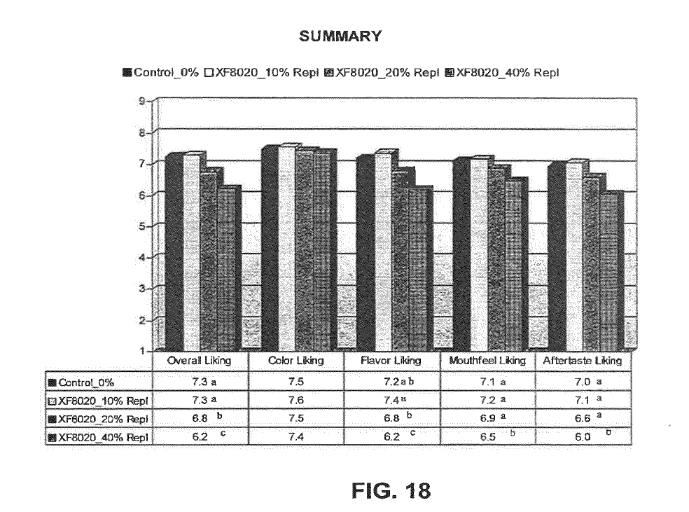

FIG. 18 is a bar graph representing the acceptability of vanilla ice cream comprising 10% dairy replacement with Supro® XF8020, 20% dairy replacement, and 40% dairy replacement, as compared to the all-dairy control ice cream.

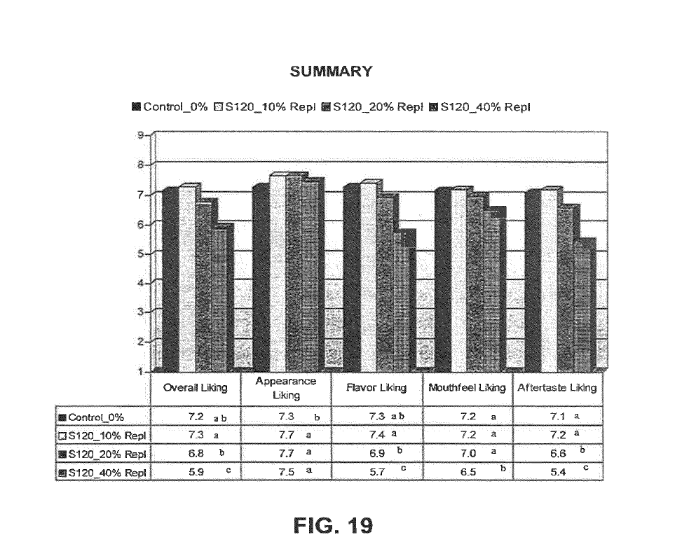

FIG. 19 is a bar graph representing the acceptability of vanilla ice cream comprising 10% dairy replacement with Supro® 120, 20% dairy replacement, and 40% dairy replacement, as compared to the all-dairy control ice cream.

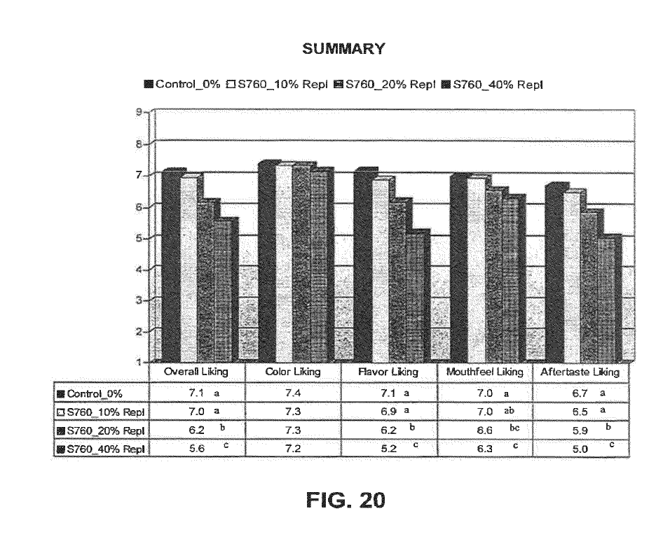

FIG. 20 is a bar graph representing the acceptability of vanilla flavoured frozen confection comprising 10% dairy replacement with Supro® 760, 20% dairy replacement, and 40% dairy replacement, as compared to the all-dairy control ice cream.

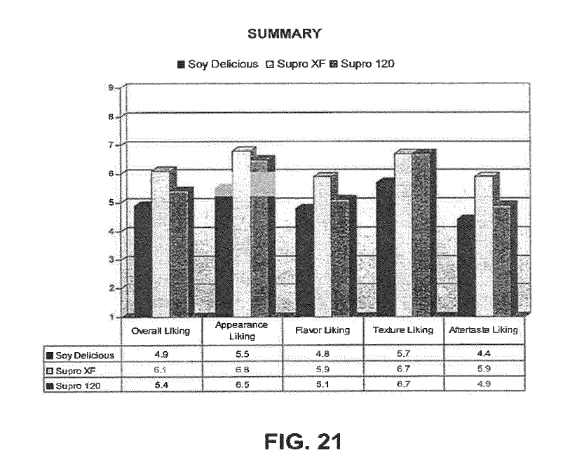

FIG. 21 is a 100% dairy replacement with Supro® 120. Supro® XF 8020 comparing to Soy Delicious a commercial all vegetable frozen confection.

### DETAILED DESCRIPTION OF THE INVENTION

The present invention provides frozen confections comprising a protein hydrolysate composition and processes for producing the frozen confections. The protein hydrolysate composition used in the frozen confections is comprised of a mixture of polypeptide fragments having primarily either an arginine residue or a lysine residue at each carboxyl terminus. The frozen confection products of the invention optionally include dairy proteins in addition to the protein hydrolysate composition. Advantageously, as illustrated in the examples, the frozen confection compositions of the invention, which contain a protein hydrolysate composition described herein, possess improved flavor, texture, mouth feel, and aroma as compared to frozen confection products containing different soy proteins.

(I) Frozen Confection Compositions

One aspect of the invention provides frozen confection compositions comprising a mixture of dairy proteins and soy protein hydrolysate compositions at various ratios up to and including 100% soy hydrolysate. Another aspect of the invention provides frozen confection compositions comprising only protein hydrolysate compositions and no dairy proteins. The composition and properties of the protein hydrolysates are detailed below in section (I)A. The frozen confection compositions of the invention that include various ratios of a protein hydrolysate composition generally have improved flavor and texture characteristics as compared to frozen confections comprised of other soy proteins, using frozen confections containing one hundred percent dairy as a benchmark.

The protein hydrolysates of the current invention form different ice crystals when the product is frozen, as compared to frozen confection products containing one hundred percent dairy proteins. Further, the frozen confections containing a protein hydrolysate composition also exhibit higher viscosities before freezing when more protein hydrolysate is added to the product. Higher mix viscosity may result in more efficient trapping of air, which shortens freezing time.

A. Protein Hydrolysate Compositions

The protein hydrolysate compositions, compared with the protein starting material will, comprise a mixture of polypeptide fragments of varying length and molecular weights. Each of the peptide fragments typically will have either an arginine or lysine residue at its carboxyl terminus (as demonstrated in Examples 3, 4, 13, and 18). The polypeptide fragments may range in size from about 75 Daltons to about 50,000 Daltons, or more preferably from about 150 Daltons to about 20,000 Daltons. In some embodiments, the average molecular size of the polypeptide fragments may be less than about 20,000. In other embodiments, the average molecular size of the polypeptide fragments may be less than about 15,000. In still other embodiment, the average molecular size of the polypeptide fragments may be less than about 10,000. In additional embodiments, the average molecular size of the polypeptide fragments may be less than about 5000.

The degree of hydrolysis of the protein hydrolysate compositions of the invention can and will vary depending upon the source of the protein material, the endopeptidase used, and the degree of completion of the hydrolysis reaction. The degree of hydrolysis (DH) refers to the percentage of peptide bonds cleaved versus the starting number of peptide bonds. For example, if a starting protein containing five hundred peptide bonds is hydrolyzed until fifty of the peptide bonds are cleaved, then the DH of the resulting hydrolysate is 10%. The degree of hydrolysis may be determined using the trinitrobenzene sulfonic (TNBS) colorimetric method or the ortho-phthaldialdehye (OPA) method, as detailed in the examples. The higher the degree of hydrolysis the greater the extent of protein hydrolysis. Typically, as the protein is further hydrolyzed (i.e., the higher the DH), the molecular weight of the peptide fragments decreases, the peptide profile changes accordingly, and the viscosity of the mixture decreases. The DH may be measured in the entire hydrolysate (i.e., whole fraction) or the DH may be measured in the soluble fraction of the hydrolysate (i.e., the supernatant fraction after centrifugation of the hydrolysate at about 500-1000×g for about 5-10 min).

In general, the degree of hydrolysis of the protein hydrolysate will be at least about 0.2%. In one embodiment, the degree of hydrolysis of the protein hydrolysate may range from about 0.2% to about 2%. In another embodiment, the degree of hydrolysis of the protein hydrolysate may range from about 2% to about 8%. In yet another embodiment, the degree of hydrolysis of the protein hydrolysate may range from about 8% to about 14%. In an alternate embodiment, the degree of hydrolysis of the protein hydrolysate may range from about 14% to about 20%. In additional embodiments, the degree of hydrolysis of the protein hydrolysate may be greater than about 20%.

The solubility of the protein hydrolysate compositions can and will vary depending upon the source of the starting protein material, the endopeptidase used, and the pH of the composition. The soluble solids index (SSI) is a measure of the solubility of the solids (i.e., polypeptide fragments) comprising a protein hydrolysate composition. The amount of soluble solids may be estimated by measuring the amount of solids in solution before and after centrifugation (e.g., about 500-1000×g for about 5-10 min). Alternatively, the amount of soluble solids may be determined by estimating the amount of protein in the composition before and after centrifugation using a technique well known in the art (such as, e.g., a bicinchoninic acid (BCA) protein determination colorimetric assay).

In general, the protein hydrolysate composition of the invention, regardless of its degree of hydrolysis, has a soluble solids index of at least about 80% at a pH greater than about pH 6.0. In one embodiment, the protein hydrolysate composition may have a soluble solids index ranging from about 80% to about 85% at a pH greater than about pH 6.0. In another embodiment, the protein hydrolysate composition may have a soluble solids index ranging from about 85% to about 90% at a pH greater than about pH 6.0. In a further embodiment, the protein hydrolysate composition may have a soluble solids index ranging from about 90% to about 95% at a pH greater than about 6.0. In another alternate embodiment, the protein hydrolysate composition may have a soluble solids index ranging from about 95% to about 99% at a pH greater than about 6.0.

Furthermore, the solubility of the protein hydrolysate compositions of the invention may vary at about pH 4.0 to about pH 5.0 as a function of the degree of hydrolysis. For example, soy protein hydrolysate compositions having degrees of hydrolysis greater than about 3% tend to be more soluble at about pH 4.0 to about pH 5.0 than those having degrees of hydrolysis less than about 3%.

Generally speaking, soy protein hydrolysate compositions having degrees of hydrolysis of about 1% to about 6% are stable at a pH from about pH 7.0 to about pH 8.0. Stability refers to the lack of sediment formation over time. The protein hydrolysate compositions may be stored at room temperature (i.e., ˜23° C.) or a refrigerated temperature (i.e., ˜4° C.). In one embodiment, the protein hydrolysate composition may be stable for about one week to about four weeks. In another embodiment, the protein hydrolysate composition may be stable for about one month to about six months. In a further embodiment, the protein hydrolysate composition may be stable for more than about six months.

The protein hydrolysate composition may be dried. For example the protein hydrolysate composition may be spray dried. The temperature of the spray dryer inlet may range from about 500° F. to about 600° F. and the exhaust temperature may range from about 180° F. to about 100° F. Alternatively, the protein hydrolysate composition may be vacuum dried, freeze dried, or dried using other procedures known in the art.

In embodiments in which the protein hydrolysate is derived from soy protein, the degree of hydrolysis may range from about 0.2% to about 14%, and more preferably from about 1% to about 6%. In addition to the number of polypeptide fragments formed, as illustrated in the examples, the degree of hydrolysis typically impacts other physical properties and sensory properties of the resulting soy protein hydrolysate composition. Typically, as the degree of hydrolysis increases from about 1% to about 6%, the soy protein hydrolysate composition has increased transparency or translucency and decreased grain and soy/legume sensory attributes. Furthermore, the soy protein hydrolysate composition has substantially less bitter sensory attributes when the degree of hydrolysis is less than about 2% compared to when the degree of hydrolysis is greater than about 2%. Stated another way, higher degrees of hydrolysis reduce grain and soy/legume sensory attributes, whereas lower degrees of hydrolysis reduce bitter sensory attributes. The sensory attributes and methods for determining them are detailed in the Examples.

Furthermore, in embodiments in which the protein hydrolysate is derived from soy, the soy protein hydrolysate composition may comprise polypeptides selected from the group consisting of SEQ ID NOs:5-177 and 270-274. In one embodiment, the soy protein hydrolysate may comprise at least one polypeptide having an amino acid sequence that corresponds to or is derived from the group consisting of SEQ ID NOs:5-177 and 270-274. In an alternate embodiment, the soy protein hydrolysate may comprise at least about ten polypeptides or fragments thereof selected from the group consisting of SEQ ID NOs:5-177 and 270-274. In another embodiment, the soy protein hydrolysate may comprise at least about 20 polypeptides or fragments thereof selected from the group consisting of SEQ ID NOs:5-177 and 270-274. In a further embodiment, the soy protein hydrolysate may comprise at least about 40 polypeptides or fragments thereof selected from the group consisting of SEQ ID NOs:5-177 and 270-274. In yet another embodiment, the soy protein hydrolysate may comprise at least about 80 polypeptides or fragments thereof selected from the group consisting of SEQ ID NOs:5-177 and 270-274. In yet another embodiment, the soy protein hydrolysate may comprise at least about 120 polypeptides or fragments thereof selected from the group consisting of SEQ ID NOs:5-177 and 270-274. In a further embodiment, the soy protein hydrolysate may comprise at least about 178 polypeptides or fragments thereof selected from the group consisting of SEQ ID NOs:5-177 and 270-274.

In other embodiments in which the protein hydrolysate is derived from a combination of soy protein and dairy, the combined soy/dairy protein hydrolysate composition may comprise polypeptides selected from the group consisting of SEQ ID NOs:5-197 and 270-274. In one embodiment, the combined soy/dairy hydrolysate may comprise at least one polypeptide having an amino acid sequence that corresponds to or is derived from the group consisting of SEQ ID NOs:5-197 and 270-274. In an alternate embodiment, the combined soy/dairy hydrolysate may comprise at least about ten polypeptides or fragments thereof selected from the group consisting of SEQ ID NOs:5-197 and 270-274. In another embodiment, the combined soy/dairy hydrolysate may comprise at least about 50 polypeptides or fragments thereof selected from the group consisting of SEQ ID NOs:5-197 and 270-274. In another alternate embodiment, the combined soy/dairy hydrolysate may comprise at least about 100 polypeptides or fragments thereof selected from the group consisting of SEQ ID NOs:5-197 and 270-274. In another embodiment, the soy/dairy hydrolysate may comprise at least about 150 polypeptides or fragments thereof selected from the group consisting of SEQ ID NOs:5-197 and 270-274. In still another alternate embodiment, the combined soy/dairy hydrolysate may comprise at least about 198 polypeptides or fragments thereof selected from the group consisting of SEQ ID NOs:5-197 and 270-274.

In additional embodiments in which the protein hydrolysate is derived from canola, the protein hydrolysate composition may comprise polypeptides selected from the group consisting of SEQ ID NOs:198-237. In one embodiment, the canola hydrolysate may comprise at least one polypeptide having an amino acid sequence that corresponds to or is derived from the group consisting of SEQ ID NOs:198-237. In an alternate embodiment, the canola hydrolysate may comprise at least about ten polypeptides or fragments thereof selected from the group consisting of SEQ ID NOs:198-237. In another embodiment, the canola hydrolysate may comprise at least about 20 polypeptides or fragments thereof selected from the group consisting of SEQ ID NOs:198-237. In yet another alternate embodiment, the canola hydrolysate may comprise at least thirty-nine polypeptides having an amino acid sequence that corresponds to or is derived from the group consisting of SEQ ID NOs:198-237.

In other additional embodiments in which the protein hydrolysate is derived from maize, the protein hydrolysate composition may comprise polypeptides selected from the group consisting of SEQ ID NOs:238-261. In one embodiment, the maize hydrolysate may comprise at least one polypeptide having an amino acid sequence that corresponds to or is derived from the group consisting of SEQ ID NOs:238-261. In another embodiment, the maize hydrolysate may comprise at least ten polypeptides having an amino acid sequence that corresponds to or is derived from the group consisting of SEQ ID NOs:238-261. In a further embodiment, the maize hydrolysate may comprise at least 24 polypeptides having an amino acid sequence that corresponds to or is derived from the group consisting of SEQ ID NOs:238-261.

Furthermore, in embodiments in which the protein hydrolysate is derived from wheat, the protein hydrolysate composition may comprise polypeptides selected from the group consisting of SEQ ID NOs:262-269. In one embodiment, the wheat hydrolysate may comprise at least one polypeptide having an amino acid sequence that corresponds to or is derived from the group consisting of SEQ ID NOs: 262-269. In a further embodiment, the wheat hydrolysate may comprise at least eight polypeptides having an amino acid sequence that corresponds to or is derived from the group consisting of SEQ ID NOs: 262-269.

The invention may also encompass any of the polypeptides or fragments thereof that may be purified from the soy protein hydrolysate compositions, soy/dairy protein hydrolysate compositions, canola protein hydrolysate compositions, maize protein hydrolysate compositions or wheat protein hydrolysate compositions of the invention. Typically, a pure polypeptide fragment constitutes at least about 80%, preferably, 90% and even more preferably, at least about 95% by weight of the total polypeptide in a given purified sample. A polypeptide fragment may be purified by a chromatographic method, such as size exclusion chromatography, ion exchange chromatography, affinity chromatography, hydrophobic interaction chromatography, reverse phase chromatography, and the like. For example, the polypeptide fragment may be selected from the group consisting of SEQ ID NOs:5-274. Additionally, the invention also encompasses polypeptide fragments that are substantially similar in sequence to those selected from the group consisting of SEQ ID NOs:5-274. In one embodiment, polypeptide fragment may have at least 80, 81, 82, 83, 84, 85, 86, 87, 88, or 89% sequence identity to a polypeptide fragment selected from the group consisting of SEQ ID NOs:5-274. In another embodiment, the polypeptide fragment may have at least 90, 91, 92, 93, 94, 95, 96, 97, 98, or 99% sequence identity to a polypeptide fragment selected from the group consisting of SEQ ID NOs:5-274. Methods for determining whether a polypeptide fragment shares a certain percentage of sequence identity with a sequence of the invention are presented above.

It is also envisioned that the protein hydrolysate compositions of the invention may further comprise a non-hydrolyzed (i.e., intact) protein. The non-hydrolyzed protein may be present in an essentially intact preparation (such as, e.g., soy curd, corn meal, milk, etc.) Furthermore, the non-hydrolyzed protein may be isolated from a plant-derived protein source (e.g., sources such as amaranth, arrowroot, barley, buckwheat, canola, cassava, channa (garbanzo), legumes, lentils, lupin, maize, millet, oat, pea, potato, rice, rye, sorghum, sunflower, tapioca, triticale, wheat, and so forth) or isolated from an animal protein material (examples of suitable isolated animal proteins include acid casein, caseinate, whey, albumin, gelatin, and the like). In preferred embodiments, the protein hydrolysate composition further comprises a non-hydrolyzed protein selected from the group consisting of barley, canola, lupin, maize, oat, pea, potato, rice, soy, wheat, animal, dairy, egg, and combinations thereof. The relative proportions of the protein hydrolysate and the non-hydrolyzed protein can and will vary depending upon the proteins involved and the desired use of the composition.

B. Process for Preparing a Protein Hydrolysate

The process for preparing a protein hydrolysate comprising a mixture of polypeptide fragments that have primarily either an arginine residue or a lysine residue at each carboxyl terminus comprises contacting a protein material with an endopeptidase that specifically cleaves the peptide bonds of the protein material on the carboxyl terminal side of an arginine residue or a lysine residue to produce a protein hydrolysate. The protein material or combination of protein materials used to prepare a protein hydrolysate can and will vary. Examples of suitable protein material are detailed below.

(a) Soy Protein Material

In some embodiments, the protein material may be a soy protein material. A variety of soy protein materials may be used in the process of the invention to generate a protein hydrolysate. In general, the soy protein material may be derived from whole soybeans in accordance with methods known in the art. The whole soybeans may be standard soybeans (i.e., non genetically modified soybeans), genetically modified soybeans (such as, e.g., soybeans with modified oils, soybeans with modified carbohydrates, soybeans with modified protein subunits, and so forth) or combinations thereof. Suitable examples of soy protein material include soy extract, soymilk, soymilk powder, soy curd, soy flour, soy protein isolate, soy protein concentrate, and mixtures thereof.

In one embodiment, the soy protein material used in the process may be a soy protein isolate (also called isolated soy protein, or ISP). In general, soy protein isolates have a protein content of at least about 90% soy protein on a moisture-free basis. The soy protein isolate may comprise intact soy proteins or it may comprise partially hydrolyzed soy proteins. The soy protein isolate may have a high content of storage protein subunits such as 7S, 11S, 2S, etc. Non-limiting examples of soy protein isolates that may be used as starting material in the present invention are commercially available, for example, from Solae, LLC (St. Louis, Mo.), and among them include ALPHA™ 5800, SUPRO® 120, SUPRO®500E, SUPRO® 545, SUPRO® 620, SUPRO® 670, SUPRO® 760, SUPRO® EX 33, SUPRO® PLUS 2600F, SUPRO® PLUS 2640DS, SUPRO® PLUS 2800, SUPRO® PLUS 3000, SUPRO® XF 8020, SUPRO® XF 8021, and combinations thereof.

In another embodiment, the soy protein material may be a soy protein concentrate, which has a protein content of about 65% to less than about 90% on a moisture-free basis. Examples of suitable soy protein concentrates useful in the invention include the PROCON™ product line, ALPHA™ 12 and ALPHA™ 5800, all of which are commercially available from Solae, LLC. Alternatively, soy protein concentrate may be blended with the soy protein isolate to substitute for a portion of the soy protein isolate as a source of soy protein material. Typically, if a soy protein concentrate is substituted for a portion of the soy protein isolate, the soy protein concentrate is substituted for up to about 40% of the soy protein isolate by weight, at most, and more preferably is substituted for up to about 30% of the soy protein isolate by weight.

In yet another embodiment, the soy protein material may be soy flour, which has a protein content of about 49% to about 65% on a moisture-free basis. The soy flour may be defatted soy flour, partially defatted soy flour, or full fat soy flour. The soy flour may be blended with soy protein isolate or soy protein concentrate.

In an alternate embodiment, the soy protein material may be material that has been separated into four major storage protein fractions or subunits (15S, 11S, 7S, and 2S) on the basis of sedimentation in a centrifuge. In general, the 11S fraction is highly enriched in glycinins, and the 7S fraction is highly enriched in beta-conglycinins. In still yet another embodiment, the soy protein material may be protein from high oleic soybeans.

(b) Other Protein Materials

In another embodiment, the protein material may be derived from a plant other than soy. By way of non-limiting example, suitable plants include amaranth, arrowroot, barley, buckwheat, canola, cassava, channa (garbanzo), legumes, lentils, lupin, maize, millet, oat, pea, potato, rice, rye, sorghum, sunflower, tapioca, triticale, wheat, and mixtures thereof. Especially preferred plant proteins include barley, canola, lupin, maize, oat, pea, potato, rice, wheat, and combinations thereof. In one embodiment, the plant protein material may be canola meal, canola protein isolate, canola protein concentrate, or combinations thereof. In another embodiment, the plant protein material may be maize or corn protein powder, maize or corn protein concentrate, maize or corn protein isolate, maize or corn germ, maize or corn gluten, maize or corn gluten meal, maize or corn flour, zein protein, or combinations thereof. In still another embodiment, the plant protein material may be barley powder, barley protein concentrate, barley protein isolate, barley meal, barley flour, or combinations thereof. In an alternate embodiment, the plant protein material may be lupin flour, lupin protein isolate, lupin protein concentrate, or combinations thereof. In another alternate embodiment, the plant protein material may be oatmeal, oat flour, oat protein flour, oat protein isolate, oat protein concentrate, or combinations thereof. In yet another embodiment, the plant protein material may be pea flour, pea protein isolate, pea protein concentrate, or combinations thereof. In still another embodiment, the plant protein material may be potato protein powder, potato protein isolate, potato protein concentrate, potato flour, or combinations thereof. In a further embodiment, the plant protein material may be rice flour, rice meal, rice protein powder, rice protein isolate, rice protein concentrate, or combinations thereof. In another alternate embodiment, the plant protein material may be wheat protein powder, wheat gluten, wheat germ, wheat flour, wheat protein isolate, wheat protein concentrate, solubilized wheat proteins, or combinations thereof.

In other embodiments, the protein material may be derived from an animal source. In one embodiment, the animal protein material may be derived from eggs. Non-limiting examples of suitable egg proteins include powdered egg, dried egg solids, dried egg white protein, liquid egg white protein, egg white protein powder, isolated ovalbumin protein, and combinations thereof. Egg proteins may be derived from the eggs of chicken, duck, goose, quail, or other birds. In an alternate embodiment, the protein material may be derived from a dairy source. Suitable dairy proteins include non-fat dry milk powder, milk protein isolate, milk protein concentrate, acid casein, caseinate (e.g., sodium caseinate, calcium caseinate, and the like), whey protein isolate, whey protein concentrate, and combinations thereof. The milk protein material may be derived from cows, goats, sheep, donkeys, camels, camelids, yaks, water buffalos, etc. In a further embodiment, the protein may be derived from the muscles, organs, connective tissues, or skeletons of land-based or aquatic animals. As an example, the animal protein may be gelatin, which is produced by partial hydrolysis of collagen extracted from the bones, connective tissues, organs, etc, from cattle or other animals.

It is also envisioned that combinations of a soy protein material and at least one other protein material also may be used in the process of the invention. That is, a protein hydrolysate composition may be prepared from a combination of a soy protein material and at least one other protein material. In one embodiment, a protein hydrolysate composition may be prepared from a combination of a soy protein material and one other protein material selected from the group consisting of barley, canola, lupin, maize, oat, pea, potato, rice, wheat, animal material, dairy, and egg. In another embodiment, a protein hydrolysate composition may be prepared from a combination of a soy protein material and two other protein materials selected from the group consisting of barley, canola, lupin, maize, oat, pea, potato, rice, wheat, animal material, dairy, and egg. In further embodiments, a protein hydrolysate composition may be prepared from a combination of a soy protein material and three or more other protein materials selected from the group consisting of barley, canola, lupin, maize, oat, pea, potato, rice, wheat, animal material, dairy, and egg.

The concentrations of the soy protein material and the other protein material used in combination can and will vary. The amount of soy protein material may range from about 1% to about 99% of the total protein used in the combination. In one embodiment, the amount of soy protein material may range from about 1% to about 20% of the total protein used in combination. In another embodiment, the amount of soy protein material may range from about 20% to about 40% of the total protein used in combination. In still another embodiment, the amount of soy protein material may range from about 40% to about 80% of the total protein used in combination. In a further embodiment, the amount of soy protein material may range from about 80% to about 99% of the total protein used in combination. Likewise, the amount of the (at least one) other protein material may range from about 1% to about 99% of the total protein used in combination. In one embodiment, the amount of other protein material may range from about 1% to about 20% of the total protein used in combination. In another embodiment, the amount of other protein material may range from about 20% to about 40% of the total protein used in combination. In still another embodiment, the amount of other protein material may range from about 40% to about 80% of the total protein used in combination. In a further embodiment, the amount of other protein material may range from about 80% to about 99% of the total protein used in combination.

(c) Protein Slurry

In the process of the invention, the protein material is typically mixed or dispersed in water to form a slurry comprising about 1% to about 20% protein by weight (on an “as is” basis). In one embodiment, the slurry may comprise about 1% to about 5% protein (as is) by weight. In another embodiment, the slurry may comprise about 6% to about 10% protein (as is) by weight. In a further embodiment, the slurry may comprise about 11% to about 15% protein (as is) by weight. In still another embodiment, the slurry may comprise about 16% to about 20% protein (as is) by weight.

After the protein material is dispersed in water, the slurry of protein material may be heated from about 70° C. to about 90° C. for about 2 minutes to about 20 minutes to inactivate putative endogenous protease inhibitors. Typically, the pH and the temperature of the protein slurry are adjusted so as to optimize the hydrolysis reaction, and in particular, to ensure that the endopeptidase used in the hydrolysis reaction functions near its optimal activity level. The pH of the protein slurry may be adjusted and monitored according to methods generally known in the art. The pH of the protein slurry may be adjusted and maintained at from about pH 5.0 to about pH 10.0. In one embodiment, the pH of the protein slurry may be adjusted and maintained at from about pH 7.0 to about pH 8.0. In another embodiment, the pH of the protein slurry may be adjusted and maintained at from about pH 8.0 to about pH 9.0. In a preferred embodiment, the pH of the protein slurry may be adjusted and maintained at about pH 8.0. The temperature of the protein slurry is preferably adjusted and maintained at from about 40° C. to about 70° C. during the hydrolysis reaction in accordance with methods known in the art. In a preferred embodiment, the temperature of the protein slurry may be adjusted and maintained at from about 50° C. to about 60° C. during the hydrolysis reaction. In general, temperatures above this range may eventually inactivate the endopeptidase, while temperatures below or above this range tend to slow the activity of the endopeptidase.

(d) Endopeptidase

The hydrolysis reaction is generally initiated by adding an endopeptidase to the slurry of protein material. Several endopeptidases are suitable for use in the process of the invention. Preferably, the endopeptidase will be a food-grade enzyme. The endopeptidase may have optimal activity under the conditions of hydrolysis from about pH 6.0 to about pH 11.0, and more preferably, from about pH 7.0 to about pH 9.0, and at a temperature from about 40° C. to about 70° C., and more preferably from about 45° C. to about 60° C.

In general, the endopeptidase will be a member of the S1 serine protease family (MEROPS Peptidase Database, release 8.00A; //merops.sanger.ac.uk). Preferably, the endopeptidase will cleave peptide bonds on the carboxyl terminal side of arginine, lysine, or both residues. Thus, endopeptidase may be a trypsin-like endopeptidase, which cleaves peptide bonds on the carboxyl terminal side of arginine, lysine, or both. A trypsin-like endopeptidase in the context of the present invention may be defined as an endopeptidase having a Trypsin ratio of more than 100 (see Example 16). The trypsin-like endopeptidase may be a lysyl endopeptidase, which cleaves peptide bonds on the carboxyl terminal side of lysine residues. In preferred embodiments, the endopeptidase may be of microbial origin, and more preferably of fungal origin. Although trypsin and trypsin-like endopeptidases are available from other sources (e.g., animal sources), trypsins from animal sources may not be able to cleave the starting protein material, as shown in Example 14.

In one embodiment, the endopeptidase may be trypsin-like protease from Fusarium oxysporum (U.S. Pat. No. 5,288,627; U.S. Pat. No. 5,693,520, each of which is hereby incorporated by reference in its entirety). This endopeptidase is termed “TL1” and its protein sequence (SEQ ID NO:1) is presented in Table A. The accession number for TL1 is SWISSPROT No. P35049 and its MEROPS ID is S01.103. In another embodiment, the endopeptidase may be trypsin-like protease from Fusarium solani (International Patent Application WO20051040372-A1, which is incorporated herein in its entirety). This endopeptidase is termed “TL5,” and its protein sequence (SEQ ID NO:2) is presented in Table A. The accession number for TL5 is GENESEQP: ADZ80577. In still another embodiment, the endopeptidase may be trypsin-like protease from Fusarium cf. solani. This endopeptidase is termed “TL6.” and its protein sequence (SEQ ID NO:3) is presented in Table A. In a further embodiment, the endopeptidase may be lysyl endopeptidase from Achromobacter lyticus. This endopeptidase is termed “SP3,” and its protein sequence (SEQ ID NO:4) is presented in Table A. The accession number for SP3 is SWISSPROT No. 15636 and the MEROPS ID of SP3 is S01.280. In an exemplary embodiment, the endopeptidase may be TU.

TABLE A
Exemplary Trypsin-like Proteases.

| SEQ ID NO: | Identity | Sequence |
|---|---|---|
| 1 | Trypsin-like | MVKFASVVALVAPLAAAAPQEIPNIVGGTSASAG |
| | protease (TL1) | DFPFIVSISRNGGPWCGGSLLNANTVLTAAHCVS |
| | from Fusarium | GYAQSGFQIRAGSLSRTSGGITSSLSSVRVHPSY |
| | oxysporum | SGNNNDLAILKLSTSIPSGGNIGYARLAASGSDPV |
| | | AGSSATVAGWGATSEGGSSTPVNLLKVTVPIVSR |
| | | ATCRAQYGTSAITNQMFCAGVSSGGKDSCQGD |
| | | SGGPIVDSSNTLIGAVSWGNGCARPNYSGVYAS |
| | | VGALRSFIDTYA |
| 2 | Trypsin-like | MVKFAAILALVAPLVAARPQDSSPMIVGGTAASA |
| | protease (TL5) | GDFPFIVSIAYNGGPWCGGTLLNANTVMTAAHCT |
| | from Fusarium | QGRSASAFQVRAGSLNRNSGGVTSSVSSIRIHPS |
| | solani | FSSSTLNNDVSILKLSTPISTSSTISYGRLAASGSD |
| | | PVAGSDATVAGWGVTSQGSSSSPVALRKVTIPIV |
| | | SRTTCRSQYGTSAITTNMFCAGLAEGGKDSCQG |
| | | DSGGPIVDTSNTVIGIVSWGEGCAQPNLSGVYAR |
| | | VGSLRTYIDGQL |
| 3 | Trypsin-like | MVKFAAILALVAPLVAARPQDRPMIVGGTAASAG |
| | protease (TL6) | DFPFIVSIAYNGGPWCGGTLLNASTVLTAAHCTQ |
| | from | GRSASAFQVRAGSLNRNSGGVTSAVSSIRIHPSF |
| | Fusarium cf. | SGSTLNNDVSILKLSTPISTSSTISYGRLAASGSDP |
| | solani | AAGSDATVAGWGVTSQGSSSSPVALRKVTIPIVS |
| | | RTTCRSQYGTSAITTNMFCAGLAEGGKDSCQGD |
| | | SGGPIVDTSNTVIGIVSWGEGCAQPNFSGVYARV |
| | | GSLRSYIDGQL |
| 4 | Lysyl | MKRICGSLLLLGLSISAALAAPASRPAAFDYANLS |
| | endopeptidase | SVDKVALRTMPAVDVAKAKAEDLQRDKRGDIPR |
| | (SP3) from | FALAIDVDMTPQNSGAWEYTADGQFAVWRQRV |
| | Achromobacter | RSEKALSLNFGFTDYYMPAGGRLLVYPATQAPA |
| | lyticus | GDRGLISQYDASNNNSARQLWTAVVPGAEAVIE |
| | | AVIPRDKVGEFKLRLTKVNHDYVGFGPLARRLAA |
| | | ASGEKGVSGSCNIDVVCPEGDGRRDIIRAVGAYS |
| | | KSGTLACTGSLVNNTANDRKMYFLTAHHCGMGT |
| | | ASTAASIVVYWNYQNSTCRAPNTPASGANGDGS |
| | | MSQTQSGSTVKATYATSDFTLLELNNAANPAFNL |
| | | FWAGWDRRDQNYPGAIAIHHPNVAEKRISNSTS |
| | | PTSFVAWGGGAGTTHLNVQWQPSGGVTEPGSS |
| | | GSPIYSPEKRVLGQLHGGPSSCSATGTNRSDQY |
| | | GRVFTSWTGGGAAASRLSDWLDPASTGAQFIDG |
| | | LDSGGGTPNTPPVANFTSTTSGLTATFTDSSTDS |
| | | DGSIASRSWNFGDGSTSTATNPSKTYAAAGTYT |
| | | VTLTVTDNGGATNTKTGSVTVSGGPGAQTYTND |
| | | TDVAIPDNATVESPITVSGRTGNGSATTPIQVTIY |
| | | HTYKSDLKVDLVAPDGTVYNLHNRTGGSAHNIIQ |
| | | TFTKDLSSEAAQRAPGSCG |

In another embodiment, the endopeptidase may comprise an amino acid sequence that is at least 80%, 81%, 82%, 83%, 84%, or 85% identical to SEQ ID NOs: 1, 2, 3, 4, or a fragment thereof. In a further embodiment, the endopeptidase may comprise an amino acid sequence that is at least 86%, 87%, 88%, 89%, 90%, 91%, or 92% identical to SEQ ID NOs: 1, 2, 3, 4, or a fragment thereof. In yet another embodiment, the endopeptidase may comprise an amino acid sequence that is at least 93%, 94%, 95%, 96%, 97%, 98% or 99% identical to SEQ ID NOs: 1, 2, 3, 4, or a fragment thereof. The fragment of any of these sequences having protease activity may be the amino acid sequence of the active enzyme, e.g. after processing, such as after any signal peptide and/or propeptide has been cleaved off. Preferred fragments include amino acids 25-248 of SEQ ID NO:1, amino acids 26-251 of SEQ ID NO:2, amino acids 18-250 of SEQ ID NO:3, or amino acids 21-653 of SEQ ID NO:4.

For purposes of the present invention, the alignment of two amino acid sequences may be determined by using the Needle program from the EMBOSS package (Rice, P., Longden, I. and Bleasby, A. (2000) EMBOSS: The European Molecular Biology Open Software Suite. Trends in Genetics 16, (6) pp 276-277; http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5. In general, the percentage of sequence identity is determined by comparing two optimally aligned sequences over a comparison window, wherein the portion of the amino acid sequence in the comparison window may comprise additions or deletions (i.e., gaps) as compared to the reference sequence (which does not comprise additions or deletions) for optimal alignment of the two sequences. The percentage is calculated by determining the number of positions at which an identical amino acid occurs in both sequences to yield the number of matched positions, dividing the number of matched positions by the total number of positions in the shortest of the two sequences in the window of comparison, and multiplying the result by 100 to yield the percentage of sequence identity.

A skilled practitioner will understand that an amino acid residue may be substituted with another amino acid residue having a similar side chain without affecting the function of the polypeptide. For example, a group of amino acids having aliphatic side chains is glycine, alanine, valine, leucine, and isoleucine; a group of amino acids having aliphatic-hydroxyl side chains is serine and threonine; a group of amino acids having amide-containing side chains is asparagine and glutamine; a group of amino acids having aromatic side chains is phenylalanine, tyrosine, and tryptophan; a group of amino acids having basic side chains is lysine, arginine, and histidine; and a group of amino acids having sulfur-containing side chains is cysteine and methionine. Preferred conservative amino acid substitution groups include: valine-leucine-isoleucine, phenylalanine-tyrosine, lysine-arginine, alanine-valine, and asparagine-glutamine. Thus, the endopeptidase may have at least one conservative amino acid substitution with respect to SEQ ID NOs:1, 2, 3, or 4. In one embodiment, the endopeptidase may have about 50 conservative amino acid substitutions with respect to SEQ ID NOs:1, 2, 3, or 4. In another embodiment, the endopeptidase may have about 40 conservative amino acid substitutions with respect to SEQ ID NOs:1, 2, 3, or 4. In yet another embodiment, the endopeptidase may have about 30 conservative amino acid substitutions with respect to SEQ ID NOs:1, 2, 3, or 4. In another alternate embodiment, the endopeptidase may have about 20 conservative amino acid substitutions with respect to SEQ ID NOs:1, 2, 3, or 4. In still another embodiment, the endopeptidase may have about 10 conservative amino acid substitutions with respect to SEQ ID NOs:1, 2, 3, or 4. In yet another embodiment, the endopeptidase may have about 5 conservative amino acid substitutions with respect to SEQ ID NOs:1, 2, 3, or 4. In a further embodiment, the endopeptidase may have about one conservative amino acid substitution with respect to SEQ ID NOs:1, 2, 3, or 4.

Various combinations of protein material and endopeptidase are presented in Table B.

TABLE B
Preferred Combinations.

| Protein Material | Endopeptidase |
|---|---|
| Soy | Trypsin-like protease |
| Soy | TL1 |
| Soy | TL5 |
| Soy | TL6 |
| Soy | SP3 |
| Barley | Trypsin-like protease |
| Barley | TL1 |
| Barley | TL5 |
| Barley | TL6 |
| Barley | SP3 |
| Canola | Trypsin-like protease |
| Canola | TL1 |
| Canola | TL5 |
| Canola | TL6 |
| Canola | SP3 |
| Lupin | Trypsin-like protease |
| Lupin | TL1 |
| Lupin | TL5 |
| Lupin | TL6 |
| Lupin | SP3 |
| Maize | Trypsin-like protease |
| Maize | TL1 |
| Maize | TL5 |
| Maize | TL6 |
| Maize | SP3 |
| Oat | Trypsin-like protease |
| Oat | TL1 |
| Oat | TL5 |
| Oat | TL6 |
| Oat | SP3 |
| Pea | Trypsin-like protease |
| Pea | TL1 |
| Pea | TL5 |
| Pea | TL6 |
| Pea | SP3 |
| Potato | Trypsin-like protease |
| Potato | TL1 |
| Potato | TL5 |
| Potato | TL6 |
| Potato | SP3 |
| Rice | Trypsin-like protease |
| Rice | TL1 |
| Rice | TL5 |
| Rice | TL6 |
| Rice | SP3 |
| Wheat | Trypsin-like protease |
| Wheat | TL1 |
| Wheat | TL5 |
| Wheat | TL6 |
| Wheat | SP3 |
| Egg | Trypsin-like protease |
| Egg | TL1 |
| Egg | TL5 |
| Egg | TL6 |
| Egg | SP3 |
| Dairy | Trypsin-like protease |
| Dairy | TL1 |
| Dairy | TL5 |
| Dairy | TL6 |
| Dairy | SP3 |
| Animal (e.g., gelatin) | Trypsin-like protease |
| Animal (e.g., gelatin) | TL1 |
| Animal (e.g., gelatin) | TL5 |
| Animal (e.g., gelatin) | TL6 |
| Animal (e.g., gelatin) | SP3 |
| Soy and Barley | Trypsin-like protease |
| Soy and Barley | TL1 |
| Soy and Barley | TL5 |
| Soy and Barley | TL6 |
| Soy and Barley | SP3 |
| Soy and Canola | Trypsin-like protease |
| Soy and Canola | TL1 |
| Soy and Canola | TL5 |
| Soy and Canola | TL6 |
| Soy and Canola | SP3 |
| Soy and Lupin | Trypsin-like protease |
| Soy and Lupin | TL1 |
| Soy and Lupin | TL5 |
| Soy and Lupin | TL6 |
| Soy and Lupin | SP3 |
| Soy and Maize | Trypsin-like protease |
| Soy and Maize | TL1 |
| Soy and Maize | TL5 |
| Soy and Maize | TL6 |
| Soy and Maize | SP3 |
| Soy and Oat | Trypsin-like protease |
| Soy and Oat | TL1 |
| Soy and Oat | TL5 |
| Soy and Oat | TL6 |
| Soy and Oat | SP3 |
| Soy and Pea | Trypsin-like protease |
| Soy and Pea | TL1 |
| Soy and Pea | TL5 |
| Soy and Pea | TL6 |
| Soy and Pea | SP3 |
| Soy and Potato | Trypsin-like protease |
| Soy and Potato | TL1 |
| Soy and Potato | TL5 |
| Soy and Potato | TL6 |
| Soy and Potato | SP3 |
| Soy and Rice | Trypsin-like protease |
| Soy and Rice | TL1 |
| Soy and Rice | TL5 |
| Soy and Rice | TL6 |
| Soy and Rice | SP3 |
| Soy and Wheat | Trypsin-like protease |
| Soy and Wheat | TL1 |
| Soy and Wheat | TL5 |
| Soy and Wheat | TL6 |
| Soy and Wheat | SP3 |
| Soy and Egg | Trypsin-like protease |
| Soy and Egg | TL1 |
| Spy and Egg | TL5 |
| Soy and Egg | TL6 |
| Soy and Egg | SP3 |
| Soy and Dairy | Trypsin-like protease |
| Soy and Dairy | TL1 |
| Soy and Dairy | TL5 |
| Soy and Dairy | TL6 |
| Soy and Dairy | SP3 |
| Soy and Animal (e.g., gelatin) | Trypsin-like protease |
| Soy and Animal (e.g., gelatin) | TL1 |
| Soy and Animal (e.g., gelatin) | TL5 |
| Soy and Animai (e.g., gelatin) | TL6 |
| Soy and Animal (e.g., gelatin) | SP3 |

The amount of endopeptidase added to the protein material can and will vary depending upon the source of the protein material, the desired degree of hydrolysis, and the duration of the hydrolysis reaction. The amount of endopeptidase may range from about 1 mg of enzyme protein to about 5000 mg of enzyme protein per kilogram of protein material. In another embodiment, the amount may range from 10 mg of enzyme protein to about 2000 mg of enzyme protein per kilogram of protein material. In yet another embodiment, the amount may range from about 50 mg of enzyme protein to about 1000 mg of enzyme protein per kilogram of protein material.

As will be appreciated by a skilled artisan, the duration of the hydrolysis reaction can and will vary. Generally speaking, the duration of the hydrolysis reaction may range from a few minutes to many hours, such as, from about 30 minutes to about 48 hours. To end the hydrolysis reaction, the composition may be heated to a temperature that is high enough to inactivate the endopeptidase. For example, heating the composition to a temperature of approximately 90° C. will substantially heat-inactivate the endopeptidase.

(II) Preparation of a Frozen Confection Containing a Protein Hydrolysate

The frozen confections detailed in (I), above, are comprised of any of the protein hydrolysate compositions detailed in (I)A, and any edible material. Alternatively, the frozen confections may comprise any of the protein hydrolysate compositions in lieu of dairy. Alternatively, the frozen confections may comprise an edible material and any of the isolated polypeptide fragments described herein.

A. Inclusion of the Protein Hydrolysate Composition

The concentration of protein hydrolysate in the frozen confections can and will vary depending on the product being made. In embodiments comprising a high percentage of dairy protein, the percentage of protein hydrolysate will be low. Whereas, in embodiments without added dairy protein, the percentage of protein hydrolysate in the various frozen confections will be high. Thus, the concentration of the protein hydrolysate of the protein ingredient in the various frozen confections may be less than about 1%, 2%, 5%, 10%. 15%, 20%, 25%, 30%, 35%, 40%, 45%, 50%, 60%, 65%, 70%, 75%, 80%, 85%, 90%, 95%, and 100% by weight.

The selection of a particular protein hydrolysate composition to combine with an edible material can and will vary depending upon the desired frozen confection product. In some embodiments, the protein hydrolysate composition may be derived from barley, canola, lupin, maize, oat, pea, potato, rice, wheat, animal, egg, or combinations thereof. In still other embodiments, the protein hydrolysate composition may be derived from a combination of soy and at least one other protein source selected from the group consisting of barley, canola, lupin, maize, oat, pea, potato, rice, wheat, animal, dairy, and egg. In alternative embodiments, the protein hydrolysate composition may comprise a combination of different protein hydrolysates. In additional embodiments, the protein hydrolysate composition may comprise isolated or synthetic polypeptides selected from the group of amino acid sequences consisting of SEQ ID NO:5-274.

The degree of hydrolysis of the protein hydrolysate composition will also vary depending upon the starting material used to make the hydrolysate and the desired frozen confection. For example, with a frozen confection resembling ice cream that is comprised an amount of a soy-containing protein hydrolysate composition, in certain embodiments where it may be desirable to minimize the bitter sensory attribute, a soy protein hydrolysate composition having a degree of hydrolysis closer to or less than 1% rather than 6% may be selected. Additionally, in alternative embodiments, when it may be desirable to minimize the grain and soy/legume sensory attributes in a frozen confection, a soy protein hydrolysate composition having a degree of hydrolysis closer to or greater than 6% rather than 1% may be selected.

B. Optional Blending with Dairy

The protein hydrolysate composition may optionally be blended with dairy. In some embodiments, the concentration of dairy may be about 95%, 90%, 80%, 70%, 60%, or 50% by weight, and the concentration of the protein hydrolysate may be about 5%, 10%, 20%, 30%, 40%, or 50% by weight. In other embodiments, the concentration of dairy may be about 40%, 30%, 20%, 10%, 5%, or 0% by weight, and the concentration of the protein hydrolysate may be about 60%, 70%, 80%, 90%, 95%, or 100% by weight. In one embodiment, the concentration of dairy may range from about 50% to about 95% by weight, and the concentration of the protein hydrolysate may range from about 5% to about 50% by weight. In another embodiment, the concentration of dairy may range from about 0% to about 50% by weight, and the concentration of the protein hydrolysate may range from about 50% to about 100% by weight.

C. Processing into Frozen Confection Products

The processes used to make the frozen confection products containing a protein hydrolysate are similar to the processes used to make frozen confection with one hundred percent dairy.

The frozen confection containing a protein hydrolysate will be processed into a variety of frozen confection products having a variety of shapes. The frozen confections produced can be any frozen confection product known in the industry. In a preferred embodiment, the frozen confection may be an ice cream or resemble an ice cream. Non-limiting examples of frozen confections include, sherbet, water ice, mellorine, frozen yogurt, frozen custard, popsicles, sorbet, gelato, or combinations thereof. The frozen confection may be combined with other edible ingredients such as wafers, cookies or cones as in an ice cream sandwich or ice cream cone, or an appropriate sauce (such as caramel, chocolate sauce, fruit sauce, etc.) as in a sundae. Additionally, the frozen confection may contain edible inclusions (such as chocolate chips, fruit pieces, candies, cake pieces, brownie pieces, cookie dough, cookie pieces, nuts, etc.) or non-edible inclusions (popsicle sticks, etc.). The frozen confection may also be formed into an extruded shape.

Generally, the edible material in a frozen confection is comprised of skim milk, reduced fat milk, 2% milk, whole milk, cream, evaporated milk, yogurt, buttermilk, dry milk powder, non-fat dry milk powder, milk proteins, acid casein, caseinate (e.g., sodium caseinate, calcium caseinate, etc.), whey protein concentrate, whey protein isolate, soy protein isolate, soy protein hydrolysate, whey hydrolysate, chocolate, cocoa powder, coffee, tea, fruit juices, vegetable juices, and any other ingredient known and used in the industry. The frozen confection may further comprise sweetening agents (such as glucose, sucrose, fructose, maltodextrin, sucralose, corn syrup (liquid or solids), honey, maple syrup, etc.), flavoring agents (e.g., chocolate, chocolate extract, cocoa, vanilla extract, pure vanilla, vanillin, vanilla flavor, malt powder, fruit flavors, mint, caramel, green tea, hazelnut, ginger, coconut, pistachio, salt, etc.), emulsifying or thickening agents (e.g., lecithin, carrageenan, cellulose gum, cellulose gel, starch, gum arabic, xanthan gum, and any other thickening agent known and used in the industry); stabilizing agents, lipid materials (e.g., canola oil, sunflower oil, high oleic sunflower oil, fat powder, etc.), preservatives (e.g., potassium sorbate, sorbic acid, and any other preservatives known and used in the industry), antioxidants (e.g., ascorbic acid, sodium ascorbate, etc.), coloring agents, vitamins, minerals, or combinations thereof.

In a preferred embodiment, the frozen confection product may resemble ice cream. The “ice cream” product may be formed by the process common to all ice cream products, which includes ingredient blending, pasteurization, homogenization, cooling, aging, freezing, packaging, and hardening. The flavoring agents may be added after the pasteurization step in a flavor tank. Ingredients may be either liquid or dry, or a combination of both. Products can be manufactured by batch or by continuous processes. The blending temperature depends upon the nature of the ingredients, but it must be above the melting point of any fat and sufficient to hydrate gums used as stabilizers. Pasteurization is generally carried out at high temperatures for short periods of time, in which the homogenizer is integrated into the pasteurization system, as described inter alia by the FDA's Bacteriological Analytical Manual, herein incorporated by reference. Freezing and packaging may be used, based on typical industry standards to complete the process and produce products that remain at shelf-stable temperatures at or below 0° F.

The process for making the frozen confection composition of the present invention may further comprise a heat treatment to pasteurize or sterilize the frozen confection composition. The pasteurization is performed before the confection composition is frozen. Pasteurization generally comprises heating at a temperature of from about 155° F. to about 270° F., and more typically from about 175° F. to about 195° F., at a pressure of from about 0.1 to about 10 atmospheres, and more typically from about 1 to about 1.5 atmospheres, at a time of from about 3 seconds to about 30 minutes, and more typically from about 4 seconds to about 25 seconds. The heating, pressure, and time parameters are independent of each other.

The process for making the frozen confection composition of the present invention may further comprise homogenizing the confection composition prior to it being frozen to help uniformly disperse the proteins in the frozen confection composition. The frozen confection composition is usually at a temperature range of 145° F. to 170° F. for homogenization. Specifically, this homogenization allows for the frozen confection composition to have a more uniform suspension of the fat by reducing the size of the fat droplets to a very small diameter or particle size. Suitably, the frozen confection composition prior to freezing can be homogenized with high speed, high shear mixing at about 1000 pounds per square inch to about 4000 pounds per square inch using a single-stage homogenization procedure. Alternatively, a multi-stage homogenization procedure may also be used wherein the total pressure of all the stages are between about 1000 pounds per square inch and about 4000 pounds per square inch. For example, in a two-stage procedure, the first homogenization stage is from about 2000 pounds per square inch to about 3,000 pounds per square inch and the second homogenization stage is from about 250 pounds per square inch to about 750 pounds per square inch.

The pasteurization and homogenization procedures may be carried out independently of each other or may be carried out sequentially, that is, both the pasteurization and homogenization procedures are employed, with the pasteurization being done first followed by homogenization. The parameters for pasteurization and homogenization, when used singly are the same parameters when both are used.

When using the protein hydrolysate composition described herein to replace other protein sources in frozen confection products, the preferred protein replacement amount is up to 100%. When using the protein hydrolysate composition described herein to partially replace dairy protein in frozen confections, the preferred protein replacement amount is 20-35%, and the most preferred protein replacement amount is 30%.

### DEFINITIONS

To facilitate understanding of the invention, several terms are defined below.

The term “frozen confection” broadly refers to a frozen mixture of a combination of safe and suitable ingredients including, but not limited to, milk, sweetener, stabilizers, emulsifiers, coloring, and flavoring. Other ingredients such as egg products and starch hydrolysates may also be included. Specific frozen confections include ice cream and its lower fat varieties, frozen custards, mellorine (vegetable fat-containing frozen desserts), sherbets, and water ices. Some of these products are served in either soft frozen or hard frozen form. Also included as frozen confections would be parevine-type products (non-dairy frozen desserts), which are similar to ice cream and its various forms except that the dairy has been replaced by safe and suitable ingredients.

The term “degree of hydrolysis” refers to the percentage of the total peptide bonds that are cleaved.

The term “endopeptidase” refers to an enzyme that hydrolyzes internal peptide bonds in oligopeptide or polypeptide chains. The group of endopeptidases comprises enzyme subclasses EC 3.4.21-25 (International Union of Biochemistry and Molecular Biology enzyme classification system).

A “food grade enzyme” is an enzyme that is generally recognized as safe (GRAS) approved and is safe when consumed by an organism, such as a human. Typically, the enzyme and the product from which the enzyme may be derived are produced in accordance with applicable legal and regulatory guidelines.

A “hydrolysate” is a reaction product obtained when a compound is cleaved through the effect of water. Protein hydrolysates occur subsequent to thermal, chemical, or enzymatic degradation. During the reaction, large molecules are broken into smaller proteins, soluble proteins, peptide fragments, and free amino acids.

The term “sensory attribute,” such as used to describe terms like “grain,” “soy/legume,” or “bitter” is determined in accordance with the SQS Scoring System as specifically delineated in Example 6.

The term “soluble solids index” refers to the percentage of soluble proteins or soluble solids.

The terms “soy protein isolate” or “isolated soy protein,” as used herein, refer to a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “soy protein concentrate” as used herein is a soy material having a protein content of from about 65% to less than about 90% soy protein on a moisture-free basis. Soy protein concentrate also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon, and separating the soy protein and soy cotyledon fiber from the soluble carbohydrates of the cotyledon.

The term “soy flour” as used herein, refers to a comminuted form of defatted, partially defatted, or full fat soybean material having a size such that the particles can pass through a No. 100 mesh (U.S. Standard) screen. The soy cake, chips, flakes, meal, or mixture of the materials are comminuted into soy flour using conventional soy grinding processes. Soy flour has a soy protein content of about 49% to about 65% on a moisture free basis. Preferably the flour is very finely ground, most preferably so that less than about 1% of the flour is retained on a 300 mesh (U.S. Standard) screen.

The term “soy cotyledon fiber” as used herein refers to the polysaccharide portion of soy cotyledons containing at least about 70% dietary fiber. Soy cotyledon fiber typically contains some minor amounts of soy protein, but may also be 100% fiber. Soy cotyledon fiber, as used herein, does not refer to, or include, soy hull fiber. Generally, soy cotyledon fiber is formed from soybeans by removing the hull and germ of the soybean, flaking or grinding the cotyledon and removing oil from the flaked or ground cotyledon, and separating the soy cotyledon fiber from the soy material and carbohydrates of the cotyledon.

A “trypsin-like serine protease” is an enzyme that preferentially cleaves a peptide bond on the carboxyl terminal side of an arginine residue or a lysine residue.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above compounds, products and methods without departing from the scope of the invention, it is intended that all matter contained in the above description and in the examples given below, shall be interpreted as illustrative and not in a limiting sense.

### EXAMPLES

The following examples illustrate embodiments of the invention.

### Example 1

### Hydrolysis of Isolated Soy Proteins with the Trypsin Like Endopeptidase, TL1

Isolated soy protein was hydrolyzed into smaller peptide fragments in an attempt to increase its solubility and improve its sensory characteristics. The fungal trypsin-like peptidase from Fusarium oxysporum, TL1, the sequence of which is shown as SEQ ID NO:1 of the present application, was chosen because it cleaves peptide bonds at the C-terminal side of arginine or lysine residues, whereas other peptidases have been shown to cleave random peptide bonds in soy proteins.

An 8% slurry of isolated soy protein (ISP) was made by dispersing 320 g of SUPRO® 500E, Solae, St. Louis, Mo.) in 3680 g of water using moderate mixing to reduce foaming. Two drops of a defoamer were added, if necessary. The solution was heated to 80° C. for 5 min to inactivate any serine protease inhibitors that may have been present. The mixture was cooled to 50° C. and the pH was adjusted to 8.0 with food-grade KOH (a 50% w/w solution). Aliquots (800 mL) of the 8% soy protein slurry were incubated at 50° C. for 60 min in the presence of 0, 75 mg, 350 mg, 650 mg, or 950 mg of TL1/kg of soy protein. The samples were heated to 85° C. for 5 min to inactivate the enzyme. The samples were chilled on ice and stored at 4° C.

The degree of hydrolysis (% DH) refers to the percent of specific peptide bonds that were hydrolyzed (that is, the number of cleaved out of the total number of peptide bonds present in the starting protein). The % DH was estimated using the trinitrobenzene sulfonic acid (TNBS) method. This procedure is an accurate, reproducible and generally applicable procedure for determining the degree of hydrolysis of food protein hydrolysates. For this, 0.1 g of the soy protein hydrolysate was dissolved in 100 mL of 0.025 N NaOH. An aliquot (2.0 mL) of the hydrolysate solution was mixed with 8 mL of 0.05 M sodium borate buffer (pH 9.5). Two mL of the buffered hydrolysate solution was treated with 0.20 mL of 10% trinitrobenzene sulfonic acid, followed by incubation in the dark for 15 minutes at room temperature. The reaction was quenched by adding 4 mL of a 0.1 M sodium sulfite-0.1 M sodium phosphate solution (1:99 ratio), and the absorbance was read at 420 nm. A 0.1 mM glycine solution was used as the standard. The following calculation was used to determine the percent recovery for the glycine standard solution: [(absorbance of glycine at 420 nm−absorbance of blank at 420 nm)×(10010.710)]. Values of 94% or higher were considered acceptable.

Table 1 presents the mean TNBS values and the % DH for each sample. It appears that hydrolysis began to plateau around 6% OH, which could reflect the number of arginine and lysine sites readily available to be cleaved. This experiment suggests that digestion with 350 mg/kg of TL1 for one hour produced sufficient hydrolysis products.

TABLE 1
Degree of Hydrolysis of Soy Protein Hydrolysates

| | | TNBS Value | |
|---|---|---|---|
| | | (moles NH₂ per | |
| Sample # | Description | 100 kg protein) | DH (%) |
| 0 | 0 TL1 mg/kg | 24 | 0 |
| 23-1 | 75 TL1 mg/kg | 51 | 3.0 |
| 23-2 | 350 TL1 mg/kg | 70 | 5.2 |
| 23-3 | 850 TL1 mg/kg | 75 | 5.8 |
| 24-4 | 950 TL1 mg/kg | 78 | 6.1 |

### Example 2

### SDS-PAGE Analysis of TL1 Hydrolysates

TL1 hydrolysates with 0.3%, 2.2%, 3.1%, 4.0%, and 5.0% DH were prepared essentially as described in Example 1. Aliquots of each, and non-hydrolyzed isolated soy protein, were resolved by SDS-PAGE using standard procedures. This analysis permitted comparison of molecular sizes of the polypeptides in the soy hydrolysates with those of the starting soy proteins. FIG. 1 presents an image of a Coomassie stained gel. The non-hydrolyzed isolated soy protein comprises polypeptides ranging in size from about 5 kDa to about 100 kDa. Although the size range of the polypeptides in the 0.3% DH hydrolysate was similar to that of the starting material, this hydrolysate contained additional small polypeptide fragments. The hydrolysates with higher % DH essentially lacked polypeptides larger than about 20-30 kDa, and all had additional small (<5 kDa) polypeptides. The polypeptide patterns of the 2.2%, 3.1%, and 4.0% DH hydrolysates were quite similar. The 5.0% DH hydrolysate, however, had a narrower range of polypeptide sizes (˜0.1-20 kDa) than the other hydrolysates. In particular, the 7S and 11S subunit bands were not present in the 5.0% DH hydrolysate (see FIG. 1, lane 8).

### Example 3

### Analysis of Peptide Fragments in TL1 Hydrolysates by LC-MS

Peptide fragments in the TL1 hydrolysates prepared in Example 1 were identified by liquid chromatography mass spectrometry (LC-MS). Samples were prepared for LC-MS analysis by mixing an aliquot containing 2 mg of each TL1 hydrolysate with 0.1% formic acid (1 mL) in a glass vial and vortexing for 1-2 min. The mixture was centrifuged at 13,000 rpm for 5 min. An aliquot (25 μL) of the supernatant was injected into C18 analytical HPLC column (15 cm×2.1 mm id, 5 μm; Discovery Bio Wide Pore, Supelco, Sigma-Aldrich, St. Louis, Mo.) on a HP-1100 (Hewlett Packard; Palo Alto, Calif.) HPLC instrument. The elution profile is presented in Table 2; solvent A was 0.1% formic acid; solvent B was 0.1% formic acid in acetonitrile, the flow rate was 0.19 mL/min, and the column thermostat temperature was 25° C.

TABLE 2
HPLC Solvent Elution Profile

| Time | | Solvent B |
|---|---|---|
| (min) | Solvent A (%) | (%) |
| 0 | 95 | 5 |
| 35 | 55 | 45 |
| 37 | 55 | 45 |
| 39 | 10 | 90 |
| 42 | 10 | 90 |
| 44 | 95 | 5 |
| 45 | 95 | 5 |

An aliquot (10 μL) of the LC eluent was delivered to the ESI-MS source using a splitter system for MS analysis. A Thermo Finnigan LCQ Deca ion trap mass spectrometer was used to analyze the peptides with data dependent MS/MS and data dependent MS/MS with dynamic exclusion scan events. ESI-MS was conducted at positive ion mode with capillary temperature 225° C., electrospray needle was set at a voltage 5.0 kV, and scan range from m/z 400-2000. The raw MS/MS data was deconvoluted by Sequest search engine (BIOWORKS™ software. Thermo Fisher Scientific, Pittsburgh, Pa.) with no enzyme search parameters. Peptides were identified by searching a standard database such as the National Center for Biotechnology Information (NCBI) at the National Institutes of Health or Swiss-Prot from the Swiss Institute of Bioinformatics.

The peptides are presented in Table 3. Nearly every peptide fragment had an arginine or a lysine at the carboxyl terminus (three fragments had glutamine at the carboxyl terminus). Approximately twice as many fragments terminated with an arginine residue than with a lysine residue.

Identification of the peptide fragments revealed that hydrolysis products of the alpha-subunit of beta-conglycinin, beta-subunit of beta-conglycinin, glycinin subunit G1, glycinin subunit G3, and glycinin Gy4 were present in each TL1 hydrolysate. Many of the same peptide fragments were detected in each hydrolysate. The 5.8% DH and 6.1% DH hydrolysates also contained fragments from P 24 oleosin isoform A. The 6.1% DH hydrolysate revealed the presence of fragments from additional protein, trypsin inhibitor Kti3.

TABLE 3
Peptide Fragments in Hydrolysates with Different Degree of Hydrolysis (DH)

| | 3.0% DH | | 5.2% DH | | 5.8% DH | | 6.1% DH | |
|---|---|---|---|---|---|---|---|---|
| | SEQ ID | | SEQ ID | | SEQ ID | | SEQ ID | |
| Protein | NO | Sequence | NO | Sequence | NO | Sequence | NO | Sequence |
| Alpha- | 5 | YSNKLGK | 23 | SGDALR | 24 | FETLFK | 38 | SSSRK |
| subunit of | 6 | RFETLFK | 24 | FETLFK | 8 | SRDPIYSNK | 23 | SGDALR |
| beta- | 7 | SPQLQNLR | 7 | SPQLQNLR | 9 | SSEDKPFNLR | 24 | FETLFK |
| conglycinin | 8 | SRDPIYSNK | 8 | SRDPIYSNK | 7 | SPQLQNLR | 7 | SPQLQNLR |
| | 9 | SSEDKPFNL | 25 | KTISSEDKPF | 36 | EQQEEQPLE | 39 | FFEITPEK |
| | | R | | NLR | | VR | | |
| | | | | | 25 | KTISSEDKPF | 8 | SRDPIYSNK |
| | | | | | | NLR | | |
| | | | | | 37 | LQESVIVEIS | 37 | LQESVIVEISK |
| | | | | | | KEQIR | | EQIR |
| | | | | | | | 40 | VLFSREEGQ |
| | | | | | | | | QQGEQFR |
| Beta-subunit | 10 | SSEDEPFNL | 26 | SPQLENLR | 26 | SPQLENLR | 42 | LLQR |
| of beta- | | R | | | | | | |
| conglycinin | 11 | NFLAGEKD | 27 | LAGEKDNVV | 27 | LAGEKDNVV | 43 | FNKR |
| | | NVVR | | R | | R | | |
| | | | 11 | NFLAGEKDN | 11 | NFLAGEKDN | 26 | SPQLENLR |
| | | | | VVR | | VVR | | |
| | | | 28 | KTISSEDEPF | 41 | LKVREDENN | 11 | NFLAGEKDN |
| | | | | NLR | | PFYLR | | VVR |
| | | | 29 | VREDENNPF | | | | |
| | | | | YLR | | | | |
| Glycinin | 12 | NNNPFK | 30 | PPQESQKR | 44 | PDNR | 45 | TLNR |
| subunit G1 | 13 | LSAEFGSLR | 13 | LSAEFGSLR | 45 | TLNR | 50 | SQQAR |
| (proglycinin | 14 | SQSDNFEY | 31 | LNALKPDNR | 46 | PQQR | 47 | YNFR |
| A1aB1b) | | VSFK | | | | | | |
| | 15 | PEEVIQHTF | 32 | VFDGELQEG | 47 | YNFR | 12 | NNNPFK |
| | | NLK | | R | | | | |
| | 16 | FYLAGNQE | 14 | SQSDNFEYV | 12 | NNNPFK | 13 | LSAEFGSLR |
| | | QEFLK | | SFK | | | | |
| | 17 | RFYLAGNQ | 15 | PEEVIQHTF | 13 | LSAEFGSLR | 48 | PQNFVVAAR |
| | | EQEFLK | | NLK | | | | |
| | | | 16 | FYLAGNQEQ | 48 | PQNFVVAAR | 31 | LNALKPDNR |
| | | | | EFLK | | | | |
| | | | | | 32 | VFDGELQEG | 32 | VFDGELQEG |
| | | | | | | R | | R |
| | | | | | 49 | LAGNQEQEF | 14 | SQSDNFEYV |
| | | | | | | LK | | SFK |
| | | | | | 14 | SQSDNFEYV | 15 | PEEVIQHTFN |
| | | | | | | SFK | | LK |
| | | | | | 15 | PEEVIQHTF | 16 | FYLAGNQEQ |
| | | | | | | NLK | | EFLK |
| | | | | | 16 | FYLAGNQEQ | | |
| | | | | | | EFLK | | |
| Glycinin | 18 | PPKESQR | 18 | PPKESQR | 19 | LSAQFGSLR | 18 | PPKESQR |
| subunit G3 | 19 | LSAQFGSL | 19 | LSAQFGSLR | 120 | LAGNQEQEF | 19 | LSAQFGSLR |
| (glycinin | | R | | | | LQ | | |
| A1bB2) | 20 | FYLAGNQE | 33 | PEEVIQQTF | 18 | PPKESQR | | |
| | | QEFLQ | | NLR | | | | |
| | | | 20 | FYLAGNQEQ | | | | |
| | | | | EFLQ | | | | |
| Glycinin Gy4 | 21 | SKKTQPR | 22 | PSEVLAHSY | 51 | ADFYNPK | 51 | ADFYNPK |
| A5A4B3 | | | | NLR | | | | |
| | 22 | PSEVLAHSY | 34 | ISTLNSLTLP | 52 | MIIIAQGK | 52 | MIIIAQGK |
| | | NLR | | ALR | | | | |
| | | | 35 | KQIVTVEGG | 53 | PETMQQQQ | 53 | PETMQQQQQ |
| | | | | LSVISPK | | QQK | | QK |
| | | | | | 22 | PSEVLAHSY | 22 | PSEVLAHSYN |
| | | | | | | NLR | | LR |
| | | | | | 35 | KQIVTVEGG | 34 | ISTLNSLTLPA |
| | | | | | | LSVISPK | | LR |
| | | | | | | | 35 | KQIVTVEGGL |
| | | | | | | | | SVISPK |
| P 24 oleosin | | | | | 54 | HSER | 57 | TKEVGQDIQS |
| isoform A | | | | | | | | K |
| | | | | | 55 | YEAGVVPPG | 56 | HHLAEAAEYV |
| | | | | | | AR | | GQK |
| | | | | | 56 | HHLAEAAEY | | |
| | | | | | | VGQK | | |
| Trypsin | | | | | | | 58 | LVVSK |
| inhibitor Kti3 | | | | | | | 59 | DAMDGWFR |

### Example 4

### Analysis of Peptide Fragments in TL1 Hydrolysate With a High Degree of Hydrolysis via MALDI-MS

Peptide fragments in the 6.1% DH soy hydrolysate prepared in Example 1 were also analyzed by matrix-assisted laser desorption ionization time of flight mass spectrometry (MALDI-TOF/TOF-MS). The sample was prepared for and analyzed by HPLC as described in Example 3, except that the final elution step was extended to about 50 minutes and fractions were collected on a Bio-Rad fraction collector at 1 minute intervals. Fractions #4-48 were evaporated completely on a Genevac evaporator at <30° C.

For this, the dried samples were dissolved in 200 μL of a solution of 1% trifluoracetic acid (TFA) in 50% acetonitrile. An aliquot (1.5 μL) of each sample was mixed with 1.5 μL of MALDI matrix solution (6.2 mg of alpha-cyano-4-hydroxy cinnamic acid/ml of 36% methanol (v/v), 56% acetonitrile (v/v), and 8% water). The sample was vortexed, centrifuged, and 1 μL was spotted on a MALDI stainless steel target plate. The thirteen samples with high quality MS spectra were selected for further purification and MS/MS analysis. Each fraction was dried and resuspended in 10 μL of a solution of 0.1% formic acid in 1% acetonitrile in a PCR tube, vortexed for 30 sec, and centrifuged at 2000 rpm for 10 seconds. The vortexing and spinning was repeated 5 times. Peptide mixtures were purified by using a NuTip (10 μL porous graphite carbon SPE tip). A pre wetted (0.1% formic acid in 60% acetonitrile followed by equilibration with 0.1% formic acid) tip was used to extract peptides from the PCR tube containing the sample. The entire sample solution was drawn up into the tip and expelled back to the tube for a total of 50 times. The sample loaded tip was then washed (drawn and expelled) with 0.1% formic acid (10 μL) five times. Finally, the peptides were eluted from the tip with 10 μL of 0.1% formic acid in 60% acetonitrile. The elution process was repeated ten times using the same solvent mixture (10 μL). The pooled eluted sample solution was dried in a speed vacuum and resuspended in 1.5 μL of a solution of 1% TFA in 50% acetonitrile and 1.5 μL of the MALDI matrix solution. The mixture was vortexed for 30 seconds, centrifuged for 5 seconds at 2000 rpm, and 1 μL was spotted on a MALDI target plate. MS analysis was performed on MALDI-TOF/TOF instrument (ABI-4700). The instrument was equipped with ND:YAG (335 nm) and operated at a repetition rate of 200 Hz in both MS and MS/MS mode. The data were recorded with 20 KeV acceleration energy in the first TOF and the voltage m Einzel lens was set at 6 KeV. The MS/MS data were deconvoluted by MASCOT search engine (MATRIX SCIENCE) with no enzyme search parameters. Peptides were identified by searching a standard database such as NCBI or Swiss-Prot.

The peptides identified by MALDI-MS are presented in Table 4. Some of the same peptide fragments were identified in this analysis that were identified with LC-MS (ESI). For example, fragments of alpha-subunit of beta-conglycinin, beta-subunit of beta-conglycinin, glycinin subunit G1, and glycinin Gy4 were found in both analyses. The MALDI-MS analysis detected fragments of additional polypeptides, such as the alpha prime subunit of beta-conglycinin, glycinin subunit G2, and 62 K sucrose-binding protein precursor and seed maturation protein, LEA4.

TABLE 4
Peptide Fragments in 6.1% DH Hydrolysate - MALDI-MS

| | SEQ ID | |
|---|---|---|
| Protein | NO: | Sequence |
| Alpha-subunit of | 7 | SPQLQNLIR |
| beta-conglycinin | 25 | KTISSEDKPFNLR |
| | 40 | VLFSREEGQQQGEQR |
| Beta-subunit of | 60 | TISSEDEPFNLR |
| beta-conglycinin | 28 | KTISSEDEPFNLR |
| | 29 | VREDENNPFYLR |
| | 61 | FFEITPEKNPQLR |
| | 62 | SSNSFQTLFENQNGR |
| | 63 | QVQELAFPGSAQDVER |
| Alpha prime-subunit | 64 | QQQEEQPLEVR |
| of beta-conglycinin | 65 | TISSEDKPFNLR |
| Glycinin subunitG1 | 66 | FLVPPQESQK |
| (proglycinin A1aB1b) | 67 | FLVPPQESQKR |
| | 68 | VLIVPQNFVVAAR |
| | 16 | FYLAGNQEQEFLK |
| | 69 | RPSYTNGPQEIYIQQGK |
| | 70 | VFYLAGNPDIEYPETMQQQQQQK |
| Glycinin subunit G2 | 71 | EAFGVNMQIVR |
| A2B1a | 14 | SQSDNFEYVSFK |
| | 72 | NNNPFSFLVPPQESQR |
| | 73 | NLQGENEGEDGEDKGAIVTVK |
| | 74 | VFDGELQEGGVLIVPQNFAVAAK |
| | 75 | GKQQEEENEGSNILSGFAPEFLK |
| | 76 | PQNFAVAAK |
| Glycinin Gy4 | 77 | NGLHLPSYSPYPR |
| A5A4B3 | 78 | AIPSEVLAHSYNLR |
| | 70 | VFYLAGNPDIEYPETMQQQQQQK |
| | 79 | WQEQQDEDEDEDEDDEDEQIPSH |
| | | PPR |
| | 80 | KQGQHQQEEEEEGGSVLSGFSK |
| 62 K sucrose-binding | 81 | LFDQQNEGSIFAISR |
| protein precursor | 82 | LTEVGPDDDEKSWLQR |
| Seed maturation | 83 | TNRGPGGTATAHNTRA |
| Protein; LEA4 | 84 | HQTSAMPGHGTGQPTGH |

### Example 5

### Hydrolysis of Isolated Soy Proteins with TL1 or ALCALASE®

Isolated soy proteins were hydrolyzed with either TL1 or ALCALASE® 2.4L, a microbial subtilisin protease available from Novozymes (Bagsvaerd, Denmark), so that the sensory attributes and functionality of the different hydrolysates could be compared. A slurry of 8% isolated soy protein was prepared by blending 72 g of SUPRO® 500E in 828 g of tap water using moderate mixing for 5 min. Two drops of defoamer were added. The pH of the slurry was adjusted to 8.0 with 2 N KOH. Aliquots (800 g) of the slurry were heated to 50° C. with mixing. Varying amounts of TL1 peptidase or ALCALASE® (ALC) protease were added to achieve targeted degrees of hydrolysis of 0, 1, 2, 4, and 6%. An autotitrator was used to keep the pH of the reaction constant at pH 8.0. After incubating at 50° C. for a period of time to produce the desired degree of hydrolysis, the samples were heated to 85° C. for 5 min to inactivate the enzymes, and the solutions were adjusted to pH 7.0. The samples were chilled on ice and stored at 4° C. The degree of hydrolysis (% DH) was determined using the TNBS method (as described in Example 1). Table 5 presents the amounts of enzymes added, the reaction times, the volumes of KOH added to titrate the pH during the reaction, the mean TNBS values, and the % DH.

TABLE 5
TL1 and ALCALASE ® Hydrolysates

| | | | | TNBS Value | |
|---|---|---|---|---|---|
| | | | | (moles NH₂ | |
| | | Time | KOH | per 100 kg | |
| Sample # | Enzyme | (min) | (mL) | protein) | DH (%) |
| 0 | 0 | 30 | 0 | 23.7 | 0 |
| 46-1 | 0.0182% | 30 | 3.2 | 34.8 | 13 |
| | ALCALASE ® | | | | |
| 46-2 | 0.0394% | 30 | 5.6 | 45.8 | 2.5 |
| | ALCALASE ® | | | | |
| 46-5 | 0.1018% | 30 | 8.7 | 52.1 | 3.2 |
| | ALCALASE ® | | | | |
| 46-9 | 0.3462% | 30 | 19.2 | 75.9 | 5.9 |
| | ALCALASE ® | | | | |
| 46-4 | 30 mg/kg TL1 | 28 | 3.1 | 32.1 | 1.0 |
| 46-3 | 70 mg/kg TL1 | 22 | 5.9 | 40.4 | 1.9 |
| 46-8 | 250 mg/kg TL1 | 12 | 8.5 | 50.3 | 3.0 |
| 46-7 | 400 mg/kg TL1 | 40 | 19.2 | 69.1 | 5.1 |

### Example 6

### Sensory Analysis of TL1 and ALCALASE® Hydrolysates

A proprietary sensory screening method, the Solae Qualitative Screening (SQS) method, was used to assess the flavor characteristics of the TL1 and ALCALASE® hydrolysates prepared in Example 5. This method is based upon a direct comparison between a test sample and a control sample, and it provides both qualitative and directional quantitative differences. A panel of seven trained assessors was provided with aliquots of each sample (diluted to a 5% slurry) and a control sample that was a 5% slurry of unhydrolyzed isolated soy protein. The pH of each solution was adjusted to 7.0 with food grade phosphoric acid.

The evaluation protocol comprised swirling a cup three times, while keeping the bottom of the cup on the table. After the sample sat for 2 seconds, each assessor sipped about 10 mL (2 tsp), swished it about her/his mouth for 10 seconds, and then expectorated. The assessor then rated the differences between the test sample and the control sample according to the scale presented in Table 6.

TABLE 6
SQS Scoring System

| SQS | | |
|---|---|---|
| Score | Scale | Definition |
| 5 | Match | The test sample has virtually identical sensory |
| | | characteristics to the control sample by appearance, |
| | | aroma, flavor and texture. |
| 4 | Slight | The test sample has one or multiple ‘slight’ |
| | difference | differences from the control sample. These |
| | | differences might not be noticed if not in a |
| | | side-by-side comparison with the control. |
| 3 | Moderate | The test sample has one or multiple ‘moderate’ |
| | difference | differences from the control sample. These |
| | | differences would be noticeable in a side-by-side |
| | | comparison of the two samples after one tasting |
| | | of each. |
| 2 | Extreme | The test sample has one or multiple ‘extreme’ |
| | difference | differences from the control sample. These |
| | | differences would be noticed even if not in a |
| | | side-by-side comparison. |
| 1 | Reject | The test sample has obvious defects that make it |
| | | different from the control sample. |

Table 7 presents the mean SQS scores for each sample. The TL1 hydrolysates were generally rated as moderately different from the control sample (which was untreated isolated soy protein). The ALCALASE® (ALC) hydrolysates were rated as having from slight to extreme differences from the control.

TABLE 7
SQS Scores for TL1 and ALCALASE ® Hydrolysates

| % DH TL1 | SQS Score | % DH ALCALASE ® | SQS Score |
|---|---|---|---|
| 0 | 4.7 | 0 | 4.7 |
| 1.0 | 3.6 | 1.3 | 3.9 |
| 1.9 | 3.1 | 2.5 | 3.6 |
| 3.6 | 3.1 | 3.2 | 3.9 |
| 5.1 | 3.3 | 5.9 | 2.3 |

If a test sample was rated as different from the control sample (i.e., had an SQS score of 2, 3, or 4), then the test sample was further evaluated to provide diagnostic information on how the test sample differed from the control sample. Thus, if the test sample had slightly more, moderately more, or extremely more of an attribute (see Table 8) than the control sample, then scores of +1, +2, +3, respectively, were assigned. Likewise, if the test sample had slightly less, moderately less, or extremely less of the attribute than the control sample, then scores of −1, −2, −3, respectively, were assigned. This analysis provided an assessment of the directional quantitative differences between the test sample and the control sample.

TABLE 8
SQS Lexicon

| Attribute | Definition | References |
|---|---|---|
| Green | The general category of aromatics | Fresh cut grass, |
| | associated with green vegetation | green beans, |
| | including stems, grass, leaves | tomato vines |
| | and green herbs. | |
| Grain | The aromatics associated with the | All-purpose flour |
| | total grain impact, which may | paste, cream of |
| | include all types of grain and | wheat, whole |
| | different stages of heating. May | wheat pasta |
| | include wheat, whole wheat, oat, | |
| | rice, graham, etc. | |
| Soy/Legume | The aromatics associated with | Unsweetened |
| | legumes/soybeans; may include | SILK ™ soymilk, |
| | all types and different stages | canned |
| | of heating. | soybeans, tofu |
| Cardboard/ | The aromatics associated with | Toothpicks, water |
| Woody | dried wood and the aromatics | from cardboard |
| | associated with slightly oxidized | soaked for 1 hour |
| | fats and oils, reminiscent of a | |
| | cardboard box. | |
| Sweet | The taste on the tongue stimulated | Sucrose |
| | by sucrose and other sugars, such | solutions: 2%, |
| | as fructose, glucose, etc., and by | 5%, 10% |
| | other sweet substances, such as | |
| | saccharin, Aspartame, and | |
| | Acesulfame-K. | |
| Sour | The taste on the tongue stimulated | Citric acid |
| | by acid, such as citric, malic, | solutions: 0.05%, |
| | phosphoric, etc. | 0.08%, 0.15% |
| Salt | The taste on the tongue associated | Sodium chloride |
| | with sodium salts. | solutions: 0.2%, |
| | | 0.35%, 0.5% |
| Bitter | The taste on the tongue associated | Caffeine |
| | with caffeine and other bitter | solutions: 0.05%, |
| | substances, such as quinine and | 0.08%, 0.15% |
| | hop bitters. | |
| Astringent | The shrinking or puckering of the | Alum solutions: |
| | tongue surface caused by substances | 0.005%, 0.007%, |
| | such as tannins or alum. | 0.01% |

The directional differences of nine flavor attributes are presented in FIGS. 2A and 2B for hydrolysates with similar DH levels. At all DH levels, the TL1 hydrolysates had larger decreases in grain and soy/legume attributes and smaller increases in astringency and bitterness than did the ALC hydrolysates. The highest % DH ALC hydrolysates had particularly large increases in bitterness relative to the control.

### Example 7

### Solubility of TL1 and ALCALASE® Hydrolysates

The solubility of each of the TL1 and ALCALASE® hydrolysates prepared in Example 5 was estimated by diluting the hydrolysates to 2.5% solids and storing them at 4° C. at pH 7.0 for one week. The samples were evaluated visually; a photographic image is presented in FIG. 3A. All of the TL1 hydrolysates had little sediment, but the 5.1% DH TL1 hydrolysate also had increased transparency relative to those with lower % DH. In contrast, the ALC hydrolysate with the highest % DH had a significant amount of sediment. FIG. 3B presents images of tubes of a 6.1% DH TL1 hydrolysate and a 13.8% DH ALC hydrolysate diluted to 2.5% solids that were stored at pH 8.2 at 4° C. for three weeks. The TL1 hydrolysate had no sediment, indicating that it was stable for an extended period of time at pH 8.2 at 4° C., whereas the ALC hydrolysate had sediment.

The effect of pH on solubility was tested in each of the TL1 and ALC hydrolysates prepared in Example 5. Aliquots of each were adjusted to pH 2, pH 3, pH 4, pH 5, pH 6, pH 7, pH 8, or pH 9, and the samples were centrifuged at 500×g for 10 min. The amount of solid matter in the solution before centrifuging was compared to the amount of solid matter in solution after centrifuging to give the soluble solids index (SSI). The % soluble solids of the TL1 and ALC hydrolysates are presented as a function of pH in FIGS. 4A and 4B, respectively. All of the solutions had reduced solubility at pH levels of about pH 4 to pH 5 (i.e., the isoelectric point of soy protein), and somewhat increased solubility at lower pH values. At higher pH values, however, all of the TL1 hydrolysates had excellent solubility at levels above pH 6.0 (FIG. 4A), but some of the ALC hydrolysates had reduced solubility at the higher pH levels (FIG. 4B). FIG. 4C presents a direct comparison of the solubility of TL1 and ALC hydrolysates at low and high % DH as a function of pH.

### Example 8

### Optical Transmittance of TL1 Hydrolysates

The transmittance of some of the TL1 hydrolysates prepared in Example 5 was measured. For this, the 1% DH and 5.1% DH TL1 hydrolysates were prepared with different percentages of solids (i.e., 0.5%, 1.0%, 1.5%. 2.0%, and 2.5%). An aliquot of each protein slurry was placed in a TURBISCAN® Lab Expert unit (Formulaction, l'Union, France) and the transmittance was recorded every second for a total of 60 seconds. Table 9 presents the average percent transmittance for each sample. The 5.1% DH TL1 hydrolysate had 37.4% transmittance at 0.5% solids as compared to 1.3% transmittance for the 1.0% DH hydrolysate at 0.5% solids. These data confirm what was observed visually (see FIG. 3A).

TABLE 9
Transmittance of TL1 Hydrolysates

| | % Transmittance | | | | |
|---|---|---|---|---|---|
| DH | 2.5% | 2.0% | 1.5% | 1.0% | 0.5% |
| (%) | solids | solids | solids | solids | solids |
| 1.0 | 0.0 | 0.0 | 6.1 | 0.2 | 1.3 |
| 5.1 | 2.1 | 4.2 | 8.0 | 16.6 | 37.4 |

### Example 9

### Bitterness Analysis of Soy Hydrolysates Prepared with TL1 or Other Endopeptidases

Isolated soy proteins were hydrolyzed with TL1, ALCALASE® (ALC), or lysyl endopeptidase from Achromobacter lyticus (SP3; SEQ ID NO:4) essentially as described in Examples 1 and 5. The enzyme concentrations and reactions conditions were selected to give % DH values of about 5-6%, as determined by the TNBS method as described in Example 1. The hydrolysates were presented to a panel of five assessors for evaluation, focusing on bitterness, using the SQS method described in Example 6.

The mean SQS scores and diagnostic bitterness scores are presented in Table 10. The TL1 and SP3 hydrolysates were rated as having slight differences from the control sample (non-hydrolyzed isolated soy protein). Likewise the TL1 and SP3 hydrolysates were rated just slightly less bitter than the control sample. In contrast, the ALC hydrolysate was rated as extremely different and extremely more bitter than the control sample.

TABLE 10
SQS Analysis of Hydrolysates.

| | SQS score | Bitterness score |
|---|---|---|
| Sample | (mean) | (mean) |
| No enzyme | 4.5 | −0.2 |
| TL1 | 3.8 | −0.7 |
| SP3 | 4.3 | −0.2 |
| ALC | 2.2 | +2.8 |

### Example 10

### Physical Properties of Pilot Plant TL1 Hydrolysates

The production of TL1 hydrolysates of soy was scaled up from bench scale to a larger pilot plant scale, and the sensory and functional characteristics of the hydrolysates were analyzed. For this, the starting material was soy protein curd. To produce the soy protein curd material, soy flakes, soy flour, or soy grit was serially extracted with aqueous solutions from about pH 6.5 to about pH 10 to separate the protein in the flakes/flour/grit from insoluble materials such as fiber. A low level of sulfite was added to the extraction media at 0.05-0.15% based on the flake weight. The flakes, flour, or grit was extracted with an aqueous sodium hydroxide solution of about pH 6.5-7.0 for the first extraction and then extracted with a solution of about pH 8.5-10 for the second extraction. The weight ratio of the water to the soy flake/flour/grit material was from about 8:1 to about 16:1.

After extraction, the extract was separated from the insoluble materials by filtration or by centrifugation. The pH of the separated extract was then adjusted with a suitable acid to about the isoelectric point of soy protein (about pH 4-5, or preferably pH 4.4-4.6) to precipitate a soy protein curd so that the soy protein could be separated from soy solubles, including flatulence inducing oligosaccharides and other water soluble carbohydrates. Suitable edible acids include hydrochloric acid, sulfuric acid, nitric acid, or acetic acid. The precipitated protein material (curd) was separated from the extract (whey) by centrifugation to produce the soy protein curd material. The separated soy protein curd material was washed with water to remove residual solubles, at a weight ratio of water to protein material of about 5:1 to about 12:1.

The soy protein curd material was first neutralized to about pH 8.0 to about pH 9.0, preferably about pH 8.0-8.5, with an aqueous alkaline solution or an aqueous alkaline earth solution, such as a sodium hydroxide solution or a potassium hydroxide solution. The neutralized soy protein curd was heated and cooled, preferably by jet cooking and flash cooling. The soy protein material was then treated with TL1 enzyme at a temperature and for a time effective to hydrolyze the soy protein material so that the soy protein hydrolysate had a TNBS value of about 35-55. The enzyme was added to the soy protein material at a concentration of from 0.005% to 0.02% enzyme protein based on the protein curd weight basis. The enzyme was contacted with the soy protein curd material at a temperature of from 40° C. to 60° C., preferably at about 50° C. for a period of from 30 minutes to 120 minutes, preferably from 50 minutes to 70 minutes, to hydrolyze the protein. The hydrolysis was terminated by heating the hydrolyzed soy protein material to a temperature effective to inactivate the enzyme. Most preferably the hydrolyzed soy protein curd material was jet cooked to inactivate the enzyme, and flash cooled then spray-dried as described above.

Table 11 presents the reaction parameters for a typical set of hydrolysates. The degree of hydrolysis was determined using the TNBS method, essentially as described in Example 1. The TNBS value and % DH of each sample are also presented in Table 11. Control samples included non-hydrolyzed isolated soy protein (i.e., SUPRO® 500E) and essentially a commercially available soy protein hydrolysate (i.e., SUPRO® XT 219 hydrolyzed with a mixture of enzymes to 2.8% DH).

TABLE 11
Pilot Plant TL1 Hydrolysates.

| | | | Dose | TNBS Value | |
|---|---|---|---|---|---|
| | | | (mg enzyme | (moles NH₂ | |
| | pH, | Time | protein/kg | per 100 kg | |
| Sample # | Temperature | (min) | solids) | protein) | % DH |
| 5-2 | Control (non-hydrolyzed protein) | | | 24.3 | 0 |
| 5-3 | Control (hydrolyzed protein) | | | 49.3 | 2.8 |
| 5-7 | 8.0, 50° C. | 30 | 10 | 26.7 | 0.3 |
| 5-8 | 8.0, 50° C. | 30 | 25 | 32.1 | 0.9 |
| 5-4 | 9.5, 50° C. | 30 | 50 | 35.8 | 1.3 |
| 5-9 | 8.0, 50° C. | 30 | 50 | 38.1 | 1.6 |
| 5-5 | 8.0, 50° C. | 120 | 50 | 42.1 | 2.0 |
| 5-1 | 8.0, 50° C. | 120 | 50 | 48.0 | 2.7 |
| 5-6 | 8.0, 50° C. | 120 | 100 | 58.2 | 3.8 |
| 5-10 | 8.0, 50° C. | 120 | 200 | 69.9 | 5.2 |

The TL1 hydrolysates and control samples were analyzed by SDS PAGE using standard procedures, and FIG. 5 presents an image of the gel. This analysis revealed that all of the major soybean storage protein subunits were cleaved by TU.

### Example 11

### Solubility and Viscosity of Pilot Plant TL1 Hydrolysates

The solubility of the pilot plant TL1 hydrolysates and control samples prepared in Example 10 was also examined. Aliquots of each sample were adjusted to pH 2, pH 3, pH 4, pH 5, pH 6, pH 7, pH 8, and pH 9 and the soluble solids index (SSI) was determined, essentially as described in Example 7. As shown in FIG. 6, all of the TL1 hydrolysates samples were nearly 100% soluble at pH levels of pH 6 and above, while the hydrolyzed control sample was only approximately 40% soluble at pH 6. Furthermore, as the degree of hydrolysis increased, the solubility at the isoelectric point (i.e., around pH 4-5) increased.

The viscosity of several of the TL1 hydrolysates and a control sample was determined at various percentages of solids (i.e., 12-20% solids). The samples were dispersed using a small Waring blender with a total slurry content of 70 grams. The samples were blended for a total of four minutes using minimal shear to decrease foam. The samples were then analyzed using a Brookfield viscometer with the small sample adapter and spindle 18 at room temperature. Each sample was prepared and analyzed in duplicate. FIG. 7 plots the viscosity measurements in centipoises (cps) for the different preparations. The commodity isolate was greater than 10,000 cps—which was too viscous for the Brookfield at 12% solids. This analysis revealed that as the degree of hydrolysis increased, the viscosity decreased, and that as the percent of solids increased, the viscosity increased. FIG. 8 summarizes the viscosity and solubility data. Solubility is expressed as soluble solids index (SSI) and nitrogen soluble index (NSI, which is the percent of water soluble nitrogen as a function of the total nitrogen). As shown in FIG. 8, viscosity decreased and solubility increased, as the degree of hydrolysis increased.

The amount of flavor volatiles present in several of the TL1 hydrolysates was compared to those present in the non-hydrolyzed isolated soy protein. The flavor volatiles were determined using standard GC techniques. The levels of hexanal, heptanal, pentanal, 3-octen-2-one, and 1-octen-3-ol were reduced in the TL1 hydrolysates as compared to non-hydrolyzed soy protein (FIGS. 9A and 9B).

### Example 12

### Sensory Analysis of Pilot Plant TL1 Hydrolysates

The flavor profiles of the pilot plant TL1 hydrolysates prepared in Example 10 were analyzed using the SQS method essentially as described in Example 6. Panels of 11 or 12 trained assessors rated the hydrolysates, as compared to a control sample (i.e., non-hydrolyzed isolated soy protein). Table 12 presents the mean SOS scores and FIGS. 10A-D present plots of the diagnostic scores. In general, the TL1 hydrolysates had slightly less grain and soy/legume attributes and reduced viscosity relative to the control sample, but increased bitter attribute, especially at higher degrees of hydrolysis (% DH). The hydrolyzed control sample (i.e., sample 5-3) had slightly reduced grain attribute, but moderately increased bitter and astringent attributes. Thus, the TL1 hydrolysates were generally rated as less bitter than the hydrolyzed control sample.

TABLE 12
SQS Scores of Pilot Plant TL1 Hydrolysates.

| Sample # | Sample | SQS Score |
|---|---|---|
| 5-2 | Blind control (Non-hydrolyzed control) | 4.8 |
| 5-3 | Hydrolyzed control | 3.2 |
| 5-7 | TL1, 0.3% DH | 4.1 |
| 5-8 | TL1, 0.9% DH | 3.6 |
| 5-4 | TL1, 1.3% DH | 3.9 |
| 5-9 | TL1, 1.6% DH | 3.7 |
| 5-5 | TL1, 2.0% DH | 3.6 |
| 5-1 | TL1, 2.7% DH | 3.2 |
| 5-6 | TL1, 3.8% DH | 2.7 |
| 5-10 | TL1, 5.2% DH | 2.7 |

FIG. 11 presents a summary of the sensory analyses of the TL1 hydrolysates in which key sensory attributes are plotted as a function of the degree of hydrolysis. The overall sensory scores of the hydrolysate decreased as the degree of hydrolysis increased, whereas the bitter scores increased as the degree of hydrolysis increased. It appears that hydrolysates having less than about 2% DH had the best flavor with the least bitter taste.

### Example 13

### Analysis of Peptide Fragments in TL1 Hydrolysates of Soy

Peptides in TL1 hydrolysates having different degrees of hydrolysis were identified by LC-MS analyses using Q-STAR® XL MS (Applied Biosystems Inc. (ABI), Foster City, Calif.) and LCQ-Deca MS (ThermoFinnigan, Hertfordshire, Great Britain).

Approximately (0.5-2.0 mg) of each sample was dissolved in 0.5 mL of 50 mM ammonium bicarbonate. Five μL was injected onto a 75 um i.d. column for LC-MS/MS analysis using data-dependent acquisition (LC flow rate was 180 nL/min). Nano-LC was performed with an LC Packings Ultimate nano-LC using a 018 PepMap100 column (Dionex)/Eksigent 2D nano-LC using a 018 PepMap100 column (Dionex). The elution profile is presented in Table 13. Solvent A was 5% acetonitrile, 0.1% formic acid in MilliQ water, and Solvent B was 95% acetonitrile, 0.075% formic acid in MilliQ water).

TABLE 13
LC-Pump Gradient.

| Time (min) | % B |
|---|---|
| 0 | 5 |
| 3 | 5 |
| 8 | 25 |
| 40 | 60 |
| 45 | 95 |

Sample analysis proceeded with an ABI QSTAR® XL hybrid QTOF MS/MS mass spectrometer equipped with a nanoelectrospray source (Protana XYZ manipulator). Positive mode nanoelectrospray was generated from borosilicate nanoelectrospray needles at 2.5 kV. The m/z response of the instrument was calibrated daily with standards from the manufacturer. TOF mass spectra and product ion spectra were acquired using the information dependent data acquisition (IDA) feature in the Analyst QS software with the following parameters: Mass ranges for TOF MS and MS/MS were m/z 300-2000 and 70-2000, respectively. Every second, a TOF MS precursor ion spectrum was accumulated, followed by three product ion spectra, each for 3 sec. The switching from TOF MS to MS/MS was triggered by the mass range of peptides (m/z 300-2000), precursor charge state (2-4) and ion intensity (>50 counts). The DP, DP2, and FP settings were 60, 10, and 230, respectively, and rolling collision energy was used.

The peptide electrospray tandem mass spectra were processed using Analyst QS software (Applied Biosystems). Peptides were identified by searching a standard database such as NCBI or Swiss-Prot using MASCOT version 1.9 with the following constraints: no enzyme with up to one missed cleavage site; 0.8/2.0 and 0.8 Da mass tolerances for MS and MS/MS fragment ions, respectively. The charge states of precursor ions selected were 1-3.

For the LC-MS analysis using LCQ-Deca MS, samples were prepared by 1) mixing an aliquot containing 2 mg of each TL1 hydrolysate with 0.1% formic acid (1 mL) in a glass vial, vortexing for 1-2 min, and centrifuging the mixture at 13,000 rpm in a microcentrifuge for 5 min; or 2) mixing an aliquot containing 3 mg of each TL1 hydrolysate and 0.1% formic acid (300 uL) in a microcentrifuge tube and vortexing the mixture for 1-2 minutes. The entire mixture was then transferred to a pre cleaned 018 tip (Glygen Corp., Columbia, Md.) for peptide isolation. The 018 tip was cleaned by eluting with 0.1% formic acid in 60% acetonitrile (300 μL) and equilibrated with 0.1% formic acid (600 μL). Materials eluted with 0.1% formic acid fraction were discarded, and the peptides were eluted with 0.1% formic acid in 60% acetonitrile (600 μL). Total volume of peptide solution was reduced to 200 μL by evaporating the solvent mixture in on Genevac evaporator at 300° C. for 10 minutes. LC-MS analysis was performed essentially as described in Example 3.

Table 14 presents all of the peptides identified in the TL1 hydrolysates of soy protein.

TABLE 14
Peptdes in TL1 Hydrolysates of Soy.

| SEQ ID | | |
|---|---|---|
| NO: | Sequence | |
| 85 | GYLADK | 666.31 |
| 86 | FQTLFE | 783.42 |
| 24 | FETLFK | 784.39 |
| 87 | PPQESQK | 813.35 |
| 18 | PPKESQR | 841.47 |
| 51 | ADFYNPK | 854.35 |
| 88 | PQESQKR | 872.51 |
| 52 | MIIIAQGK | 873.44 |
| 89 | NQYGRIR | 906.85 |
| 7 | SPQLQNLR | 955.57 |
| 30 | PPQESQKR | 969.69 |
| 13 | LSAEFGSLR | 978.54 |
| 19 | LSAQFGSLR | 978.86 |
| 90 | PEKNPQLR | 981.95 |
| 59 | DAMDGWFR | 997.42 |
| 48 | PQNFVVAAR | 1001.67 |
| 91 | EVGQDIQSK | 1003.75 |
| 39 | FFEITPEK | 1010.52 |
| 92 | DYGSYAQGR | 1016.83 |
| 93 | PPRYEAGVK | 1017.19 |
| 31 | LNALKPDNR | 1040.48 |
| 94 | APSIYHSER | 1060.05 |
| 95 | FGVNMQIVR | 1063.52 |
| 8 | SRDPIYSNK | 1079.91 |
| 27 | LAGEKDNVVR | 1100.68 |
| 55 | YEAGVVPPGAR | 1115.81 |
| 96 | SSDFLTYGLK | 1130.55 |
| 97 | AFGVNMQIVR | 1134.48 |
| 32 | VFDGELQEGR | 1149.55 |
| 98 | NILEASYDTK | 1153.48 |
| 99 | NPIYSNNFGK | 1153.57 |
| 100 | GIGTIISSPYR | 1163.64 |
| 101 | ESYFVDAQPK | 1183.57 |
| 102 | HLSVVHPIYK | 1192.74 |
| 103 | LHENIARPSR | 1193.19 |
| 10 | SSEDEPFNLR | 1193.40 |
| 104 | NKPLVVQFQK | 1200.52 |
| 105 | AKDYGSYAQGR | 1215.94 |
| 57 | TKEVGQDIQSK | 1233.46 |
| 71 | EAFGVNMQIVR | 1263.63 |
| 106 | THHNAVTSYLK | 1270.46 |
| 107 | LAGNQEQEFLQ | 1276.11 |
| 49 | LAGNQEQEFLK | 1276.11 |
| 108 | NKNPFLFGSNR | 1293.66 |
| 67 | FLVPPQESQKR | 1328.82 |
| 34 | NFLAGEKDVVR | 1361.77 |
| 109 | SRDPIYSNKLGK | 1378.25 |
| 36 | EQQEEQPLEVR | 1383.89 |
| 22 | PSEVLAHSYNLR | 1386.32 |
| 110 | SRNPIYSNNFGK | 1396.65 |
| 34 | ISTLNSLTLPALR | 1398.86 |
| 65 | TISSEDKPFNLR | 1406.73 |
| 68 | VLIVPQNFVVAAR | 1425.88 |
| 111 | YLAGNQEQEFLK | 1439.72 |
| 14 | SQSDNFEYSFK | 1450.57 |
| 56 | HHLAEAAEYVGQK | 1453.52 |
| 15 | PEEVIQHTFNLK | 1454.98 |
| 112 | PEFLEHAFVVDR | 1459.51 |
| 113 | PPHSVQVHTTTHR | 1496.89 |
| 77 | NGLHLPSYSPYPR | 1500.78 |
| 114 | QIVTVEGGLSVISPK | 1526.94 |
| 25 | KTISSEDKPFNLR | 1534.93 |
| 29 | VREDENNPFYLR | 1551.92 |
| 115 | LPEEVIQHTFNLK | 1568.22 |
| 78 | AIPSEVLAHSYNLR | 1569.72 |
| 116 | FSREEGQQQGEQR | 1579.15 |
| 117 | NQRESYFVDAQPK | 1582.77 |
| 118 | LFEITPEKNPQLR | 1584.81 |
| 16 | FYLAGNQEQEFLK | 1586.53 |
| 20 | FYLAGNQEQEFLQ | 1587.53 |
| 61 | FFEITPEKNPQLR | 1618.87 |
| 35 | KQIVTVEGGLSVISPK | 1655.01 |
| 119 | QESVIVEISKEQIR | 1658.84 |
| 120 | HLAEAAEYVGQKTK | 1681.97 |
| 121 | AGRISTLNSLTLPALR | 1683.00 |
| 122 | FMPEKGSAEYEELR | 1685.88 |
| 123 | PFSFLVPPQESQRR | 1687.82 |
| 124 | LEASYDTKFEEINK | 1687.91 |
| 125 | LARPVLGGSSTFPYPR | 1717.87 |
| 62 | SSNSFQTLFENQNGR | 1728.71 |
| 17 | RFYLAGNQEQEFLK | 1742.88 |
| 126 | NELDKGIGTIISSPYR | 1762.75 |
| 37 | LQESVIVEISKEQIR | 1770.71 |
| 127 | THHNAVSSYIKDVFR | 1774.05 |
| 63 | QVQELAFPGSAQDVER | 1774.90 |
| 128 | THHNAVTSYLKDVFR | 1788.52 |
| 41 | LKVREDENNPFYLR | 1792.91 |
| 129 | NPFLFGSNRFETLFK | 1817.93 |
| 130 | HFLAQSFNTNEDIAEK | 1863.86 |
| 131 | NNNPFSFLVPPKESQR | 1873.99 |
| 132 | LFLLDHHDPIMPYLR | 1880.00 |
| 133 | SLSQIVQPAFESAFDLK | 1880.06 |
| 134 | DWVFTDQALPADLIKR | 1888.05 |
| 135 | NLQGENEGEDKGAIVTVK | 1900.99 |
| 136 | NILEASYDTKFEEINK | 1913.97 |
| 137 | NLQGENEEEDSGAIVTVK | 1931.88 |
| 138 | KESFFFPFELPREER | 1957.03 |
| 69 | RPSYTNGPQEIYIQQGK | 1980.03 |
| 139 | SSNSFQTLFENQNGRIR | 1997.89 |
| 140 | NNNPFSFLVPPQESQRR | 2029.84 |
| 141 | AIPSEVLSNSYNLGQSQVR | 2061.96 |
| 142 | HFLAQSFNTNEDTAEKLR | 2121.87 |
| 143 | QVQELAFPGSAQDVERLLK | 2129.03 |
| 144 | VPSGTTYYVVNPDNNENLR | 2152.00 |
| 145 | IPAGTTYYLVNPHDHQNLK | 2181.01 |
| 146 | QEEENEGSNILSGFAPEFLK | 2239.48 |
| 147 | KQGQHQQQEEEGGSVLSGFSK | 2288.13 |
| 148 | NLQGENEEEDSGAIVTVKGGLR | 2314.87 |
| 149 | SVSQNVLPLLQSAFDLNFTPR | 2346.32 |
| 150 | QVKNNNPFSFLVPPQESQRR | 2384.93 |
| 74 | VFDGELQEGGVLIVPQNFAVAAK | 2402.06 |
| 80 | KQGQHQQEEEEEGGSVLSGFSK | 2418.85 |
| 151 | QVKNNNPFSFLVPPQESQRRA | 2457.12 |
| 152 | NAMFVPHYTLNANSIIYALNGR | 2480.21 |
| 153 | TPVVAVSIIDTNSLENQLDQMPR | 2541.23 |
| 75 | GKQQEEENEGSNILSGFAPEFLK | 2552.16 |
| 154 | VFDGELQEGRVLIVPQNFVVAAR | 2557.16 |
| 155 | EPVVAISLLDTSNFNNQLDQTPR | 2572.90 |
| 156 | KNAMFVPHYTLNANSIIYALNGR | 2608.37 |
| 157 | DLDIFLSIVDMNEGALLLPHFNSK | 2701.56 |
| 158 | VFYLAGNPDIEHPETMQQQQQQK | 2730.40 |
| 159 | HFLAQSFNTNEDIAEKLQSPDDER | 2804.41 |
| 160 | VVFCPQQAEDDKCGDIGISIDHDDGTR | 2946.31 |
| 161 | SQQARQVKNNNPFSFLVPPQESQRR | 2956.36 |
| 162 | VLFGEEEEQRQQEGVIVELSKEQIR | 2973.47 |
| 163 | NLQGENEEEDSGAIVTVKGGLRVTAPAMR | 3041.33 |
| 79 | WQEQQDEDEDEDEDDEDEQIPSHPPR | 3211.13 |
| 164 | VFYLAGNPDIEYPETMQQQQQQKSHGGR | 3249.31 |
| 165 | DFVLDNEGNPLENGGTYYILSDITAFGGIR | 3261.53 |
| 166 | HQQEEENEGGSILSGFTLEFLEHAFSVDK | 3278.49 |
| 167 | RQQEEENEGGSILSGFAPEFLEHAPVVDR | 3291.54 |
| 168 | TNDTPMIGTLAGANSLLNALPEEVIQHTFNLK | 3423.41 |
| 169 | HNIGQTSSPDIYNPQAGSVTTATSLDFPALSWLR | 3646.60 |
| 170 | HQQEEENEGGSILSGFTLEFLEHAFSVDKQIAK | 3717.92 |
| 171 | NFLAGSQDNVISQIPSQVQELAFPGSAQAVEKLLK | 3728.18 |
| 172 | MITLAIPVNKPGRFESFFLSSTQAQQSYLQGFSK | 3822.18 |
| 173 | FREGDLIAVPTGVAWWMYNNEDTPVVAVSIIDTNS | 5105.43 |
| | LENQLDQMPR | |
| 270 | LSAEFGSLRK | 1107.69 |
| 271 | IGENKDAMDGWFR | 1538.75 |
| 40 | VLFSREEGQQQGEQR | 1791.01 |
| 177 | NAMFVPHYNLNANSIIYALNGR | 2493.17 |
| 272 | KNAMFVPHYNLNANSIIYALNGR | 2621.46 |
| 273 | TNDRPSIGNLAGANSLLNALPEEVIQHTFNLK | 3446.52 |
| 274 | TNDRPSIGNLAGANSLLNALPEEVIQQTFNLR | 3466.74 |

### Example 14

### Hydrolysis of Soy Protein with Other Endopeptidases

Isolated soy protein was treated with different endopeptidases (e.g., SP3, trypsin-like protease from Fusarium solani (TL5; SEQ ID NO:2), trypsin-like protease from Fusarium cf. solani (TL6; SEQ ID NO:3), porcine trypsin, or bovine trypsin) to determine whether trypsin or a trypsin-like protease from another source could be used to hydrolyze soy protein.

An 8% slurry of isolated soy protein (i.e., SUPRO® 500E) was prepared, adjusted to pH 8, and mixed with one of the endopeptidases for a final concentration of 100 mg protease/kg soy protein. A non-protease containing control samples was included. The slurries were incubated in a water bath at 50° C. for 2 hours with mixing, and then the proteases were heat-inactivated (80° C. for 30 min). Deionized water was added to each sample for a final concentration of 5% soy protein.

To estimate the degree of hydrolysis, an aliquot of each sample was resolved by SDS-PAGE on a 4-20% Tris-Glycine gel (Novex Inc., Wadsworth, Ohio). As shown in FIG. 12, TL1, SP3, TL5, and TL6 hydrolyzed the soy protein into smaller polypeptide fragments, whereas there was little or no hydrolysis of the soy protein after treatment with either porcine trypsin or and bovine trypsin (see lanes 7 and 8). The inability of porcine and bovine trypsins to cleave soy proteins was observed at both 37° and 50° C. (at pH 8).

### Example 15

### Inhibition of Trypsin-Like Proteases with Bowman-Birk Inhibitor

It is possible that the porcine and bovine trypsins were unable to hydrolyze the soy protein material because soy contains active protease inhibitors that survived heat treatment during the production of the soy material. To test this hypothesis, the proteases were incubated with various concentrations of a commercial preparation of the Bowman-Birk inhibitor and residual enzyme activity was measured.

The proteases were diluted to 0.001 mg/ml with assay buffer (0.1 M Tris, 0.02% Brij 35, pH 8.0) and mixed with various concentration of Bowman-Birk inhibitor (Cat # T-9777, Sigma-Aldrich) in wells of a microtiter plate. The plate was incubated 1 hour at room temperature with agitation. Residual activity was measured by adding 0.6 mg/ml of substrate, Boc-Val-Leu-Gly-Arg-p-nitroanilide (L-1205: Bachem Biosciences, Prussia, Pa.). Absorbance was measured at 405 nm every 10 seconds for 3 min at room temperature. Activity was calculated from the initial slope of the measured absorbance at 405 nm. Residual activity was calculated as the activity in a well with the inhibitor relative to the activity in a well without the inhibitor.

As shown in Table 15, porcine and bovine trypsins were inhibited by lower concentrations of Bowman-Birk inhibitor than the microbial proteases. Thus, it appears that soy materials contain compounds that inhibit the activity of animal-derived trypsins.

TABLE 15
Inhibition of Animal-Derived Proteases

| | |
|---|---|
| Bowman-Birk | Protease (% residual activity) |

| inhibitor | | | | Porcine | Bovine |
|---|---|---|---|---|---|
| (mg/ml) | TL1 | TL5 | TL6 | trypsin | trypsin |
| 0.5 | 0.8 | 0.5 | 1.3 | 0.1 | 0.0 |
| 0.25 | 2.2 | 1.2 | 2.9 | 0.1 | 0.0 |
| 0.125 | 5.8 | 3.1 | 9.5 | 0.2 | 0.0 |
| 0.0625 | 13 | 7.2 | 26 | 6.4 | 0.0 |
| 0.0313 | 32 | 19 | 55 | 1.0 | 0.1 |
| 0.0156 | 61 | 29 | 66 | 2.2 | −1.5 |
| 0.0078 | 82 | 43 | 84 | 3.2 | 0.0 |
| 0.0039 | 109 | 55 | 97 | 6.2 | −0.4 |
| 0.00195 | 103 | 57 | 94 | 8.3 | 0.1 |
| 0.00097 | 111 | 71 | 107 | 9.4 | 5.3 |
| 0.00048 | 117 | 78 | 104 | 11 | 6.9 |
| 0 | 100 | 100 | 100 | 100 | 100.0 |

### Example 16

### Trypsin Ratio and Identification of Trypsin-Like Proteases

An assay was developed for identifying enzymes having trypsin-like activity. For this, trypsin-like activity was measured using chromogenic substrates with the general formula Suc-Ala-Ala-Pro-Xxx-pNA (Bachem Biosciences), where Xxx is the three letter abbreviation for one of the twenty natural amino acid residues and pNA is para-nitroanilide. If the endopeptidase cleaved the peptide bond on the carboxyl terminal side of Xxx, then para-nitroaniline was released and a yellow color was generated and measured essentially as described in Example 15. Ten pNA substrates were used, wherein Xxx was Ala, Arg, Asp, Glu, Ile, Leu, Lys, Met, Phe or Val.

The following endopeptidases were tested: ALCALASE®, SP3, TL1, and porcine trypsin. All enzymes were purified by chromatography to a high purity, i.e., only one band was seen for each peptidase on Coomassie stained SDS-polyacrylamide gels. The activity of each enzyme was measured at a pH value where the activity was at least half of that of the pH optimum with the Suc-Ala-Ala-Pro-Xxx-pNA substrates. The pH optimum of ALC was pH 9, and the pH optimum of the other three peptidases was pH 10 with respect to these substrates. The assay buffer was 100 mM succinic acid, 100 mM HEPES, 100 mM CHES, 100 mM CABS, 1 mM CaCl₂, 150 mM KCl, and 0.01% Triton X-100, pH 9.0. Twenty μL of each peptidase dilution (diluted in 0.01% Triton X-100) was placed in ten wells of a microtiter plate. The assay was started by adding 200 μL of one of the ten pNA substrates to each well (50 mg dissolved in 1.0 ml DMSO and further diluted 90× with the assay buffer). The initial increase in OD₄₀₅ was monitored as a measure of the peptidase activity. If a linear plot was not achieved in the 4 minutes measuring time, the peptidase was diluted further and the assay was repeated.

The Trypsin ratio was calculated as the maximal activity with either substrate containing Arg or Lys, divided by the maximal activity with any of the eight other substrates. A trypsin-like endopeptidase was defined as an endopeptidase having a Trypsin ratio of more than 100.

The activity levels are presented in Table 16 as activities relative to the activity for the Suc-Ala-Ala-Pro-Xxx-pNA substrate with the highest activity, as well as the Trypsin ratios. Although the assay was performed at pH 9 and three of the tested peptidases have pH optimums greater than pH 9, the activity of these three peptidases at pH 9 was more than half of the activity at the pH optimum. Thus, this analysis revealed the Achromobacter lyticus protease (SP3), the Fusarium trypsin-like protease (TL1) and porcine trypsin are trypsin-like endopeptidases, whereas ALCALASE® (ALC) is not a trypsin-like endopeptidase.

TABLE 16
Activities and Trypsin Ratios of Various Peptidases.

| Substrate | | | | |
|---|---|---|---|---|
| (Xxx) | ALC | SP3 | TL1 | Porcine Trypsin |
| Ala | 0.02497 | 0.00001 | 0.00000 | 0.00001 |
| Arg | 0.01182 | 0.00001 | 1.00000 | 1.00000 |
| Asp | 0.00053 | 0.00000 | 0.00000 | 0.00000 |
| Ile | 0.00026 | 0.00000 | 0.00000 | 0.00000 |
| Met | 0.37582 | 0.00023 | 0.00002 | 0.00031 |
| Val | 0.00033 | 0.00000 | 0.00000 | 0.00000 |
| Leu | 0.86502 | 0.00001 | 0.00000 | 0.00002 |
| Glu | 0.00289 | 0.00000 | 0.00000 | 0.00000 |
| Lys | 0.01900 | 1.00000 | 0.53071 | 0.51396 |
| Phe | 1.00000 | 0.00001 | 0.00003 | 0.00057 |
| Max of Arg or | 0.01900 | 1.00000 | 1.00000 | 1.00000 |
| Lys | | | | |
| Max of non- | 1.00000 | 0.00023 | 0.00003 | 0.00057 |
| Arg/Lys | | | | |
| Trypsin ratio | 0.019 | 4300 | 33000 | 1750 |

### Example 17

### TL1 Hydrolysates Derived From a Combination of Soy and Dairy Proteins

A combination of isolated soy protein and isolated dairy protein was hydrolyzed with TL1 to different degrees of hydrolysis, so that the functional properties and sensory attributes of the combination could be assessed.

A 5% slurry of soy and dairy proteins was made by dispersing a 50/50 mix of isolated soy protein (SUPRO® 500E) and sodium caseinate (Alanate 180, NZMP Inc./Fonterra Co-op Group Ltd., Wellington, New Zealand) in water with moderate mixing. The mixture was heated to 80° C. and held for five minutes, cooled to 50° C., and the pH was adjusted to 8.0 using 1M NaOH. Aliquots of the slurry were heated to 50° C. with medium mixing, and varying amounts of TL1 (˜17-600 mg of enzyme protein per kg of intact protein) were added to achieve targeted % DH values of 0, 2%, 4%, and 6%. After incubating at 50° C. for a period of time (about 60 min) to generate the desired degree of hydrolysis, the samples were heated to 90° C. for 3 min to inactivate the enzymes. The samples were chilled on ice and stored at 4° C. The degree of hydrolysis (% DH) was determined using the TNBS method (as described in Example 1).

The effect of pH on solubility was tested in two of the soy/dairy TL1 hydrolysates (i.e., 4.3% DH and 6.7% DH). Aliquots of each were adjusted to pH 5, pH 6, pH 7, or pH 8, and the samples were centrifuged at 500×g for 10 minutes. The amount of solid matter in solution before centrifuging was compared to the amount of solid matter in solution after centrifuging to give the soluble solids index (SSI), and a plot of the % soluble solids as a function of pH is presented in FIG. 13. Both solutions had reduced solubility at pH levels of about pH 5 (i.e., around the isoelectric point of soy protein). Both of the soy/dairy TL1 hydrolysates, however, had excellent solubility at levels of about pH 6.0 and above.

### Example 18

### Analysis of Peptide Fragments in TL1 Hydrolysates of Soy/Dairy

Peptide fragments in the soy/dairy TL1 hydrolysates prepared in Example 17 were identified by liquid chromatography mass spectrometry (LC-MS), using methods detailed above (see Examples 3, 4, and 13). The sequences of the peptide fragments identified in this study are listed in Table 17. Four new soy derived peptides were identified (i.e., SEQ ID NOs:174, 175, 176, and 177). The dairy derived sequences are SEQ ID NOs:178-197.

TABLE 17
Peptide Fragments* in TL1 Hydrolysates of
Soy/Dairy.

| SEQ ID | | |
|---|---|---|
| NO: | Sequence | MH+ |
| 13 | LSAEFGSLR | 979.45 |
| 96 | SSDFLTYGLK | 1130.50 |
| 174 | EAFGVNMQIVR | 1263.55 |
| 34 | ISTLNSLTLPALR | 1398.83 |
| 175 | ISPLPVLKEIFR | 1411.76 |
| 68 | VLIVPQNFVVAAR | 1425.67 |
| 14 | SQSDNFEYVSFK | 1450.50 |
| 56 | HHLAEAAEYVGQK | 1452.65 |
| 78 | AIPSEVLAHSYNLR | 1569.65 |
| 16 | FYLAGNQEQEFLK | 1586.65 |
| 61 | FFEITPEKNPQLR | 1618.66 |
| 121 | AGRISTLNSLTLPALR | 1682.88 |
| 176 | YEAGVVPPARFEAPR | 1658.76 |
| 37 | LQESVIVEISKEQIR | 1770.84 |
| 72 | NNNPFSFLVPPQESQR | 1873.80 |
| 69 | RPSYTNGPQEIYIQQGK | 1978.84 |
| 140 | NNNPFSFLVPPQESQRR | 2029.93 |
| 149 | SVSQNVLPLLQSAFDLNFTPR | 2346.00 |
| 152 | NAMFVPHYTLNANSIIYALNGR | 2479.02 |
| 177 | NAMFVPHYNLNANSIIYALNGR | 2492.02 |
| 156 | KNAMFVPHYTLNANSIIYALNGR | 2607.38 |
| 178 | YIPIQYVLSR | 1251.58 |
| 179 | YLGYLEQLLR | 1268.39 |
| 180 | HIQKEDVPSER | 1337.60 |
| 181 | FFVAPFPEVFGK | 1384.76 |
| 182 | FVAPFPEVFGKEK | 1494.68 |
| 183 | HPHLSFMAIPPKK | 1502.71 |
| 184 | YLGYLEQLLRLK | 1509.39 |
| 185 | IAKYIPIQYVLSR | 1563.77 |
| 186 | HPHPHLSFMAIPPK | 1608.72 |
| 187 | FFVAPFPEVFGKEK | 1642.29 |
| 188 | HPHPHLSFMAIPPKK | 1736.78 |
| 189 | HQGLPQEVLNENLLR | 1759.80 |
| 190 | SPAQILQWQVLSNTVPAK | 1979.96 |
| 191 | HPHPHLSFMAIPPKKNQDK | 2222.18 |
| 192 | HPIKHQGLPQEVLNENLLR | 2235.07 |
| 193 | RPKHPIKHQGLPQEVLNENLLR | 2616.33 |
| 194 | YYQQKPVALINNQFLPYPYYAKPAAVR | 3216.39 |
| 195 | LHSMKEGIHAQQKEPMIGVNQELAYFYPELFR | 3804.52 |
| 196 | LITLAIPVNKPGRFESFFLSSTEAQQSYLQGFSR | 3832.67 |
| 197 | YPSYGLNYYQQKPVALINNQFLPYPYYAKPAAVR | 4010.66 |

*Dairy-derived peptide fragments = SEQ ID NOs: 178-197; Soy-derived peptide fragments = all other SEQ ID NOs.

### Example 19

### TL1 Hydrolysates Derived from Other Protein Materials

A variety of other plant-derived protein materials were treated with TL1 to generate additional hydrolysates. These hydrolysates were produced at a small scale (i.e., bench top). For this, 5% slurries of either canola, wheat gluten, or corn germ proteins were denatured at a temperature above 80° C. for five minutes. The protein slurries were neutralized to about pH 8.0-8.5 with an aqueous alkaline solution or an aqueous alkaline earth solution, such as a sodium hydroxide solution or a potassium hydroxide solution. Each of the protein slurries was then treated with TL1 enzyme at a temperature and for a time sufficient to hydrolyze the protein material. The TL1 enzyme was added to the protein slurries at a concentration of from 0.01% to 0.08% enzyme protein based on the protein curd weight basis. The enzyme was contacted with the protein curd material at a temperature of about 50° C. for a period of from 50 minutes to 70 minutes, to hydrolyze the protein. The hydrolysis reaction was terminated by heating the hydrolyzed soy protein material to a temperature that effectively inactivated the enzyme.

Table 18 presents the reaction parameters for a typical set of hydrolysates. The activity of TL1 enzyme was measured based on mole amino group. The increased TNBS values demonstrate the enzyme activity. Enzyme activity appeared to be affected by the suspension or solubility of the protein material, although the activities are not optimized for each protein.

TABLE 18
Reaction Parameters.

| | | | Dose | TNBS Value |
|---|---|---|---|---|
| | | | (mg enzyme | (moles NH₂ |
| | pH, | Time | protein/kg | per 100 kg |
| Sample | Temperature | (min) | solids) | protein)* |
| Canola D | 8.0, 50° C. | 60 | 400 | 38.8 |
| Canola E | 8.0, 50° C. | 60 | 800 | 46.1 |
| Corn Germ B | 8.0, 50° C. | 60 | 100 | 41.0 |
| Corn Germ D | 8.6, 50° C. | 60 | 400 | 48.9 |
| Corn Germ E | 8.0, 50° C. | 60 | 800 | 57.2 |
| Wheat E | 8.0, 50° C. | 60 | 800 | 20.8 |

*TNBS value = TNBS value of test sample − TNBS value of control sample (i.e., non-hydrolyzed protein)

The TL1 canola, corn, or wheat hydrolysates and non-hydrolyzed control samples were analyzed by SDS PAGE using standard procedures. FIG. 14 presents an image of the gel. This analysis revealed that all of the major protein subunits of each protein material were cleaved by TL1.

The representative peptides in the canola, corn, or wheat TL1 hydrolysates were identified using procedures detailed above. Table 19, 20, and 21 present representative peptides identified in the TL1 hydrolysates of canola, corn, and wheat, respectively.

TABLE 19
Peptides in TL1 Hydrolysates of Canola.

| SEQ ID | | |
|---|---|---|
| NO: | Peptide | MH+ |
| 198 | QTATHLPR | 923.43 |
| 199 | LQNQQVNR | 999.47 |
| 200 | YQTATHLPR | 1086.48 |
| 201 | GPFQVVRPPL | 1109.57 |
| 202 | MADAVGYAGQK | 1110.45 |
| 203 | EFQQAQHLR | 1156.51 |
| 204 | NNFEWISFK | 1184.51 |
| 205 | GASKAVKQQIR | 1185.56 |
| 206 | VQGQFGVIRPP | 1197.60 |
| 207 | IYQTATHLPR | 1199.50 |
| 208 | MADAVGYAGQKGK | 1295.50 |
| 209 | VQGPFSVIRPPL | 1309.70 |
| 210 | VQGQFGVIRPPL | 1310.68 |
| 211 | GLYLPSFFSTAK | 1330.64 |
| 212 | TNANAQINTLAGR | 1343.61 |
| 213 | ISYVVQGMGISGR | 1366.63 |
| 214 | NILNGFTPEVLAK | 1415.71 |
| 215 | TAQQLQNQQDNR | 1443.61 |
| 216 | RMADAVGYAGQKGK | 1451.62 |
| 217 | ATSQQFQWIEFK | 1512.63 |
| 218 | AGNNPQGQQWLQGR | 1553.66 |
| 219 | GQLLVVPQGFAVVKR | 1610.88 |
| 220 | TLLFGEKPVTVFGIR | 1676.86 |
| 221 | LLAGNNPQGQQWLQGR | 1779.82 |
| 222 | VTSVNSYTLPILQYIR | 1866.93 |
| 223 | MNQFFHGWYMEPLTK | 1928.79 |
| 224 | TAQQLQNQQDNRGNIVR | 1982.91 |
| 225 | PFLLAGNNPQGQQWLQGR | 2023.94 |
| 226 | FGIVEGLMTTVHSITATQK | 2032.96 |
| 227 | GLPLEVISNGYQISPQEAR | 2070.99 |
| 228 | WFLPFDESDPASIEAAER | 2079.83 |
| 229 | GLPLEVISNGYQISLEEAR | 2088.00 |
| 230 | ALPLEVITNAFQISLEEAR | 2114.49 |
| 231 | QQGQQQGQQGQQLQHEISR | 2205.89 |
| 232 | NFGKDFIFGVASSAYQIEGGR | 2262.97 |
| 233 | ALPLEVITNAFQISLEEARR | 2270.49 |
| 234 | THENIDDPARADVYKPNLGR | 2281.00 |
| 235 | FNTIETTLTHSSGPASYGRPR | 2291.97 |
| 236 | NLRPFLLAGNNPQGQQWLQGR | 2406.69 |
| 237 | VFDQEISKGQLLVVPQGFAVVKR | 2557.27 |

TABLE 20
Peptides in TL1 Hydrolysates of Corn (Maize).

| SEQ ID | | |
|---|---|---|
| NO: | Peptide | MH+ |
| 238 | VAVLEANPR | 968.60 |
| 239 | RPYVFDRR | 1108.69 |
| 240 | HGQDKGIIVR | 1122.74 |
| 241 | AIGFDGLGDPGR | 1174.69 |
| 242 | VLRPFDEVSR | 1217.76 |
| 243 | NPESFLSSFSK | 1242.68 |
| 244 | VFLAGADNVLQK | 1274.80 |
| 245 | DIGFNGLADPNR | 1288.75 |
| 246 | NALENYAYNMR | 1358.73 |
| 247 | VPTVDVSVVDLTVR | 1498.34 |
| 248 | QISWNYNYGPAGR | 1525.83 |
| 249 | ARFEELNMDLFR | 1540.98 |
| 250 | REQLGQQGYSEMGK | 1610.84 |
| 251 | TLLFGDKPVTVFGIR | 1663.11 |
| 252 | REQLGQQGYSEMGKK | 1739.04 |
| 253 | GPLQISWNYNYGPAGR | 1793.05 |
| 254 | ALSFASKAEEVDEVLGSRR | 1908.10 |
| 255 | AVGKVLPDLNGKLTGMSFR | 2003.30 |
| 256 | ALSFASKAEEVDELGSRR | 2064.30 |
| 257 | LSPGTAFVVPAGHPFVAVASR | 2080.53 |
| 258 | DQRPSIANQHGQLYEADAR | 2169.30 |
| 259 | ARLSPGTAFVVPAGHPFVAVASR | 2307.41 |
| 260 | RHASEGGHGPHWPLPPFGESR | 2308.34 |
| 261 | YYGRGPLQISWNYNYGPAGR | 2332.25 |

TABLE 21
Peptides in TL1 Hydrolysates of Wheat.

| SEQ ID | | |
|---|---|---|
| NO: | Peptid | MH+ |
| 262 | WSTGLQMR | 978.53 |
| 263 | QVVDQQLAGR | 1113.62 |
| 264 | QYEQTVVPPK | 1188.70 |
| 265 | QGQQGYYPTSPQHTGQR | 1933.07 |
| 266 | QVVDQQLAGRLPWSTGLQMR | 2283.30 |
| 267 | QGYDSPYHVSAEQQAASPMVAK | 2364.25 |
| 268 | SLQQPGQGQQIGQGQQGYYPTSPQHTGQR | 3154.78 |
| 269 | QGYYPTSLQQPGQGQQIGQGQQGYYPTSPQHTGQR | 3864.02 |

### Example 20

### Sensory Analysis of Combinations of Soy Hydrolysates and Intact Dairy Protein

TL1 hydrolysates of soy were combined with intact dairy proteins (i.e., caseinate or whey). The sensory profiles of these combinations of soy hydrolysates and intact dairy protein were compared to combinations of non-hydrolyzed (intact) soy and intact dairy proteins using the SOS method, which was detailed above in Example 6. A TL1 soy hydrolysate having a degree of hydrolysis of about 2.1% DH was diluted to a 5% slurry. Non-hydrolyzed soy protein was also diluted to a 5% slurry. For one trial, the TL1 hydrolysate was mixed with sodium caseinate (1:1) and assessed against a control sample, which was the non-hydrolyzed soy protein mixed with sodium caseinate (1:1). In a second trial, the TL1 hydrolysate was mixed with sweet dairy whey (4:1) and assessed against the control sample, which was non-hydrolyzed soy protein mixed with sweet dairy whey (4:1).

Table 22 presents the mean SOS scores for each sample and the diagnostic ratings. The combinations comprising the TL1 hydrolysate were generally rated as slightly different from the control sample. The diagnostic scores showed that combinations of TL1 hydrolysate and intact dairy protein have improved sensory characteristics relative to control samples (i.e., combinations of non-hydrolyzed soy and intact dairy proteins).

TABLE 22
SQS Analysis.

| | | Diagnostic |
|---|---|---|
| Sample | SQS Score | Rating* |
| TL1 Hydrolysate + Casein | 3.7 | ↓ grain |
| TL1 Hydrolysate + Dairy Whey | 3.6 | ↓ soy/legume |

*↓ = slightly less than the control sample

### Example 21

### Analysis of Frozen Confections Comprising a Protein Hydrolysate (Supro® XF8020)

A frozen dessert product resembling ice cream was prepared using a TL1 soy hydrolysate, Supro® XF8020, at various replacement levels. Each “ice cream” sample was formed by first adding phosphate to water in a stainless steel container and heating to 100° F. A desirable amount of a protein hydrolysate (Supro® XF8020) was added, and the components were mixed at medium speeding using a propeller-type mixer for 5-10 minutes in order to disperse and hydrate the protein. After the protein was thoroughly dispersed, the slurry temperature was increased to 180° F., and the slurry was mixed at low speed for 5 minutes. Sugar and corn syrup solids were added to the protein slurry and mixing continued for 3 more minutes at medium speed. Heavy cream and Polysorbate 60 were then added, and the combined ingredients were mixed at medium speed for 3-5 minutes until the components were completely dispersed. The mixture was then pasteurized at 180° F. with a hold time of 30 seconds. After pasteurization, the mixture was homogenized using a 2 stage, single piston homogenizer set at 500 psi, second stage; 2500 psi, first stage. Following homogenization the mixture was collected in pre-sterilized Nalgene® bottles and immediately place in an ice bath, where they were held for 30 minutes. The chilled bottles were placed in a 35° F. walk-in cooler and stored overnight. Prior to freezing, vanilla flavoring was blended with the chilled mixture. The flavored mixture was then dispensed into a Taylor Batch Ice Cream Freezer and freezing of the mixture occurred over 7 minutes to reach a temperature of 24° F.-26° F. The mixture was drawn from the freezer and packaged into appropriately labeled 1 pint Sweetheart K16A cups. The sample cups were placed bottom side up on plastic trays and placed into a blast freezer at −20° F. overnight and moved to a 0° F. freezer for storage until evaluation.

Tables 23 through 27 present the formulations of the samples at 10%, 20%, 30%, 40%, and 50% protein hydrolysate replacement.

TABLE 23
Frozen Confection Forumulation with 10% Protein
Hydrolysate (Supro ® XF8020)

| | Control - All Milk | | TL1 - 10% Replace | |
|---|---|---|---|---|
| | Percent | weight | Percent | Weight |
| Ingredient | Use | (g) | Use | (g) |
| Distilled Water | 53.7100 | 3222.60 | 53.8100 | 3228.60 |
| Sugar | 12.0000 | 720.00 | 12.0000 | 720.00 |
| Corn Syrup Solids, 36DE | 8.0000 | 480.00 | 8.4000 | 504.20 |
| Nonfat Skim Milk Powder | 8.0000 | 480.00 | 7.1700 | 430.20 |
| Supro XF8020 | — | — | 0.3300 | 19.80 |
| Heavy Cream, 37% | 18.1400 | 1088.40 | 18.1400 | 1800.40 |
| Dipotassium Phosphate | 0.1000 | 6.00 | 0.1000 | 6.00 |
| Tween 60, Polysorbate 60 | 0.0500 | 3.00 | 0.0500 | 3.00 |
| | 100.0000 | 6000.00 | 100.0000 | 6000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

TABLE 24
Frozen Confection Product Formulation with 20% Protein
Hydrolysate (Supro ® XF8020)

| | Control - All Milk | | TL1 - 20% Replace | |
|---|---|---|---|---|
| | Percent | Weight | Percent | Weight |
| Ingredient | Use | (g) | Use | (g) |
| Distilled Water | 53.7100 | 3222.60 | 53.9100 | 3234.60 |
| Sugar | 12.0000 | 720.00 | 12.0000 | 720.00 |
| Corn Syrup Solids, 36DE | 8.0000 | 480.00 | 8.8000 | 528.00 |
| Nonfat Skim Milk Powder | 8.0000 | 480.00 | 6.3400 | 380.40 |
| Supro XF8020 | — | | 0.6600 | 39.60 |
| Heavy Cream, 37% | 18.1400 | 1088.40 | 18.1400 | 1800.40 |
| Dipotassium Phosphate | 0.1000 | 6.00 | 0.1000 | 6.00 |
| Tween 60, Polysorbate 60 | 0.0500 | 3.00 | 0.0500 | 3.00 |
| | 100.0000 | 6000.00 | 100.0000 | 6000.00 |

| | Vanilla | |
|---|---|---|
| Flavor | % | Q/4000 g |
| Unflavored base | 99.6500 | 3986.00 |
| Vanilla Flavor, Quest QL89976 | 0.3500 | 14.00 |
| | 100.0000 | 4000.00 |

TABLE 25
Frozen Confection Product Formulation with 30% Protein
Hydrolysate (Supro ® XF8020)

| | Control - All Milk | | TL1 - 30% Replace | |
|---|---|---|---|---|
| | Percent | Weight | Percent | Weight |
| Ingredient | Use | (g) | Use | (g) |
| Distilled Water | 53.7100 | 3222.60 | 54.0100 | 3240.60 |
| Sugar | 12.0000 | 720.00 | 12.0000 | 720.00 |
| Corn Syrup Solids, 36DE | 8.0000 | 480.00 | 9.2000 | 552.00 |
| Nonfat Skim Milk Powder | 8.0000 | 480.00 | 5.5100 | 330.60 |
| Supro XF8020 | — | — | 0.9900 | 59.40 |
| Heavy Cream, 37% | 18.1400 | 1088.40 | 18.1400 | 1800.40 |
| Dipotassium Phosphate | 0.1000 | 6.00 | 0.1000 | 6.00 |
| Tween 60, Polysorbate 60 | 0.0500 | 3.00 | 0.0500 | 3.00 |
| | 100.0000 | 6000.00 | 100.0000 | 6000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

TABLE 26
Frozen Confection Product Formulation with 40% Protein
Hydrolysate (Supro ® XF8020)

| | Control - All Milk | | TL1 - 40% Replace | |
|---|---|---|---|---|
| | Percent | Weight | Percent | Weight |
| Ingredient | Use | (g) | Use | (g) |
| Distilled Water | 53.7100 | 3222.60 | 54.1100 | 3246.60 |
| Sugar | 12.0000 | 720.00 | 12.0000 | 720.00 |
| Corn Syrup Solids, 36DE | 8.0000 | 480.00 | 9.6000 | 576.00 |
| Nonfat Skim Milk Powder | 8.0000 | 480.00 | 4.6800 | 280.80 |
| Supro XF8020 | — | — | 1.3200 | 79.20 |
| Heavy Cream, 37% | 18.1400 | 1088.40 | 18.1400 | 1800.40 |
| Dipotassium Phosphate | 0.1000 | 6.00 | 0.1000 | 6.00 |
| Tween 60, Polysorbate 60 | 0.0500 | 3.00 | 0.0500 | 3.00 |
| | 100.0000 | 6000.00 | 100.0000 | 6000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

TABLE 27
Frozen Confection Product Formulation with 50% Protein
Hygrolysate (Supro ® XF8020)

| | Control - All Milk | | TL1 - 50% Replace | |
|---|---|---|---|---|
| | Percent | Weight | Percent | Weight |
| Ingredient | Use | (g) | Use | (g) |
| Distilled Water | 53.7166 | 3222.60 | 54.2100 | 3252.60 |
| Sugar | 12.0000 | 720.00 | 12.0000 | 720.00 |
| Corn Syrup Solids, 36DE | 8.0000 | 480.00 | 10.0000 | 600.00 |
| Nonfat Skim Milk Powder | 8.0000 | 480.00 | 3.8500 | 231.00 |
| Supro XF8020 | — | — | 1.6500 | 99.00 |
| Heavy Cream, 37% | 18.1400 | 1088.40 | 18.1400 | 1800.40 |
| Dipotassium Phosphate | 0.1000 | 6.00 | 0.1000 | 6.00 |
| Tween 60, Polysorbate 60 | 0.0500 | 3.00 | 0.0500 | 3.00 |
| | 100.0000 | 6000.00 | 100.0000 | 6000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

Seven panelists trained in the Sensory Spectrum Descriptive Profiling method evaluated the samples in triplicate. The purpose of the evaluation was to quantify the flavor characteristics of a soy protein “ice cream” product formulated and produced according to the invention compared to that of vanilla ice cream prepared with one hundred percent dairy. Nineteen flavor attributes were evaluated on a 15-point intensity scale, with 0 for none/not applicable and 15 for very strong/high in each sample. The flavor attributes examined in the samples, definitions of the flavor attributes, and the flavor intensity scale reference samples used are set forth in Table 28.

TABLE 28
Vanilla Flavored Frozen Confection Lexicon

| | | |
|---|---|---|
| Attribute | Definition | References |

Intensities based on Universal Scale:
Baking Soda in Saltine = 2.5
Cooked Apple in Applesauce = 5.0
Orange in Orange Juice = 7.5
Concord Grape in Grape Juice = 10.0
Cinnamon In Big Red Gum = 12.0

AROMATICS

| | | |
|---|---|---|
| Overall Flavor | The overall intensity of the product | |
| Impact | aromas, an amalgamation of all | |
| | perceived aromatics, basic tastes | |
| | and chemical feeling factors. | |
| Vanilla | The general category used to | |
| Complex | describe the total vanilla impact in a | |
| | product. | |
| Vanilla/vanillin | The aromatics associated with | Vanilla Extract, Vanillin |
| | vanilla, including artificial vanilla, | crystals |
| | woody, and browned notes. | |
| Caramelized | The aromatics associated with | Caramelized sugar |
| | browned sugars such as caramel. | |
| Soy/Legume | The aromatics associated with | Unsweetened SILK ™ |
| | legumes/soybeans; may include all | soymilk, canned |
| | types and different stages of | soybeans, tofu |
| | heating. | |
| Grain | The aromatics associated with the | All-purpose flour paste, |
| | total grain impact, which may | cream of wheat, whole |
| | include all types of grain and | wheat pasta |
| | different stages of heating. May | |
| | include wheat, whole wheat, oat, | |
| | rice, graham, etc. | |
| Nutty | The aromatics associated with a | Most tree nuts: pecans, |
| | nutty/woody flavor; also a | almonds, hazelnuts, |
| | characteristic of walnuts and other | walnuts |
| | nuts. Includes hulls/skins of nuts. | |
| Milky | The slightly sour, animal, milky | Skim milk |
| | aromatic associated with skim milk | |
| | and milk derived products. | |
| Barnyard | Aromatic characteristic of a | Old casein, white |
| | barnyard; combination of manure, | pepper, processed |
| | urine, moldy hay, feed, livestock | rotten potatoes |
| | odors. | |
| Animal | Aroma similar to smell of live | Unprocessed sheep |
| | animal, including its hair. | wool |
| Dairy Fat | The slightly sweet, buttery (real) | Heavy cream |
| | aromatic associated with dairy fat. | |
| Cardboard/ | The aromatics associated with | Toothpicks, water from |
| Woody | dried wood and the aromatics | cardboard soaked for 1 |
| | associated with slightly oxidized | hour |
| | fats and oils, reminiscent of a | |
| | cardboard box. | |
| Chemical | A general term used to describe the | Saccharin, Aspartame |
| | aromatic associated with artificial | |
| | sweetener. (Does not include basic | |
| | taste sweet). | |
| Other | | Playdoh |

BASIC TASTES

| Sweet | The taste on the tongue stimulated | Sucrose solutions: | |
|---|---|---|---|
| | by sucrose and other sugars, such | 2% | 2.0 |
| | as fructose, glucose, etc., and by | 5% | 5.0 |
| | other sweet substances, such as | 10% | 10.0 |
| | saccharin, Aspartame, and | 16% | 15.0 |
| | Acesulfame-K. | | |
| Sour | The taste on the tongue stimulated | Citric acid solutions: | |
| | by acid, such as citric, malic, | 0.05% | 2.0 |
| | phosphoric, etc. | 0.08% | 5.0 |
| | | 0.15% | 10.0 |
| | | 0.20% | 15.0 |
| Salt | The taste on the tongue associated | Sodium chloride solutions: | |
| | with sodium salts. | 0.2% | 2.0 |
| | | 0.35% | 5.0 |
| | | 0.5% | 8.5 |
| | | 0.57% | 10.0 |
| | | 0.7% | 15.0 |
| Bitter | The taste on the tongue associated | Caffeine solutions: | |
| | with caffeine and other bitter | 0.05% | 2.0 |
| | substances, such as quinine and | 0.08% | 5.0 |
| | hop bitters. | 0.15% | 10.0 |
| | | 0.20% | 15.0 |

CHEMICAL FEELING FACTOR

| Astringent | The shrinking or puckering of the | Alum solutions: | |
|---|---|---|---|
| | tongue surface caused by | 0.05% | 3.0 |
| | substances such as tannins or | 0.10% | 6.0 |
| | alum. | 0.20% | 9.0 |

Table 29 presents the panelists' mean intensity scores for the five samples (10%, 20%, 30%, 40%, and 50%) as compared to the control (100% dairy).

TABLE 29
Mean Scores for Flavor Attributes of Samples Containing Supro ® XF8020

| Aromatics | Control | 10% | 20% | 30% | 40% | 50% |
|---|---|---|---|---|---|---|
| Overall Flavor Impact | 6.3 a | 6.3 a | 6.1 ab | 6.1 b | 6.1 b | 6.1 ab |
| Vanilla Complex | 4.1 a | 4.4 a | 3.9 b | 3.7 b | 3.9 b | 3.8 b |
| Vanilla/Vanillin | 3.3 ab | 3.4 a | 3.1 c | 3.1 bc | 3.1 c | 3.1 bc |
| Caramelized | 2.7 a | 2.7 a | 2.7 a | 2.7 a | 2.7 a | 2.5 a |
| Soy/Legume | 0.0 d | 0.6 cd | 1.5 ab | 1.0 bc | 1.7 ab | 2.1 a |
| Milky | 2.6 a | 2.5 b | 2.5 ab | 2.4 b | 2.4 b | 2.4 b |
| Dairy Fat | 2.1 a | 2.1 a | 2.2 a | 2.1 a | 2.1 a | 2.1 a |
| Cardboard/Woody | 1.5 a | 0.9 b | 0.9 b | 1.1 ab | 0.9 b | 0.9 b |
| Other Aromatic: Playdoh | 0.0 | 0.0 | 0.0 | 0.0 | 2.0 (14%) | 0.0 |
| Sweet | 4.7 b | 5.1 a | 4.9 ab | 5.0 a | 4.9 ab | 5.1 a |
| Sour | 2.0 a | 2.0 a | 2.0 a | 2.0 a | 2.0 a | 2.0 a |
| Salt | 0.8 a | 0.7 a | 0.7 a | 0.7 a | 0.8 a | 0.7 a |
| Bitter | 1.1 a | 1.1 a | 1.1 a | 1.1 a | 1.1 a | 1.1 a |
| Astringent | 2.0 a | 2.0 a | 2.0 a | 2.0 a | 2.0 a | 2.0 a |

As FIG. 15 and Table 29 both illustrate, the presence of the soy protein in the samples was not detected until replacement levels were at or above 20%. The strength of the Soy flavor remained at or below an intensity level of 2.0 on the 15-point scale, even when the samples included 50% soy protein. In fact, Milky, Dairy Fat, Caramelized, and Vanilla Complex aromatics were all stronger in intensity relative to Soy/Legume. Additionally, there was only a slight decrease in the Milky aromatic at 10% soy replacement as compared to 100% dairy, while the Vanilla Complex and Vanilla/Vanillin flavors increased slightly at 10% soy replacement but then decreased as the soy replacement levels increased to 20% and above.

FIG. 17 presents the acceptability of the soy protein samples at soy protein inclusion levels of 10%, 20%, and 40%, as assessed by a separate panel of 74 consumers, ages 35-54, recruited as willing to try vanilla flavored frozen desserts. Samples were presented to each consumer in a balanced sequential monadic fashion, in which each sample was served individually and taken away before the next sample was evaluated, Serving order was rotated and balanced to minimize bias due to serving order effects, consistent with standard sensory testing protocol.

As the graph in FIG. 17 illustrates, the mean overall liking, appearance liking, flavor liking, mouth feel liking, and aftertaste liking responses for the sample products were comparable to that of the all-dairy ice cream control sample at 10% and 20% soy protein inclusion, but the mean liking scores decreased slightly at 40% inclusion.

This example illustrates that a frozen confection product resembling ice cream, which includes an amount of a soy protein hydrolysate in lieu of dairy, may be favorably accepted as a replacement frozen dessert for those frozen dessert products containing one hundred percent dairy.

### Example 22

### Analysis of Frozen Confections Comprising Supro® 120

A frozen dessert product resembling ice cream was prepared using Supro® 120 at various replacement levels—10%, 20%, 30%, 40%, and 50%. Each “ice cream” sample was formed by first adding phosphate to water in a stainless steel container and heating to 100° F. A desirable amount of Supro® 120 was added, and the components were mixed at medium speeding using a propeller-type mixer for 5-10 minutes in order to disperse and hydrate the protein. After the protein was thoroughly dispersed, the slurry temperature was increased to 180° F., and the slurry was mixed at low speed for 5 minutes. Sugar and corn syrup solids were added to the protein slurry and mixing continued for 3 more minutes at medium speed. Heavy cream and Polysorbate 60 were added to the mixture and the combined ingredients were mixed at medium speed for 3-5 minutes until the components were completely dispersed. The mixture was then pasteurized at 180° F. with a hold time of 30 seconds. After pasteurization, the mixture was homogenized using a 2 stage, single piston homogenizer set at 500 psi, second stage; 2500 psi, first stage. Following homogenization the mixture was collected in pre-sterilized Nalgene® bottles and immediately place in an ice bath and held for 30 minutes. The chilled bottles were placed in a 35° F. walk-in cooler and stored overnight. Prior to freezing, vanilla flavoring was blended with the chilled mixture. The flavored mixture was then dispensed into a Taylor Batch Ice Cream Freezer and freezing of the mixture occurred over 7 minutes to reach a temperature of 24° F. to 26° F. The mixture was drawn from the freezer and packaged into appropriately labeled 1 pint Sweetheart K16A cups. The sample cups were placed bottom side up on plastic trays and placed into a blast freezer at −20° F. overnight and moved to a 0° F. freezer for storage until evaluation.

Tables 30 through 34 presents the formulations of the samples at 10%, 20%, 30%, 40%, and 50% protein isolate replacement.

TABLE 30
Frozen Confection Product Formulation with 10% Supro ® 120

| | Control - All Milk | | 10% Replace | |
|---|---|---|---|---|
| | Percent | Weight | Percent | Weight |
| Ingredient | Use | (g) | Use | (g) |
| Distilled Water | 53.7100 | 4296.80 | 53.8100 | 4304.80 |
| Sugar | 12.0000 | 960.00 | 12.0000 | 960.00 |
| born Syrup Solids, 36DE | 8.0000 | 640.00 | 8.0000 | 640.00 |
| Nonfat Skim Milk Powder | 8.0000 | 640.00 | 8.4000 | 672.00 |
| Supro 120 | 0.0000 | 0.00 | 0.3300 | 26.40 |
| Heavy Cream, 37% | 18.1400 | 1451.20 | 18.1400 | 1451.20 |
| Dipotassium Phosphate | 0.1000 | 8.00 | 0.1000 | 8.00 |
| Tween 60, Polysorbate 60 | 0.0500 | 4.00 | 0.0500 | 4.00 |
| | 100.0000 | 8000.00 | 100.0000 | 8000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

TABLE 31
Frozen Confection Product Formulation with 20% Supro ® 120

| | Control - All Milk | | 20% Replace | |
|---|---|---|---|---|
| | Percent | Weight | Percent | Weight |
| Ingredient | Use | (g) | Use | (g) |
| Distilled Water | 53.7100 | 4296.80 | 53.9100 | 4312.80 |
| Sugar | 12.0000 | 960.00 | 12.0000 | 960.00 |
| Corn Syrup Solids, 36DE | 8.0000 | 640.00 | 8.8000 | 704.00 |
| Nonfat Skim Milk Powder | 8.0000 | 640.00 | 6.3400 | 507.20 |
| Supro 120 | 0.0000 | 0.00 | 0.6600 | 52.80 |
| Heavy Cream, 37% | 18.1400 | 1451.20 | 18.1400 | 1451.20 |
| Dipotassium Phosphate | 0.1000 | 8.00 | 0.1000 | 8.00 |
| Tween 60, Polysorbate 60 | 0.0500 | 4.00 | 0.0500 | 4.00 |
| | 100.0000 | 8000.00 | 100.0000 | 8000.00 |

| | Vanilla | |
|---|---|---|
| Flavor | % | g/4666 g |
| Unflavored base | 99.6500 | 3986.00 |
| Vanilla Flavor, Quest QL89976 | 0.3500 | 14.00 |
| | 100.0000 | 4000.00 |

TABLE 32
Frozen Confection Product Formulation with 30% Supro ® 120

| | Control - All Milk | | 30% Replace | |
|---|---|---|---|---|
| | Percent | Weight | Percent | Weight |
| Ingredient | Use | (g) | Use | (g) |
| Distilled Water | 53.7100 | 4296.80 | 54.0100 | 4320.80 |
| Sugar | 12.0000 | 960.00 | 12.0000 | 960.00 |
| Corn Syrup Solids, 36DE | 8.0000 | 640.00 | 9.2000 | 736.00 |
| Nonfat Skim Milk Powder | 8.0000 | 640.00 | 5.5100 | 440.80 |
| Supro 120 | 0.0000 | 0.00 | 0.9900 | 79.20 |
| Heavy Cream, 37% | 18.1400 | 1451.20 | 18.1400 | 1451.20 |
| Dipotassium Phosphate | 0.1000 | 8.00 | 0.1000 | 8.00 |
| Tween 60, Polysorbate 60 | 0.0500 | 4.00 | 0.0500 | 4.00 |
| | 100.0000 | 8000.00 | 100.0000 | 8000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

TABLE 33
Frozen Confection Product Formulation with 40% Supro ® 120

| | Control - All Milk | | 40% Replace | |
|---|---|---|---|---|
| | Percent | Weight | Percent | Weight |
| Ingredient | Use | (g) | Use | (g) |
| Distilled Water | 53.7100 | 4296.80 | 54.1100 | 4328.80 |
| Sugar | 12.0000 | 960.00 | 12.0000 | 960.00 |
| Corn Syrup Solids, 36DE | 8.0000 | 640.00 | 9.6000 | 768.00 |
| Nonfat Skim Milk Powder | 8.0000 | 640.00 | 4.6800 | 374.40 |
| Supro 120 | 0.0000 | 0.00 | 1.3200 | 105.60 |
| Heavy Cream, 37% | 18.1400 | 1451.20 | 18.1400 | 1451.20 |
| Dipotassium Phosphate | 0.1000 | 8.00 | 0.1000 | 8.00 |
| Tween 60, Polysorbate 60 | 0.0500 | 4.00 | 0.0500 | 4.00 |
| | 100.0000 | 8000.00 | 100.0000 | 8000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

TABLE 34
Frozen Confection Product Formulation with 50% Supro ® 120

| | Control - All Milk | | 60% Replace | |
|---|---|---|---|---|
| | Percent | Weight | Percent | Weight |
| Ingredient | Use | (g) | Use | (g) |
| Distilled Water | 53.7100 | 4296.80 | 54.2100 | 4336.80 |
| Sugar | 12.0000 | 960.00 | 12.0000 | 960.00 |
| Corn Syrup Solids, 36DE | 8.0000 | 640.00 | 10.0000 | 800.00 |
| Nonfat Skim Milk Powder | 8.0000 | 640.00 | 3.8500 | 308.00 |
| Supro 120 | 0.0000 | 0.00 | 1.6500 | 132.00 |
| Heavy Cream, 37% | 18.1400 | 1451.20 | 18.1400 | 1451.20 |
| Dipotassium Phosphate | 0.1000 | 8.00 | 0.1000 | 8.00 |
| Tween 60, Polysorbate 60 | 0.0500 | 4.00 | 0.0500 | 4.00 |
| | 100.0000 | 8000.00 | 100.0000 | 8000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

Seven panelists trained in the Sensory Spectrum Descriptive Profiling method evaluated the samples in triplicate. The purpose of the evaluation was to quantify the flavor characteristics of a soy protein product resembling ice cream, which is formulated and produced according to the invention compared to that of vanilla ice cream prepared with one hundred percent dairy. Nineteen flavor attributes were evaluated on a 15-point intensity scale, with 0 for none/not applicable and 15 for very strong/high in each sample. The flavor attributes examined in the samples, definitions of the flavor attributes, and the flavor intensity scale reference samples used are set forth above in Table 28.

As FIG. 16 illustrates, the presence of Supro® 120 in the samples was not detected until replacement levels were at or above 30%. The strength of the Soy flavor remained at or below 2.5 on the 15-point scale, even when the samples included 50% soy protein. In fact, Milky, Caramelized, and Vanilla Complex aromatics were all stronger in intensity relative to Soy/Legume, even at 50% soy inclusion. Additionally, there was only a slight decrease in the Milky and Caramelized aromatic at 20% soy replacement as compared to 100% dairy.

FIG. 18 presents the acceptability of the soy protein samples at Supro® 120 inclusion levels of 10%, 20%, and 40%, as assessed by a separate panel of 74 consumers, ages 35-54, recruited as willing to try vanilla flavored frozen desserts. Samples were presented to each consumer in a balanced sequential monadic fashion, in which each sample was served individually and taken away before the next sample was evaluated. Serving order was rotated and balanced to minimize bias due to serving order effects, consistent with standard sensory testing protocol.

As the graph in FIG. 18 illustrates, the mean overall liking, color liking, flavor liking, mouth feel liking, and aftertaste liking responses for the samples were comparable to or higher than that of the all-dairy control sample. For example, at 10% soy protein inclusion, overall liking, appearance liking, flavor liking, mouth feel liking, and aftertaste liking mean scores were all equal to or higher than that of the all-dairy control sample. At 20% soy protein inclusion, appearance liking score was higher than that of the all-dairy control sample, while overall liking, flavor liking, mouth feel liking, and aftertaste liking mean scores only decreased slightly. At 40% soy protein inclusion, the appearance liking and mouth feel liking scores were only slightly lower than that of the all-dairy control sample.

This example illustrates that a frozen confection product resembling ice cream, which includes an amount of Supro® 120 in lieu of dairy, may be favorably accepted as a replacement frozen dessert for those frozen dessert products containing one hundred percent dairy.

### Example 23

### Analysis of Frozen Confections Comprising a Supro® 760

A frozen dessert product resembling ice cream was prepared using Supro® 760 at various replacement levels—10%, 20%, 30%, 40%, and 50%. Each sample was formed by first adding phosphate to water in a stainless steel container and heating to 100° F. A desirable amount of Supro® 760 was added, and the components were mixed at medium speeding using a propeller-type mixer for 5-10 minutes in order to disperse and hydrate the protein. After the protein was thoroughly dispersed, the slurry temperature was increased to 180° F., and the slurry was mixed at low speed for 5 minutes. Sugar and corn syrup solids were added to the protein slurry and mixing continued for 3 more minutes at medium speed. Heavy cream and Polysorbate 60 were then added, and the combined ingredients were mixed at medium speed for 3-5 minutes until the components were completely dispersed. The mixture was then pasteurized at 180° F. with a hold time of 30 seconds. After pasteurization, the mixture was homogenized using a 2 stage, single piston homogenizer set at 500 psi, second stage; 2500 psi, first stage. Following homogenization the mixture was collected in pre-sterilized Nalgene® bottles and immediately place in an ice bath and held for 30 minutes. The chilled bottles were placed in a 35° F. walk-in cooler and stored overnight. Prior to freezing, vanilla flavoring was blended with the chilled mixture. The flavored mixture was then dispensed into a Taylor Batch Ice Cream Freezer and freezing of the mixture occurred over 7 minutes to reach a temperature of 24° F. to 26° F. The mixture was drawn from the freezer and packaged into appropriately labeled 1 pint Sweetheart K16A cups. The sample cups were placed bottom side up on plastic trays and placed into a blast freezer at −20° F. overnight and moved to a 0° F. freezer for storage until evaluation.

Tables 35 through 39 present the formulations of the samples at 10%, 20%, 30%, 40%, and 50% protein isolate replacement.

TABLE 35
Frozen Confection Product Formulation with 10% Supro ® 760

| | Control - All Milk | | 10% Replace | |
|---|---|---|---|---|
| | Percent | Weight | Percent | Weight |
| Ingredient | Use | (g) | Use | (g) |
| Distilled Water | 53.7100 | 4833.90 | 53.8100 | 4842.90 |
| Sugar | 12.0000 | 1080.00 | 12.0000 | 1080.00 |
| Corn Syrup Solids, 36DE | 8.0000 | 720.00 | 8.4000 | 756.00 |
| Nonfat Skim Milk Powder | 8.0000 | 720.00 | 7.1700 | 645.30 |
| Supro 760 | 0.0000 | 0.00 | 0.3300 | 29.70 |
| Heavy Cream, 37% | 18.1400 | 1632.60 | 18.1400 | 1632.60 |
| Dipotassium Phosphate | 0.1000 | 9.00 | 0.1000 | 9.00 |
| Tween 60, Polysorbate 60 | 0.0500 | 4.50 | 0.0500 | 4.50 |
| | 100.0000 | 9000.00 | 100.0000 | 9000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

TABLE 36
Frozen Confection Product Formulation with 20% Supro ® 760

| | Control - All Milk | | 20% Replace | |
|---|---|---|---|---|
| | Percent | Weight | Percent | Weight |
| Ingredient | Use | (g) | Use | (g) |
| Distilled Water | 53.7100 | 4833.90 | 53.9100 | 4851.90 |
| Sugar | 12.0000 | 1080.00 | 12.0000 | 1080.00 |
| Corn Syrup Solids, 36DE | 8.0000 | 720.00 | 8.8000 | 792.00 |
| Nonfat Skim Milk Powder | 8.0000 | 720.00 | 6.3400 | 570.60 |
| Supro 760 | 0.0000 | 0.00 | 0.6600 | 59.40 |
| Heavy Cream, 37% | 18.1400 | 1632.60 | 18.1400 | 1632.60 |
| Dipotassium Phosphate | 0.1000 | 9.00 | 0.1000 | 9.00 |
| Tween 60, Polysorbate 60 | 0.0500 | 4.50 | 0.0500 | 4.50 |
| | 100.0000 | 9000.00 | 100.0000 | 9000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

TABLE 37
Frozen Confection Product Formulation with 30% Supro ® 760

| | Control - All Milk | | 30% Replace | |
|---|---|---|---|---|
| | Percent | Weight | Percent | Weight |
| Ingredient | Use | (g) | Use | (g) |
| Distilled Water | 53.7100 | 4833.90 | 54.0100 | 4860.90 |
| Sugar | 12.0000 | 1080.00 | 12.0000 | 1080.00 |
| Corn Syrup Solids, 36DE | 8.0000 | 720.00 | 9.2000 | 828.00 |
| Nonfat Skim Milk Powder | 8.0000 | 720.00 | 5.5100 | 495.90 |
| Supro 760 | 0.0000 | 0.00 | 0.9900 | 89.10 |
| Heavy Cream, 37% | 18.1400 | 1632.60 | 18.1400 | 1632.60 |
| Dipotassium Phosphate | 0.1000 | 9.00 | 6.1000 | 9.00 |
| Tween 60, Polysorbate 60 | 0.0500 | 4.50 | 0.0500 | 4.50 |
| | 100.0000 | 9000.00 | 100.0000 | 9000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

TABLE 38
Frozen Confection Product Formulation with 40% Supro ® 760

| | Control - All Milk | | 40% Replace | |
|---|---|---|---|---|
| | Percent | Weight | Percent | Weight |
| Ingredient | Use | (g) | Use | (g) |
| Distilled Water | 53.7100 | 4833.90 | 54.1100 | 4869.90 |
| Sugar | 12.0000 | 1080.00 | 12.0000 | 1080.00 |
| Corn Syrup Solids, 36DE | 8.0000 | 720.00 | 9.6000 | 864.00 |
| Nonfat Skim Milk Powder | 8.0000 | 720.00 | 4.6800 | 421.20 |
| Supro 760 | 0.0000 | 0.00 | 1.3200 | 118.80 |
| Heavy Cream, 37% | 18.1400 | 1632.60 | 18.1400 | 1632.60 |
| Dipotassium Phosphate | 0.1000 | 9.00 | 0.1000 | 9.00 |
| Tween 60, Polysorbate 60 | 0.0500 | 4.50 | 0.0500 | 4.50 |
| | 100.0000 | 9000.00 | 100.0000 | 9000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

TABLE 39
Frozen Confection Product Formulation with 50% Supro ® 760

| | Control - All Milk | | 50% Replace | |
|---|---|---|---|---|
| | Percent | Weight | Percent | Weight |
| Ingredient | Use | (g) | Use | (g) |
| Distilled Water | 53.7100 | 4833.90 | 54.2100 | 4878.90 |
| Sugar | 12.0000 | 1080.00 | 12.0000 | 1080.00 |
| Corn Syrup Solids, 36DE | 8.0000 | 720.00 | 10.0000 | 900.00 |
| Nonfat Skim Milk Powder | 8.0000 | 720.00 | 3.8500 | 346.50 |
| Supro 760 | 0.0000 | 0.00 | 1.6500 | 148.50 |
| Heavy Cream, 37% | 18.1400 | 1632.60 | 18.1400 | 1632.60 |
| Dipotassium Phosphate | 0.1000 | 9.00 | 0.1000 | 9.00 |
| Tween 60, Polysprbate 60 | 0.0500 | 4.50 | 0.0500 | 4.50 |
| | 100.0000 | 9000.00 | 100.0000 | 9000.00 |

| | Vanilla | |
|---|---|---|
| Flavor | % | g/4000 g |
| Unflavored base | 99.6500 | 3986.00 |
| Vanilla Flavor, Quest QL89976 | 0.3500 | 14.00 |
| | 100.0000 | 4000.00 |

Seven panelists trained in the Sensory Spectrum Descriptive Profiling method evaluated the samples in triplicate. The purpose of the evaluation was to determine the acceptance level of a soy protein “ice cream” product formulated and produced according to the invention compared to that of vanilla ice cream prepared with one hundred percent dairy. Nineteen flavor attributes were evaluated on a 15-point intensity scale, with 0 for none/not applicable and 15 for very strong/high in each sample. The flavor attributes examined in the samples, definitions of the flavor attributes, and the flavor intensity scale reference samples used are set forth above in Table 28.

Table 40 presents the panelists' mean intensity scores for the five samples (10%, 20%, 30%, 40%, and 50%) as compared to the control (100% dairy).

TABLE 40
Mean Scores for Flavor Attributes of Samples Containing Supro ® 760

| Aromatics | Control | 10% | 20% | 30% | 40% | 50% |
|---|---|---|---|---|---|---|
| Overall Flavor Impact | 6.2 a | 6.1 ab | 6.1 ab | 6.1 ab | 6.0 b | 6.2 a |
| Vanilla Complex | 4.4 a | 4.0 b | 3.9 b | 3.9 b | 3.7 b | 3.7 b |
| Vanilla/Vaniliin | 3.4 a | 3.3 a | 3.1 ab | 3.2 ab | 3.1 ab | 2.9 b |
| Caramelized | 2.9 a | 2.7 a | 2.5 b | 2.5 b | 2.7 a | 2.5 b |
| Soy/Legume | 0.0 c | 0.0 c | 1.1 b | 1.2 b | 1.9 a | 2.0 a |
| Milky | 2.7 a | 2.6 a | 2.6 a | 2.6 a | 2.5 a | 2.3 b |
| Dairy Fat | 2.1 a | 2.1 a | 2.0 a | 2.1 a | 2.0 a | 2.1 a |
| Cardboard/Woody | 1.1 a | 0.9 a | 1.1 a | 1.1 1 | 1.1 a | 0.9 b |
| Other Aromatic: Playdoh | 0.0 | 0.0 | 0.0 | 0.0 | 0.0 | 2.0 (29%) |
| Sweet | 4.9 a | 5.0 a | 4.9 a | 5.1 a | 5.0 a | 5.0 a |
| Sour | 2.0 a | 2.0 a | 2.0 a | 2.0 a | 2.0 a | 2.0 a |
| Salt | 0.8 a | 0.8 a | 0.7 a | 0.7 a | 0.7 a | 0.7 a |
| Bitter | 1.1 b | 1.1 b | 1.2 a | 1.1 b | 1.1 b | 1.1 b |
| Astringent | 2.0 a | 2.0 a | 2.0 a | 2.0 a | 2.0 a | 2.0 a |

As FIG. 17 and Table 40 both illustrate, the presence of Supro® 760 in the samples was not detected until replacement levels were at 50%. The strength of the Soy flavor remained at or below 2.0 on the 15-point scale, even when the samples included 50% soy protein. In fact, Milky, Caramelized, and Vanilla Complex aromatics were all stronger in intensity relative to Soy/Legume, even at 50% soy inclusion. Additionally, there was only a slight decrease in the Milky aromatic at 20% soy replacement as compared to 100% dairy.

FIG. 20 presents the acceptability of the soy protein samples at Supro® 760 inclusion levels of 10%, 20%, and 40%, as assessed by a separate panel of 74 consumers, ages 35-54, recruited as willing to try vanilla flavored frozen desserts. Samples were presented to each consumer in a balanced sequential monadic fashion, in which each sample was served individually and taken away before the next sample was evaluated. Serving order was rotated and balanced to minimize bias due to serving order effects, consistent with standard sensory testing protocol.

As the graph in FIG. 20 illustrates, the overall liking, appearance, flavor, mouth feel and aftertaste liking responses for the samples including soy protein product were comparable to that of the all-dairy control sample. For example, at 10% soy protein inclusion, overall liking, appearance liking, flavor liking, mouth feel liking, and aftertaste liking mean scores were all equal to or only slightly below that of the all-dairy control sample. At 20% soy protein inclusion, appearance liking, overall liking, flavor liking, mouth feel liking, and aftertaste liking mean scores were statistically lower at 95% Confidence. At 40% soy protein inclusion, appearance liking and mouth feel liking scores were also statistically lower than that of the all-dairy control sample at 95% Confidence.

This example illustrates that a frozen dessert product which includes an amount of Supro® 760 in lieu of dairy may be favorably accepted as a replacement frozen dessert for those frozen dessert products containing one hundred percent dairy.

### Examples 24 and 25

### Analysis of Frozen Confections Comprising a Soy Protein Slurry

A frozen dessert product resembling ice cream was prepared using a soy protein slurry at a dairy replacement level of 100%. The samples were formed by first adding phosphate to water in a stainless steel container and heating to 100° F. A desirable amount of soy protein slurry was added, and the components were mixed at medium speeding using a propeller-type mixer for 5-10 minutes in order to disperse and hydrate the protein. After the protein was thoroughly dispersed, the slurry temperature was increased to 180° F., and the slurry was mixed at low speed for 5 minutes. Sugar and corn syrup solids were added to the protein slurry and mixing continued for 3 more minutes at medium speed. Coconut oil, mono- and di-glycerides, and Polysorbate 60 were then added, and the combined ingredients were mixed at medium speed for 3-5 minutes until the components were completely dispersed. The mixture was then pasteurized at 180° F. with a hold time of 30 seconds. After pasteurization, the mixture was homogenized using a 2 stage, single piston homogenizer set at 3000 psi, second stage; 2500 psi, first stage. Following homogenization the mixture was collected in pre-sterilized Nalgene® bottles and immediately place in an ice bath and held for 30 minutes. The chilled bottles were placed in a 35° F. walk-in cooler and stored overnight. Prior to freezing, vanilla flavoring was blended with the chilled mixture. The flavored mixture was then dispensed into a Taylor Batch Ice Cream Freezer and freezing of the mixture occurred over 7 minutes to reach a temperature of 24° F. to 26° F. The mixture was drawn from the freezer and packaged into appropriately labeled 1 pint Sweetheart K16A cups. The sample cups were placed bottom side up on plastic trays and placed into a blast freezer at −20° F. overnight and moved to a 0° F. freezer for storage until evaluation.

Table 41 presents the formulations of the samples at 100% protein slurry replacement.

TABLE 41
Frozen Confection Product Formulation with 100% Protein Slurry

| | Example 24 | | Example 25 | |
|---|---|---|---|---|
| | (Supro ® XF 8020) | | (Supro ® 120) | |
| | | Weight | | Weight |
| Ingredient | % Use | (g) | % Use | (g) |
| Distilled Water | 63.8100 | 8933.40 | 63.8500 | 8939.00 |
| Sugar | 12.0000 | 1680.00 | 12.0000 | 1680.00 |
| Corn Syrup Solids, 36DE | 9.6000 | 1344.00 | 9.6000 | 1344.00 |
| Supro ® XF 8020 | 4.0400 | 565.60 | | |
| Supro ® 120 | | | 4.0000 | 560.00 |
| Coconut Oil | 10.0000 | 1400.00 | 10.0000 | 1400.00 |
| Dipotassium Phosphate | 0.1000 | 14.00 | 0.1000 | 14.00 |
| Kelgum 200 cP Kelco | 0.2000 | 28.00 | 0.2000 | 28.00 |
| Distilled mono-, | 0.2000 | 28.00 | 0.2000 | 28.00 |
| di-glycerides | | | | |
| Polysorbate 60 | 0.0500 | 7.00 | 0.0500 | 7.00 |
| | 100.0000 | 14000.00 | 100.0000 | 14000.00 |

| | Vanilla | |
|---|---|---|
| | % | g/4000 g |
| Unflavored base | 99.6500 | 3986.00 |
| Vanilla Flavor, Quest QL89976 | 0.3500 | 14.00 |
| | 100.0000 | 400.00 |

Six panelists trained in the Sensory Spectrum Descriptive Profiling method evaluated the samples in triplicate. Definitions of the flavor attributes are given in Table 28. Mean flavor attribute intensities are summarized in Table 42 below.

FIG. 21 is a 100% dairy replacement with Supra® 120, Supro® XF 8020 comparing to Soy Delicious a commercial all vegetable frozen confection.

Table 42 presents the panelists' mean intensity scores as shown in FIG. 21.

| | | |
|---|---|---|
| Example 24 | Example 25 | Soy Delicious |

Aromatics

| | | | | | | |
|---|---|---|---|---|---|---|
| Overall Flavor Impact | 6.8 | b | 6.6 | b | 7.2 | a |
| SWA Complex | 3.4 | b | 2.8 | c | 3.8 | a |
| Caramelized | 6.9 | a | 0.0 | b | 1.0 | a |
| Vanilla | 6.4 | a | 0.4 | a | 0.4 | a |
| Vanillin | 2.4 | a | 2.2 | a | 2.5 | a |
| Soy/Legume | 2.7 | ab | 2.6 | b | 2.9 | a |
| Grain | 0.3 | a | 0.0 | a | 0.3 | a |
| Nutty | 0.0 | | 0.0 | | 0.0 | |
| Milky | 6.6 | | 0.0 | | 0.0 | |
| Animal | 0.0 | | 0.0 | | 0.0 | |
| Barnyard | 0.0 | | 0.0 | | 0.0 | |
| Dairy Fat | 0.0 | | 0.0 | | 0.0 | |
| Cardboard/Woody | 2.3 | a | 2.3 | a | 2.4 | a |
| Chemical | 2.0 | b | 2.0 | b | 2.2 | a |
| Other Aromatic: Painty | 2.5 | (17%) | 2.5 | (17%) | 0.0 | |
| Other Aromatic: Fat | 2.0 | (17%) | 2.0 | (17%) | 2.0 | (17%) |
| Other Aromatic: Alcohol | 0.0 | | 0.0 | | 2.0 | (17%) |
| Other Aromatic: | 0.0 | | 0.0 | | 2.0 | (33%) |
| Playdough/Fruity | | | | | | |

Basic Tastes

| | | | | | | |
|---|---|---|---|---|---|---|
| Sweet | 7.6 | ab | 6.9 | b | 8.2 | a |
| Sour | 2.0 | a | 2.0 | a | 1.9 | b |
| Salt | 1.6 | a | 1.5 | a | 1.5 | a |
| Bitter | 2.1 | a | 2.1 | a | 1.9 | a |

Chemical Feeling Factors

| | | | | | | |
|---|---|---|---|---|---|---|
| Astringent | 1.9 | a | 1.9 | a | 2.1 | a |
| Burn | 0.0 | | 0.0 | | 0.0 | |

Results from consumer acceptance data show mean scores for Vanilla Frozen Desserts produced with Supro XF (Example 24) are significantly higher (better liked) than Soy Delicious Vanilla Frozen Dessert for every Hedonic tested; Overall Liking, Appearance Liking, Flavor Liking, Texture Liking and Aftertaste Liking.

In comparison to Vanilla Frozen Dessert produced with Supra 120 (Example 25), Supro XF (Example 24) mean scores are significantly higher in Overall Liking, Flavor Liking and Aftertaste Liking.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A frozen confection, the frozen confection comprising:
(a) a protein hydrolysate composition comprising a mixture of polypeptide fragments having primarily either an arginine residue or a lysine residue at each carboxyl terminus, the composition having a degree of hydrolysis of at least about 0.2% and a soluble solids index of at least about 80% at a pH of greater than about 6.0; and
(b) an edible material.

2. The frozen confection of claim 1, wherein the protein hydrolysate composition is derived from a protein selected from the group consisting of soy, barley, canola, lupin, maize, oat, pea, potato, rice, wheat, animal, egg, and combinations thereof.

3. The frozen confection of claim 1, wherein the protein hydrolysate composition is derived from soy in combination with at least one protein selected from the group consisting of barley, canola, lupin, maize, oat, pea, potato, rice, wheat, animal, dairy, and egg.

4. The frozen confection of claim 1, wherein the protein hydrolysate composition is derived from soy, and the degree of hydrolysis is from about 0.2% to about 14%.

5. The frozen confection of claim 1, wherein the edible material is selected from the group consisting of skim milk, whole milk, cream, dried milk powder, non-fat dry milk powder, caseinate, soy protein concentrate, soy protein isolate, whey protein concentrate, whey protein isolate, and combinations thereof.

6. The frozen confection of claim 1, wherein the food product further comprises an ingredient selected from the group consisting of a sweetening agent, an emulsifying agent, a thickening agent, a stabilizer, a lipid material, a preservative, a flavoring agent, a coloring agent, and combinations thereof.

7. A method for producing a frozen confection composition comprising the steps of:
(a) mixing a protein hydrolysate composition comprising a mixture of polypeptide fragments having primarily either an arginine residue or a lysine residue at each carboxyl terminus, the composition having a degree of hydrolysis of at least about 0.2% and a soluble solids index of at least about 80% at a pH of greater than about 6 with at least one edible material to produce a confection and
(b) freezing the confection composition to produce a frozen confection.

8. The method for producing a frozen confection composition of claim 7, further comprising pasteurizing the confection after (a) at a temperature of from about 155° F. to about 270° F., at a pressure of from about 0.1 atmospheres to about 10 atmospheres, and at a time of from about 3 seconds to about 45 minutes.

9. The method for producing a frozen confection composition of claim 8, wherein the temperature is from about 175° F. to about 195° F., at a pressure of from about 1 atmosphere to about 1.5 atmospheres, and at a time of from about 4 seconds to about 25 seconds.

10. The method for producing a frozen confection composition of claim 7, further comprising homogenizing the confection after (a) at from about 1000 pounds per square inch to about 4000 pounds per square inch.

11. The method for producing a frozen confection composition of claim 10 where the homogenization is a single-stage homogenization.

12. The method for producing a frozen confection composition of claim 10 where the homogenization is a multi-stage homogenization.

13. The method for producing a frozen confection composition of claim 12 where the multi stage homogenization is a two-stage homogenization wherein the first stage is from about 2000 pounds per square inch up to about 3000 pounds per square inch and wherein the second stage is from about 250 pounds per square inch up to about 750 pounds per square inch.

14. The method for producing a frozen confection composition of claim 7, further comprising pasteurizing and homogenizing the confection after (a) wherein pasteurizing is at a temperature of from about 155° F. to about 270° F., at a pressure of from about 0.1 atmospheres to about 10 atmospheres, and at a time of from about 4 seconds to about 45 minutes, and wherein homogenizing is from about 1000 pounds per square inch to about 4000 pounds per square inch.

15. The method for producing a frozen confection composition of claim 14, wherein the homogenizing is single-stage or multi-stage.

16. The method for producing a frozen confection composition of claim 15 wherein the multi-stage homogenization is a two-stage homogenization wherein the first stage is from about 2000 pounds per square inch up to about 3000 pounds per square inch and wherein the second stage is from about 250 pounds per square inch up to about 750 pounds per square inch.


SEQUENCE LISTING (274 sequences)

SEQ ID NO: 1 - protein, 248 aa, Fusarium oxysporum
MVKFASVVALVAPLAAAAPQEIPNIVGGTSASAGDFPFIVSISRNGGPWCGGSLLNANTVLTAAHCVSGYAQSGFQIRAGSLSRTSGGITSSLSSVRVHPSYSGNNNDLAILKLSTSIPSGGNIGYARLAASGSDPVAGSSATVAGWGATSEGGSSTPVNLLKVTVPIVSRATCRAQYGTSAITNQMFCAGVSSGGKDSCQGDSGGPIVDSSNTLIGAVSWGNGCARPNYSGVYASVGALRSFIDTYA

SEQ ID NO: 2 - protein, 251 aa, Fusariun solani
MVKFAAILALVAPLVAARPQDSSPMIVGGTAASAGDFPFIVSIAYNGGPWCGGTLLNANTVMTAAHCTQGRSASAFQVRAGSLNRNSGGVTSSVSSIRIHPSFSSSTLNNDVSILKLSTPISTSSTISYGRLAASGSDPVAGSDATVAGWGVTSQGSSSSPVALRKVTIPIVSRTTCRSQYGTSAITTNMFCAGLAEGGKDSCQGDSGGPIVDTSNTVIGIVSWGEGCAQPNLSGVYARVGSLRTYIDGQL

SEQ ID NO: 3 - protein, 250 aa, Fusariun cf. solani
MVKFAAILALVAPLVAARPQDRPMIVGGTAASAGDFPFIVSIAYNGGPWCGGTLLNASTVLTAAHCTQGRSASAFQVRAGSLNRNSGGVTSAVSSIRIHPSFSGSTLNNDVSILKLSTPISTSSTISYGRLAASGSDPAAGSDATVAGWGVTSQGSSSSPVALRKVTIPIVSRTTCRSQYGTSAITTNMFCAGLAEGGKDSCQGDSGGPIVDTSNTVIGIVSWGEGCAQPNFSGVYARVGSLRSYIDGQL

SEQ ID NO: 4 - protein, 653 aa, Achromobacter lyticus
MKRICGSLLLLGLSISAALAAPASRPAAFDYANLSSVDKVALRTMPAVDVAKAKAEDLQRDKRGDIPRFALAIDVDMTPQNSGAWEYTADGQFAVWRQRVRSEKALSLNFGFTDYYMPAGGRLLVYPATQAPAGDRGLISQYDASNNNSARQLWTAVVPGAEAVIEAVIPRDKVGEFKLRLTKVNHDYVGFGPLARRLAAASGEKGVSGSCNIDVVCPEGDGRRDIIRAVGAYSKSGTLACTGSLVNNTANDRKMYFLTAHHCGMGTASTAASIVVYWNYQNSTCRAPNTPASGANGDGSMSQTQSGSTVKATYATSDFTLLELNNAANPAFNLFWAGWDRRDQNYPGAIAIHHPNVAEKRISNSTSPTSFVAWGGGAGTTHLNVQWQPSGGVTEPGSSGSPIYSPEKRVLGQLHGGPSSCSATGTNRSDQYGRVFTSWTGGGAAASRLSDWLDPASTGAQFIDGLDSGGGTPNTPPVANFTSTTSGLTATFTDSSTDSDGSIASRSWNFGDGSTSTATNPSKTYAAAGTYTVTLTVTDNGGATNTKTGSVTVSGGPGAQTYTNDTDVAIPDNATVESPITVSGRTGNGSATTPIQVTIYHTYKSDLKVDLVAPDGTVYNLHNRTGGSAHNIIQTFTKDLSSEAAQRAPGSCG

SEQ ID NO: 5 - protein, 7 aa, Glycine max
YSNKLGK

SEQ ID NO: 6 - protein, 7 aa, Glycine max
RFETLFK

SEQ ID NO: 7 - protein, 8 aa, Glycine max
SPQLQLNR

SEQ ID NO: 8 - protein, 9 aa, Glycine max
SRDPISYNK

SEQ ID NO: 9 - protein, 10 aa, Glycine max
SSEDKPFNLR

SEQ ID NO: 10 - protein, 10 aa, Glycine max
SSEDEPFNLR

SEQ ID NO: 11 - protein, 12 aa, Glycine max
NFLAGEKDNVVR

SEQ ID NO: 12 - protein, 6 aa, Glycine max
NNNPFK

SEQ ID NO: 13 - protein, 10 aa, Glycine max
LSAAEFGSLR

SEQ ID NO: 14 - protein, 12 aa, Glycine max
SQSDNFEYVSFK

SEQ ID NO: 15 - protein, 12 aa, Glycine max
PEEVIQHTFNLK

SEQ ID NO: 16 - protein, 13 aa, Glycine max
FYLAGNQEQEFLK

SEQ ID NO: 17 - protein, 14 aa, Glycine max
RFYLAGNQEQEFLK

SEQ ID NO: 18 - protein, 7 aa, Glycine max
PPKESQR

SEQ ID NO: 19 - protein, 9 aa, Glycine max
LSAQFGSLR

SEQ ID NO: 20 - protein, 13 aa, Glycine max
FYLAGNQEQEFLQ

SEQ ID NO: 21 - protein, 7 aa, Glycine max
SKKTQPR

SEQ ID NO: 22 - protein, 13 aa, Glycine max
PSEVLAHSYNLAR

SEQ ID NO: 23 - protein, 6 aa, Glycine max
SGDALR

SEQ ID NO: 24 - protein, 6 aa, Glycine max
FETLFK

SEQ ID NO: 25 - protein, 13 aa, Glycine max
KTISSEDKPFNLR

SEQ ID NO: 26 - protein, 8 aa, Glycine max
SPQLENLR

SEQ ID NO: 27 - protein, 10 aa, Glycine max
LAGEKDNVVR

SEQ ID NO: 28 - protein, 13 aa, Glycine max
KTISSEDEPFNLR

SEQ ID NO: 29 - protein, 12 aa, Glycine max
VREDENNPFYLR

SEQ ID NO: 30 - protein, 8 aa, Glycine max
PPQESQKR

SEQ ID NO: 31 - protein, 9 aa, Glycine max
LNALKPDNR

SEQ ID NO: 32 - protein, 10 aa, Glycine max
VFDGELQEGR

SEQ ID NO: 33 - protein, 12 aa, Glycine max
PEEVIQQTFNLR

SEQ ID NO: 34 - protein, 13 aa, Glycine max
ISTLNSLTLPALR

SEQ ID NO: 35 - protein, 16 aa, Glycine max
KQIVTVEGGLSVISPK

SEQ ID NO: 36 - protein, 11 aa, Glycine max
EQQEEQPLEVR

SEQ ID NO: 37 - protein, 15 aa, Glycine max
LQESVIVEISKEQIR

SEQ ID NO: 38 - protein, 5 aa, Glycine max
SSSRK

SEQ ID NO: 39 - protein, 8 aa, Glycine max
FFEITPEK

SEQ ID NO: 40 - protein, 15 aa, Glycine max
VLFSREEGQQQGEQR

SEQ ID NO: 41 - protein, 14 aa, Glycine max
LKVREDENNPFYLR

SEQ ID NO: 42 - protein, 4 aa, Glycine max
LLQR

SEQ ID NO: 43 - protein, 4 aa, Glycine max
FNKR

SEQ ID NO: 44 - protein, 4 aa, Glycine max
PDNR

SEQ ID NO: 45 - protein, 4 aa, Glycine max
TLNR

SEQ ID NO: 46 - protein, 4 aa, Glycine max
PQQR

SEQ ID NO: 47 - protein, 4 aa, Glycine max
YNFR

SEQ ID NO: 48 - protein, 9 aa, Glycine max
PQNFVVAAR

SEQ ID NO: 49 - protein, 11 aa, Glycine max
LAGNQEQEFLK

SEQ ID NO: 50 - protein, 5 aa, Glycine max
SQQAR

SEQ ID NO: 51 - protein, 7 aa, Glycine max
ADFYNPK

SEQ ID NO: 52 - protein, 8 aa, Glycine max
MIIIAQGK

SEQ ID NO: 53 - protein, 11 aa, Glycine max
PETMQQQQQQK

SEQ ID NO: 54 - protein, 4 aa, Glycine max
HSER

SEQ ID NO: 55 - protein, 11 aa, Glycine max
YEAGVVPPGAR

SEQ ID NO: 56 - protein, 13 aa, Glycine max
HHLAEAAEYVGQK

SEQ ID NO: 57 - protein, 11 aa, Glycine max
TKEVGQDIQSK

SEQ ID NO: 58 - protein, 5 aa, Glycine max
LVVSK

SEQ ID NO: 59 - protein, 8 aa, Glycine max
DAMDGWFR

SEQ ID NO: 60 - protein, 12 aa, Glycine max
TISSEDEPFNLR

SEQ ID NO: 61 - protein, 13 aa, Glycine max
FFEITPEKNPQLR

SEQ ID NO: 62 - protein, 15 aa, Glycine max
SSNSFQTLFENQNGR

SEQ ID NO: 63 - protein, 16 aa, Glycine max
QVQELAFPGSAQDVER

SEQ ID NO: 64 - protein, 11 aa, Glycine max
QQQEEQPLEVR

SEQ ID NO: 65 - protein, 12 aa, Glycine max
TISSEDKPFNLR

SEQ ID NO: 66 - protein, 10 aa, Glycine max
FLVPPQESQK

SEQ ID NO: 67 - protein, 11 aa, Glycine max
FLVPPQESQKR

SEQ ID NO: 68 - protein, 13 aa, Glycine max
VLIVPQNFVVAAR

SEQ ID NO: 69 - protein, 17 aa, Glycine max
RPSYTNGPQEIYIQQGK

SEQ ID NO: 70 - protein, 23 aa, Glycine max
VFYLAGNPDIEYPETMQQQQQQK

SEQ ID NO: 71 - protein, 11 aa, Glycine max
EAFGVNMQIVR

SEQ ID NO: 72 - protein, 16 aa, Glycine max
NNNPFSFLVPPQESQR

SEQ ID NO: 73 - protein, 21 aa, Glycine max
NLQGENEGEDGEDKGAIVTVK

SEQ ID NO: 74 - protein, 23 aa, Glycine max
VFDGELQEGGVLIVPQNFAVAAK

SEQ ID NO: 75 - protein, 23 aa, Glycine max
GKQQEEENEGSNILSGFAPEFLK

SEQ ID NO: 76 - protein, 9 aa, Glycine max
PQNFAVAAK

SEQ ID NO: 77 - protein, 13 aa, Glycine max
NGLHLPSYSPYPR

SEQ ID NO: 78 - protein, 14 aa, Glycine max
AIPSEVLAHSYNLR

SEQ ID NO: 79 - protein, 26 aa, Glycine max
WQEQQDEDEDEDEDDEDEQIPSHPPR

SEQ ID NO: 80 - protein, 22 aa, Glycine max
KQGQHQQEEEEEGGSVLSGFSK

SEQ ID NO: 81 - protein, 15 aa, Glycine max
LFDQQNEGSIFAISR

SEQ ID NO: 82 - protein, 16 aa, Glycine max
LTEVGPDDDEKSWLQR

SEQ ID NO: 83 - protein, 16 aa, Glycine max
TNRGPGGTATAHNTRA

SEQ ID NO: 84 - protein, 17 aa, Glycine max
HQTSAMPGHGTGQPTGH

SEQ ID NO: 85 - protein, 6 aa, Glycine max
GYLADK

SEQ ID NO: 86 - protein, 6 aa, Glycine max
FQTLFE

SEQ ID NO: 87 - protein, 7 aa, Glycine max
PPQESQK

SEQ ID NO: 88 - protein, 7 aa, Glycine max
PQESQKR

SEQ ID NO: 89 - protein, 7 aa, Glycine max
NQYGRIR

SEQ ID NO: 90 - protein, 8 aa, Glycine max
PEKNPQLR

SEQ ID NO: 91 - protein, 9 aa, Glycine max
EVGQDIQSK

SEQ ID NO: 92 - protein, 9 aa, Glycine max
DYGSYAQGR

SEQ ID NO: 93 - protein, 9 aa, Glycine max
PPRYEAGVK

SEQ ID NO: 94 - protein, 9 aa, Glycine max
APSIYHSER

SEQ ID NO: 95 - protein, 9 aa, Glycine max
FGVNMQIVR

SEQ ID NO: 96 - protein, 10 aa, Glycine max
SSDFLTYGLK

SEQ ID NO: 97 - protein, 10 aa, Glycine max
AFGVNMQIVR

SEQ ID NO: 98 - protein, 10 aa, Glycine max
NILEASYDTK

SEQ ID NO: 99 - protein, 10 aa, Glycine max
NPIYSNNFGK

SEQ ID NO: 100 - protein, 11 aa, Glycine max
GIGTIISSPYR

SEQ ID NO: 101 - protein, 10 aa, Glycine max
ESYFVDAQPK

SEQ ID NO: 102 - protein, 10 aa, Glycine max
HLSVVHPIYK

SEQ ID NO: 103 - protein, 10 aa, Glycine max
LHENIARPSR

SEQ ID NO: 104 - protein, 10 aa, Glycine max
NKPLVVQFQK

SEQ ID NO: 105 - protein, 11 aa, Glycine max
AKDYGSYAQGR

SEQ ID NO: 106 - protein, 11 aa, Glycine max
THHNAVTSYLK

SEQ ID NO: 107 - protein, 11 aa, Glycine max
LAGNQEQEFLQ

SEQ ID NO: 108 - protein, 11 aa, Glycine max
NKNPFLFGSNR

SEQ ID NO: 109 - protein, 12 aa, Glycine max
SRDPIYSNKLGK

SEQ ID NO: 110 - protein, 12 aa, Glycine max
SRNPIYSNNFGK

SEQ ID NO: 111 - protein, 12 aa, Glycine max
YLAGNQEQEFLK

SEQ ID NO: 112 - protein, 12 aa, Glycine max
PEFLEHAFVVDR

SEQ ID NO: 113 - protein, 13 aa, Glycine max
PPHSVQVHTTTHR

SEQ ID NO: 114 - protein, 15 aa, Glycine max
QIVTVEGGLSVISPK

SEQ ID NO: 115 - protein, 13 aa, Glycine max
LPEEVIQHTFNLK

SEQ ID NO: 116 - protein, 13 aa, Glycine max
FSREEGQQQGEQR

SEQ ID NO: 117 - protein, 13 aa, Glycine max
NQRESYFVDAQPK

SEQ ID NO: 118 - protein, 13 aa, Glycine max
LFEITPEKNPQLR

SEQ ID NO: 119 - protein, 14 aa, Glycine max
QESVIVEISKEQIR

SEQ ID NO: 120 - protein, 14 aa, Glycine max
HLAEAAEYVGQKTK

SEQ ID NO: 121 - protein, 16 aa, Glycine max
AGRISTLNSLTLPALR

SEQ ID NO: 122 - protein, 14 aa, Glycine max
FMPEKGSAEYEELR

SEQ ID NO: 123 - protein, 14 aa, Glycine max
PFSFLVPPQESQRR

SEQ ID NO: 124 - protein, 14 aa, Glycine max
LEASYDTKFEEINK

SEQ ID NO: 125 - protein, 16 aa, Glycine max
LARPVLGGSSTFPYPR

SEQ ID NO: 126 - protein, 16 aa, Glycine max
NELDKGIGTIISSPYR

SEQ ID NO: 127 - protein, 15 aa, Glycine max
THHNAVSSYIKDVFR

SEQ ID NO: 128 - protein, 15 aa, Glycine max
THHNAVTSYLKDVFR

SEQ ID NO: 129 - protein, 15 aa, Glycine max
NPFLFGSNRFETLFK

SEQ ID NO: 130 - protein, 16 aa, Glycine max
HFLAQSFNTNEDIAEK

SEQ ID NO: 131 - protein, 16 aa, Glycine max
NNNPFSFLVPPKESQR

SEQ ID NO: 132 - protein, 15 aa, Glycine max
LFLLDHHDPIMPYLR

SEQ ID NO: 133 - protein, 17 aa, Glycine max
SLSQIVQPAFESAFDLK

SEQ ID NO: 134 - protein, 16 aa, Glycine max
DWVFTDQALPADLIKR

SEQ ID NO: 135 - protein, 18 aa, Glycine max
NLQGENEGEDKGAIVTVK

SEQ ID NO: 136 - protein, 16 aa, Glycine max
NILEASYDTKFEEINK

SEQ ID NO: 137 - protein, 18 aa, Glycine max
NLQGENEEEDSGAIVTVK

SEQ ID NO: 138 - protein, 15 aa, Glycine max
KESFFFPFELPREER

SEQ ID NO: 139 - protein, 17 aa, Glycine max
SSNSFQTLFENQNGRIR

SEQ ID NO: 140 - protein, 17 aa, Glycine max
NNNPFSFLVPPQESQRR

SEQ ID NO: 141 - protein, 19 aa, Glycine max
AIPSEVLSNSYNLGQSQVR

SEQ ID NO: 142 - protein, 18 aa, Glycine max
HFLAQSFNTNEDTAEKLR

SEQ ID NO: 143 - protein, 19 aa, Glycine max
QVQELAFPGSAQDVERLLK

SEQ ID NO: 144 - protein, 19 aa, Glycine max
VPSGTTYYVVNPDNNENLR

SEQ ID NO: 145 - protein, 19 aa, Glycine max
IPAGTTYYLVNPHDHQNLK

SEQ ID NO: 146 - protein, 20 aa, Glycine max
QEEENEGSNILSGFAPEFLK

SEQ ID NO: 147 - protein, 21 aa, Glycine max
KQGQHQQQEEEGGSVLSGFSK

SEQ ID NO: 148 - protein, 22 aa, Glycine max
NLQGENEEEDSGAIVTVKGGLR

SEQ ID NO: 149 - protein, 21 aa, Glycine max
SVSQNVLPLLQSAFDLNFTPR

SEQ ID NO: 150 - protein, 20 aa, Glycine max
QVKNNNPFSFLVPPQESQRR

SEQ ID NO: 151 - protein, 21 aa, Glycine max
QVKNNNPFSFLVPPQESQRRA

SEQ ID NO: 152 - protein, 22 aa, Glycine max
NAMFVPHYTLNANSIIYALNGR

SEQ ID NO: 153 - protein, 23 aa, Glycine max
TPVVAVSIIDTNSLENQLDQMPR

SEQ ID NO: 154 - protein, 23 aa, Glycine max
VFDGELQEGRVLIVPQNFVVAAR

SEQ ID NO: 155 - protein, 23 aa, Glycine max
EPVVAISLLDTSNFNNQLDQTPR

SEQ ID NO: 156 - protein, 23 aa, Glycine max
KNAMFVPHYTLNANSIIYALNGR

SEQ ID NO: 157 - protein, 24 aa, Glycine max
DLDIFLSIVDMNEGALLLPHFNSK

SEQ ID NO: 158 - protein, 23 aa, Glycine max
VFYLAGNPDIEHPETMQQQQQQK

SEQ ID NO: 159 - protein, 24 aa, Glycine max
HFLAQSFNTNEDIAEKLQSPDDER

SEQ ID NO: 160 - protein, 27 aa, Glycine max
LVFCPQQAEDDKCGDIGISIDHDDGTR

SEQ ID NO: 161 - protein, 25 aa, Glycine max
SQQARQVKNNNPFSFLVPPQESQRR

SEQ ID NO: 162 - protein, 25 aa, Glycine max
VLFGEEEEQRQQEGVIVELSKEQIR

SEQ ID NO: 163 - protein, 29 aa, Glycine max
NLQGENEEEDSGAIVTVKGGLRVTAPAMR

SEQ ID NO: 164 - protein, 28 aa, Glycine max
VFYLAGNPDIEYPETMQQQQQQKSHGGR

SEQ ID NO: 165 - protein, 30 aa, Glycine max
DFVLDNEGNPLENGGTYYILSDITAFGGIR

SEQ ID NO: 166 - protein, 29 aa, Glycine max
HQQEEENEGGSILSGFTLEFLEHAFSVDK

SEQ ID NO: 167 - protein, 29 aa, Glycine max
RQQEEENEGGSILSGFAPEFLEHAFVVDR

SEQ ID NO: 168 - protein, 32 aa, Glycine max
TNDTPMIGTLAGANSLLNALPEEVIQHTFNLK

SEQ ID NO: 169 - protein, 34 aa, Glycine max
HNIGQTSSPDIYNPQAGSVTTATSLDFPALSWLR

SEQ ID NO: 170 - protein, 33 aa, Glycine max
HQQEEENEGGSILSGFTLEFLEHAFSVDKQIAK

SEQ ID NO: 171 - protein, 35 aa, Glycine max
NFLAGSQDNVISQIPSQVQELAFPGSAQAVEKLLK

SEQ ID NO: 172 - protein, 34 aa, Glycine max
MITLAIPVNKPGRFESFFLSSTQAQQSYLQGFSK

SEQ ID NO: 173 - protein, 45 aa, Glycine max
FREGDLIAVPTGVAWWMYNNEDTPVVAVSIIDTNSLENQLDQMPR

SEQ ID NO: 174 - protein, 11 aa, Glycine max
EAFGVNMQIVR

SEQ ID NO: 175 - protein, 12 aa, Glycine max
ISPLPVLKEIFR

SEQ ID NO: 176 - protein, 15 aa, Glycine max
YEAGVVPPARFEAPR

SEQ ID NO: 177 - protein, 22 aa, Glycine max
NAMFVPHYNLNANSIIYALNGR

SEQ ID NO: 178 - protein, 10 aa, Bos taurus
YIPIQYVLSR

SEQ ID NO: 179 - protein, 10 aa, Bos taurus
YLGYLEQLLR

SEQ ID NO: 180 - protein, 11 aa, Bos taurus
HIQKEDVPSER

SEQ ID NO: 181 - protein, 12 aa, Bos taurus
FFVAPFPEVFGK

SEQ ID NO: 182 - protein, 13 aa, Bos taurus
FVAPFPEVFGKEK

SEQ ID NO: 183 - protein, 13 aa, Bos taurus
HPHLSFMAIPPKK

SEQ ID NO: 184 - protein, 12 aa, Bos taurus
YLGYLEQLLRLK

SEQ ID NO: 185 - protein, 13 aa, Bos taurus
IAKYIPIQYVLSR

SEQ ID NO: 186 - protein, 14 aa, Bos taurus
HPHPHLSFMAIPPK

SEQ ID NO: 187 - protein, 14 aa, Bos taurus
FFVAPFPEVFGKEK

SEQ ID NO: 188 - protein, 15 aa, Bos taurus
HPHPHLSFMAIPPKK

SEQ ID NO: 189 - protein, 15 aa, Bos taurus
HQGLPQEVLNENLLR

SEQ ID NO: 190 - protein, 18 aa, Bos taurus
SPAQILQWQVLSNTVPAK

SEQ ID NO: 191 - protein, 19 aa, Bos taurus
HPHPHLSFMAIPPKKNQDK

SEQ ID NO: 192 - protein, 19 aa, Bos taurus
HPIKHQGLPQEVLNENLLR

SEQ ID NO: 193 - protein, 22 aa, Bos taurus
RPKHPIKHQGLPQEVLNENLLR

SEQ ID NO: 194 - protein, 27 aa, Bos taurus
YYQQKPVALINNQFLPYPYYAKPAAVR

SEQ ID NO: 195 - protein, 32 aa, Bos taurus
LHSMKEGIHAQQKEPMIGVNQELAYFYPELFR

SEQ ID NO: 196 - protein, 34 aa, Bos taurus
LITLAIPVNKPGRFESFFLSSTEAQQSYLQGFSR

SEQ ID NO: 197 - protein, 34 aa, Bos taurus
YPSYGLNYYQQKPVALINNQFLPYPYYAKPAAVR

SEQ ID NO: 198 - protein, 8 aa, Brassica juncea
QTATHLPR

SEQ ID NO: 199 - protein, 8 aa, Brassica juncea
LQNQQVNR

SEQ ID NO: 200 - protein, 9 aa, Brassica juncea
YQTATHLPR

SEQ ID NO: 201 - protein, 10 aa, Brassica juncea
GPFQVVRPPL

SEQ ID NO: 202 - protein, 11 aa, Brassica juncea
MADAVGYAGQK

SEQ ID NO: 203 - protein, 9 aa, Brassica juncea
EFQQAQHLR

SEQ ID NO: 204 - protein, 9 aa, Brassica juncea
NNFEWISFK

SEQ ID NO: 205 - protein, 11 aa, Brassica juncea
GASKAVKQQIR

SEQ ID NO: 206 - protein, 11 aa, Brassica juncea
VQGQFGVIRPP

SEQ ID NO: 207 - protein, 10 aa, Brassica juncea
IYQTATHLPR

SEQ ID NO: 208 - protein, 13 aa, Brassica juncea
MADAVGYAGQKGK

SEQ ID NO: 209 - protein, 12 aa, Brassica juncea
VQGPFSVIRPPL

SEQ ID NO: 210 - protein, 12 aa, Brassica juncea
VQGQFGVIRPPL

SEQ ID NO: 211 - protein, 12 aa, Brassica juncea
GLYLPSFFSTAK

SEQ ID NO: 212 - protein, 13 aa, Brassica juncea
TNANAQINTLAGR

SEQ ID NO: 213 - protein, 13 aa, Brassica juncea
ISYVVQGMGISGR

SEQ ID NO: 214 - protein, 13 aa, Brassica juncea
NILNGFTPEVLAK

SEQ ID NO: 215 - protein, 12 aa, Brassica juncea
TAQQLQNQQDNR

SEQ ID NO: 216 - protein, 14 aa, Brassica juncea
RMADAVGYAGQKGK

SEQ ID NO: 217 - protein, 12 aa, Brassica juncea
ATSQQFQWIEFK

SEQ ID NO: 218 - protein, 14 aa, Brassica juncea
AGNNPQGQQWLQGR

SEQ ID NO: 219 - protein, 15 aa, Brassica juncea
GQLLVVPQGFAVVKR

SEQ ID NO: 220 - protein, 15 aa, Brassica juncea
TLLFGEKPVTVFGIR

SEQ ID NO: 221 - protein, 16 aa, Brassica juncea
LLAGNNPQGQQWLQGR

SEQ ID NO: 222 - protein, 16 aa, Brassica juncea
VTSVNSYTLPILQYIR

SEQ ID NO: 223 - protein, 15 aa, Brassica juncea
MNQFFHGWYMEPLTK

SEQ ID NO: 224 - protein, 17 aa, Brassica juncea
TAQQLQNQQDNRGNIVR

SEQ ID NO: 225 - protein, 18 aa, Brassica juncea
PFLLAGNNPQGQQWLQGR

SEQ ID NO: 226 - protein, 19 aa, Brassica juncea
FGIVEGLMTTVHSITATQK

SEQ ID NO: 227 - protein, 19 aa, Brassica juncea
GLPLEVISNGYQISPQEAR

SEQ ID NO: 228 - protein, 18 aa, Brassica juncea
WFLPFDESDPASIEAAER

SEQ ID NO: 229 - protein, 19 aa, Brassica juncea
GLPLEVISNGYQISLEEAR

SEQ ID NO: 230 - protein, 19 aa, Brassica juncea
ALPLEVITNAFQISLEEAR

SEQ ID NO: 231 - protein, 19 aa, Brassica juncea
QQGQQQGQQGQQLQHEISR

SEQ ID NO: 232 - protein, 21 aa, Brassica juncea
NFGKDFIFGVASSAYQIEGGR

SEQ ID NO: 233 - protein, 20 aa, Brassica juncea
ALPLEVITNAFQISLEEARR

SEQ ID NO: 234 - protein, 20 aa, Brassica juncea
THENIDDPARADVYKPNLGR

SEQ ID NO: 235 - protein, 21 aa, Brassica juncea
FNTIETTLTHSSGPASYGRPR

SEQ ID NO: 236 - protein, 21 aa, Brassica juncea
NLRPFLLAGNNPQGQQWLQGR

SEQ ID NO: 237 - protein, 23 aa, Brassica juncea
VFDQEISKGQLLVVPQGFAVVKR

SEQ ID NO: 238 - protein, 9 aa, Zea mays
VAVLEANPR

SEQ ID NO: 239 - protein, 8 aa, Zea mays
RPYVFDRR

SEQ ID NO: 240 - protein, 10 aa, Zea mays
HGQDKGIIVR

SEQ ID NO: 241 - protein, 12 aa, Zea mays
AIGFDGLGDPGR

SEQ ID NO: 242 - protein, 10 aa, Zea mays
VLRPFDEVSR

SEQ ID NO: 243 - protein, 11 aa, Zea mays
NPESFLSSFSK

SEQ ID NO: 244 - protein, 12 aa, Zea mays
VFLAGADNVLQK

SEQ ID NO: 245 - protein, 12 aa, Zea mays
DIGFNGLADPNR

SEQ ID NO: 246 - protein, 11 aa, Zea mays
NALENYAYNMR

SEQ ID NO: 247 - protein, 14 aa, Zea mays
VPTVDVSVVDLTVR

SEQ ID NO: 248 - protein, 13 aa, Zea mays
QISWNYNYGPAGR

SEQ ID NO: 249 - protein, 12 aa, Zea mays
ARFEELNMDLFR

SEQ ID NO: 250 - protein, 14 aa, Zea mays
REQLGQQGYSEMGK

SEQ ID NO: 251 - protein, 15 aa, Zea mays
TLLFGDKPVTVFGIR

SEQ ID NO: 252 - protein, 15 aa, Zea mays
REQLGQQGYSEMGKK

SEQ ID NO: 253 - protein, 16 aa, Zea mays
GPLQISWNYNYGPAGR

SEQ ID NO: 254 - protein, 18 aa, Zea mays
ALSFASKAEEVDEVLGSR

SEQ ID NO: 255 - protein, 19 aa, Zea mays
AVGKVLPDLNGKLTGMSFR

SEQ ID NO: 256 - protein, 19 aa, Zea mays
ALSFASKAEEVDEVLGSRR

SEQ ID NO: 257 - protein, 21 aa, Zea mays
LSPGTAFVVPAGHPFVAVASR

SEQ ID NO: 258 - protein, 19 aa, Zea mays
DQRPSIANQHGQLYEADAR

SEQ ID NO: 259 - protein, 23 aa, Zea mays
ARLSPGTAFVVPAGHPFVAVASR

SEQ ID NO: 260 - protein, 21 aa, Zea mays
RHASEGGHGPHWPLPPFGESR

SEQ ID NO: 261 - protein, 20 aa, Zea mays
YYGRGPLQISWNYNYGPAGR

SEQ ID NO: 262 - protein, 8 aa, Triticum Spp
WSTGLQMR

SEQ ID NO: 263 - protein, 10 aa, Triticum Spp
QVVDQQLAGR

SEQ ID NO: 264 - protein, 10 aa, Triticum Spp
QYEQTVVPPK

SEQ ID NO: 265 - protein, 17 aa, Triticum Spp
QGQQGYYPTSPQHTGQR

SEQ ID NO: 266 - protein, 20 aa, Triticum Spp
QVVDQQLAGRLPWSTGLQMR

SEQ ID NO: 267 - protein, 22 aa, Triticum Spp
QGYDSPYHVSAEQQAASPMVAK

SEQ ID NO: 268 - protein, 29 aa, Triticum Spp
SLQQPGQGQQIGQGQQGYYPTSPQHTGQR

SEQ ID NO: 269 - protein, 35 aa, Triticum Spp
QGYYPTSLQQPGQGQQIGQGQQGYYPTSPQHTGQR

SEQ ID NO: 270 - protein, 10 aa, Glycine max
LSAEFGSLRK

SEQ ID NO: 271 - protein, 13 aa, Glycine max
IGENKDAMDGWFR

SEQ ID NO: 272 - protein, 23 aa, Glycine max
KNAMFVPHYNLNANSIIYALNGR

SEQ ID NO: 273 - protein, 32 aa, Glycine max
TNDRPSIGNLAGANSLLNALPEEVIQHTFNLK

SEQ ID NO: 274 - protein, 32 aa, Glycine max
TNDRPSIGNLAGANSLLNALPEEVIQQTFNLR